(19) United States
(12) Patent Application Publication
(10) Pub. No.: US 2008/0081766 A1
(43) Pub. Date: Apr. 3, 2008

(54) IMAGE-FORMING METHOD USING HEAT-SENSITIVE TRANSFER SYSTEM

(75) Inventors: Hidekazu Sakai, Minami-ashigara-shi (JP); Nobuyuki Haraguchi, Ashigarakami-gun (JP); Naotsugu Muro, Minami-ashigara-shi (JP); Yoshihiko Fujie, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/863,661

(22) Filed: Sep. 28, 2007

(30) Foreign Application Priority Data
Sep. 29, 2006 (JP) 2006-269758
Sep. 29, 2006 (JP) 2006-269800
Sep. 29, 2006 (JP) 2006-269804

(51) Int. Cl. B41M 5/20

(52) U.S. Cl. 503/227

(57) ABSTRACT

An image-forming method comprising employing (1) a heat-sensitive transfer image-receiving sheet having a support, at least one dye receptor layer on the support, and at least one heat insulation layer containing both hollow polymer particles and a hydrophilic polymer, the heat insulation layer being disposed between the receptor layer and the support, and (2) a heat-sensitive transfer sheet having at least one yellow heat transfer layer, at least one magenta heat transfer layer, and/or at least one cyan heat transfer layer on a support, wherein at least two of a yellow dye, a magenta dye, and a cyan dye, each incorporated in the corresponding heat transfer layer, are specific compounds.

### FIELD OF THE INVENTION

The present invention relates to an image-forming method using a heat-sensitive (thermal) transfer system, which provides an image having an excellent fastness.

The present invention also relates to an image-forming method using a heat-sensitive transfer system, which provides an image having a high density, a high image quality and an excellent fastness.

### BACKGROUND OF THE INVENTION

Various heat transfer recording methods have been known so far. Among these methods, dye diffusion transfer recording systems attract attention as a process that can produce a color hard copy having an image quality closest to that of silver halide photography (see, for example, “Joho Kiroku (Hard Copy) to Sono Zairyo no Shintenkai (Information Recording (Hard Copy) and New Development of Recording Materials)” published by Toray Research Center Inc., 1993, pp. 241-285; and “Printer Zairyo no Kaihatsu (Development of Printer Materials)” published by CMC Publishing Co., Ltd., 1995, p. 180). Moreover, this system has advantages over silver halide photography: it is a dry system, it enables direct visualization from digital data, it makes reproduction simple, and the like.

In this dye diffusion transfer recording system, a heat-sensitive transfer sheet (hereinafter also referred to as an ink sheet) containing dyes is superposed on a heat-sensitive transfer image-receiving sheet (hereinafter also referred to as an image-receiving sheet), and then the ink sheet is heated by a thermal head whose exothermic action is controlled by electric signals, in order to transfer the dyes contained in the ink sheet to the image-receiving sheet, thereby recording an image information. Three colors: cyan, magenta, and yellow, are used for recording a color image by overlapping one color to other, thereby enabling transferring and recording a color image having continuous gradation for color densities.

The use of various dyes in this system has been proposed (for example, see the publications of JP-A-7-232482 (“JP-A” means unexamined published Japanese patent application), JP-A-5-221161, JP-A-4-357088 and JP-A-62-55194). However, fastness of the image and image quality obtained by this system are not always satisfactory, when compared with a silver halide photography having a long history as a color print material. With respect to improvement of light fastness, there are known some proposals, for example, to use various dyes as described above, and to provide an overcoat layer capable of absorbing ultraviolet ray by applying a thermal transfer system (for example, the publication of JP-A-11-334202). Concerning a monochromic image of each of cyan, magenta, and yellow colors, materials having fastness of the level as good as the level of the silver halide photography have been developed. However, in the case of an image formed from a mixture consisting of at least two color dyes, such problems arise that a fading rate of each dye image is accelerated when compared with the corresponding monochromic image, and that a fading rate varies depending on the kind of color formed. Accordingly, a color balance in an actual image is lost with a progress of fading, which results in impressing a person with the degradation of image quality beyond the actual fading rate of each dye. Therefore, improvement of image fastness, particularly maintenance of color balance is an important problem to be solved.

### SUMMARY OF THE INVENTION

The present invention resides in an image-forming method comprising

employing

a heat-sensitive transfer image-receiving sheet having a support, at least one dye receptor layer on the support, and at least one heat insulation layer containing both hollow polymer particles and a hydrophilic polymer, the heat insulation layer being disposed between the receptor layer and the support, and

a heat-sensitive transfer sheet having at least one yellow heat transfer layer, at least one magenta heat transfer layer, and/or at least one cyan heat transfer layer on a support,
wherein a yellow dye incorporated in the yellow heat transfer layer contains at least one compound represented by formula (Y) set forth below, and a cyan dye incorporated in the cyan heat transfer layer is exclusively composed of at least one compound represented by formula (C) set forth below:

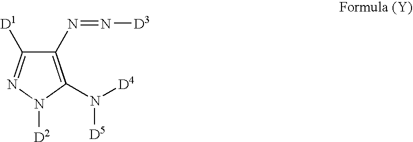

wherein, in formula (Y), D¹ represents a hydrogen atom, an alkyl group, an alkoxy group, an aryl group, an alkoxycarbonyl group, a cyano group, or a carbamoyl group; D² represents a hydrogen atom, an alkyl group, an aryl group, or a heteroaryl group; D³ represents an aryl group or a heteroaryl group; D⁴ and D⁵ each independently represent a hydrogen atom or an alkyl group; and each of the above-mentioned groups may further be substituted;

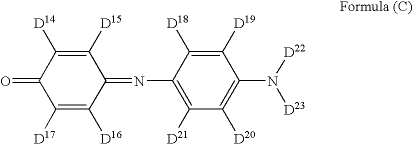

wherein, in formula (C), D¹⁴, D¹⁵, D¹⁶, D¹⁷, D¹⁸, D¹⁹, D²⁰, and D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D²² and D²³ each independently represent a hydrogen atom, an alkyl group, or an aryl group; D²² and D²³ may be bonded together to form a ring; D¹⁹ and D²² and/or D²⁰ and D²³ may be bonded together to form a ring; and each of the above-mentioned groups may further be substituted.

Further, the present invention resides in an image-forming method comprising

employing

a heat-sensitive transfer image-receiving sheet having a support, at least one receptor layer on the support, and at least one heat insulation layer containing both hollow polymer particles and a hydrophilic polymer, the heat insulation layer being disposed between the receptor layer and the support, and

a heat-sensitive transfer sheet having three kinds of heat transfer layers of at least yellow, magenta, and cyan, on the support,
wherein a magenta dye incorporated in the magenta heat transfer layer contains at least one compound represented by formula (M) set forth below, a yellow dye incorporated in the yellow heat transfer layer contains at least one compound represented by formula (YA), (YB), (YC), (YD), or (YE) set forth below, and a cyan dye incorporated in the cyan heat transfer layer contains at least one compound represented by formula (C1) or (C) set forth below;

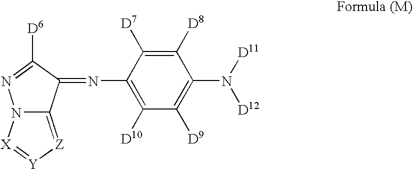

wherein, in formula (M), D⁶, D⁷, D⁸, D⁹, and D¹⁰ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D¹¹ and D¹² each independently represent a hydrogen atom, an alkyl group, or an aryl group; D¹¹ and D¹² may be bonded together to form a ring; D⁸ and D¹¹ and/or D⁹ and D¹² may be bonded together to form a ring; X, Y, and Z each independently represent ═C(D¹³)- or a nitrogen atom, in which D¹³ represents a hydrogen atom, an alkyl group, an aryl group, an alkoxy group, an aryloxy group, or an amino group; when X and Y each represents ═C(D¹³)- or Y and Z each represents ═C(D¹³)-, two D¹³s may be bonded together to form a saturated or unsaturated carbon ring; and each of the above-mentioned groups may further be substituted;

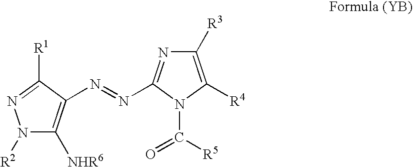

wherein, in formula (YB), R¹, R², R³, R⁴, and R⁶ each independently represent a hydrogen atom or a monovalent substituent; and R⁵ represents a monovalent substituent;

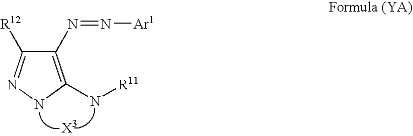

wherein, in formula (YA), R¹¹ represents a monovalent substituent; R¹² represents a hydrogen atom or a monovalent substituent; Ar¹ represents a group selected from the members of the heterocyclic group set (1) set forth below; and X³ represents atoms necessary to form a ring;

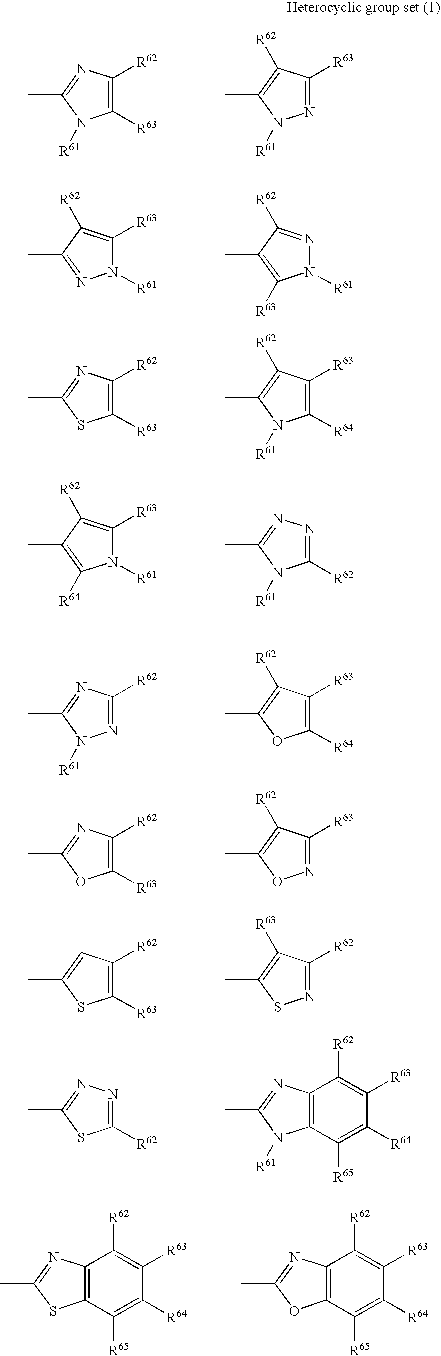

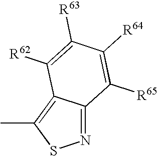

wherein, in the heterocyclic group set (1), R⁶¹, R⁶², R⁶³, R⁶⁴, and R⁶⁵ each independently represent a hydrogen atom or a substituent;

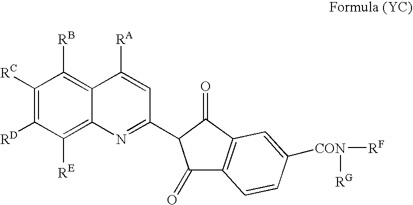

wherein, in formula (YC), R^{A}, R^{B}, R^{C}, R^{D}, and R^{E} each independently represent a hydrogen atom, a halogen atom, an alkyl group having 1 to 8 carbon atoms, a cycloalkyl group, an alkoxy group, an alkoxyalkoxy group, an alkoxycarbonyl group, a thioalkoxy group, an alkylsulfonyl group, an amino group, a substituted or unsubstituted phenoxy group, or a substituted or unsubstituted thiophenoxy group; R^{F} and R^{G} each independently represent a hydrogen atom, an alkyl group, an alkoxyalkyl group, a cycloalkyl group, an allyl group, an optionally substituted aryl group, an aralkyl group, a furfuryl group, a tetrahydrofuryl group, a tetrahydrofurfuryl group, or a hydroxylalkyl group; each of these groups may further be substituted;

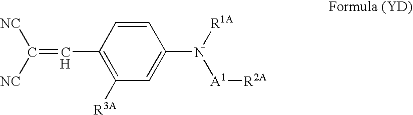

wherein, in formula (YD), R^{1A} represents an allyl group or an alkyl group; R^{2A} represents a substituted or unsubstituted alkyl group or aryl group; A¹ represents —CH₂—, —CH₂CH₂—, —CH₂CH₂O—, —CH₂CH₂OCH₂—, or —CH₂CH₂OCH₂CH₂—; R^{3A} represents an alkyl group; each of these groups may further be substituted;

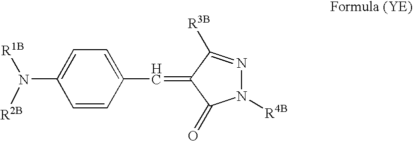

wherein, in formula (YE), R^{1B}, R^{2B}, R^{3B}, and R^{4B} each independently represent a hydrogen atom or a substituent;

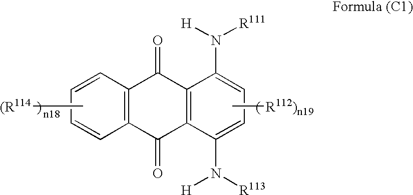

wherein, in formula (C1), R¹¹¹ and R¹¹³ each independently represent a hydrogen atom or a substituent; R¹¹² and R¹¹⁴ each independently represent a substituent; n18 represents an integer of 0 to 4; n19 represents an integer of 0 to 2; when n18 represents an integer of 2 to 4, R¹¹⁴s may be the same or different from each other; and when n19 represents 2, R¹¹²s may be the same or different from each other; each of these groups may further be substituted;

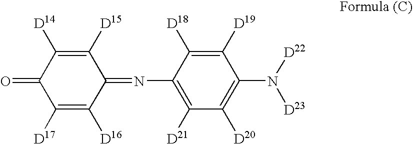

wherein, in formula (C), D¹⁴, D¹⁵, D¹⁶, D¹⁷, D¹⁸, D⁹, D²⁰, and D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D²² and D²³ each independently represent a hydrogen atom, an alkyl group, or an aryl group; D¹⁷ and D¹⁶ may be bonded together to form a ring; D²² and D²³ may be bonded together to form a ring; D¹⁹ and D²² and/or D²⁰ and D²³ may be bonded together to form a ring; and each of the above-mentioned groups may further be substituted.

Further, the present invention resides in an image-forming method comprising:

employing

a heat-sensitive transfer image-receiving sheet having a support, at least one receptor layer on the support, and at least one heat insulation layer containing both hollow polymer particles and a hydrophilic polymer, the heat insulation layer being disposed between the receptor layer and the support, and

a heat-sensitive transfer sheet having three kinds of heat transfer layers of at least yellow, magenta, and cyan, on the support,
wherein a magenta dye incorporated in the magenta heat transfer layer contains at least one compound represented by formula (M) set forth below, and a cyan dye incorporated in the cyan heat transfer layer is exclusively composed of at least one compound represented by formula (C) set forth below:

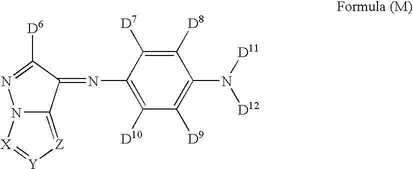

wherein, in formula (M), D⁶, D⁷, D⁸, D⁹, and D¹⁰ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D¹¹ and D¹² each independently represent a hydrogen atom, an alkyl group, or an aryl group; D¹¹ and D¹² may be bonded together to form a ring; D⁸ and D¹¹ and/or D⁹ and D¹² may be bonded together to form a ring; X, Y, and Z each independently represent ═C(D¹³)- or a nitrogen atom, in which D¹³ represents a hydrogen atom, an alkyl group, an aryl group, an alkoxy group, an aryloxy group, or an amino group; when X and Y each represents ═C(D¹³)- or Y and Z each represents ═C(D¹³)-, two D¹³s may be bonded together to form a saturated or unsaturated carbon ring; and each of the above-mentioned groups may further be substituted;

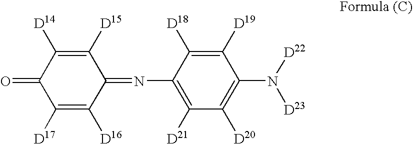

wherein, in formula (C), D¹⁴, D¹⁵, D¹⁶, D¹⁷, D¹⁸, D¹⁹, D²⁰, and D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D²² and D²³ each independently represent a hydrogen atom, an alkyl group, or an aryl group; D²² and D²³ may be bonded together to form a ring; D¹⁹ and D²² and/or D²⁰ and D²³ may be bonded together to form a ring; and each of the above-mentioned groups may further be substituted.

Other and further features and advantages of the invention will appear more fully from the following description.

### DETAILED DESCRIPTION OF THE INVENTION

The present invention provides the following means:

(1) An image-forming method comprising

employing

a heat-sensitive transfer image-receiving sheet having a support, at least one dye receptor layer on the support, and at least one heat insulation layer containing both hollow polymer particles and a hydrophilic polymer, the heat insulation layer being disposed between the receptor layer and the support, and

a heat-sensitive transfer sheet having at least one yellow heat transfer layer, at least one magenta heat transfer layer, and/or at least one cyan heat transfer layer on a support,
wherein a yellow dye incorporated in the yellow heat transfer layer contains at least one compound represented by formula (Y) set forth below, and a cyan dye incorporated in the cyan heat transfer layer is exclusively composed of at least one compound represented by formula (C) set forth below:

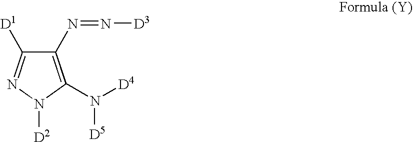

wherein, in formula (Y), D¹ represents a hydrogen atom, an alkyl group, an alkoxy group, an aryl group, an alkoxycarbonyl group, a cyano group, or a carbamoyl group; D² represents a hydrogen atom, an alkyl group, an aryl group, or a heteroaryl group; D³ represents an aryl group or a heteroaryl group; D⁴ and D⁵ each independently represent a hydrogen atom or an alkyl group; and each of the above-mentioned groups may further be substituted;

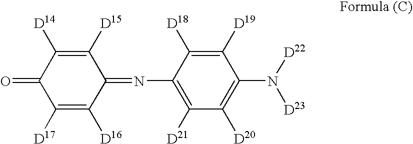

wherein, in formula (C), D¹⁴, D¹⁵, D¹⁶, D¹⁷, D¹⁸, D¹⁹, D²⁰, and D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D²² and D²³ each independently represent a hydrogen atom, an alkyl group, or an aryl group; D²² and D²³ may be bonded together to form a ring; D¹⁹ and D²² and/or D²⁰ and D²³ may be bonded together to form a ring; and each of the above-mentioned groups may further be substituted.

(2) The image-forming method as described in the above item (1), wherein at least one magenta dye contained in the magenta heat transfer layer disposed in the heat-sensitive transfer sheet is a compound represented by formula (M1), (M2), (M3), or (M4):

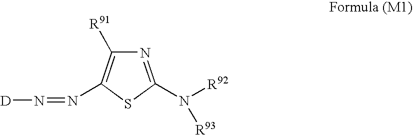

wherein, in formula (M1), R⁹¹ represents a hydrogen atom, a substituted or unsubstituted alkyl group, cycloalkyl group, aryl group, or heterocyclic group; R⁹² and R⁹³ each independently represent a hydrogen atom, a substituted or unsubstituted alkyl group, alkoxy group, cycloalkyl group, or aryl group; and D represents an optionally substituted aryl group or heterocyclic group;
A-N═N-E Formula (M2)

wherein, in formula (M2), A represents an optionally substituted heterocyclic group whose heterocyclic ring is selected from a group consisting of imidazole, pyrazole, thiazole, benzothiazole, isothiazole, benzoisothiazole, and thiophene; and E represents an optionally substituted aminophenyl group, tetrahydroquinolinyl group, julolidyl group, or aminoquinolinyl group;

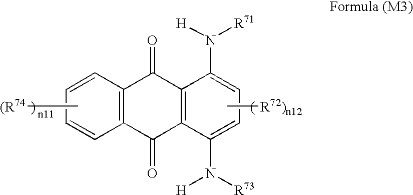

wherein, in formula (M3), R⁷¹ and R⁷³ each independently represent a hydrogen atom or a substituent; R⁷² and R⁷⁴ each independently represent a substituent; n11 represents an integer of 0 to 4; n12 represents an integer of 0 to 2; when n11 represents an integer of 2 to 4, R⁷⁴s may be the same or different from each other; and when n12 represents 2, R⁷²s may be the same or different from each other;

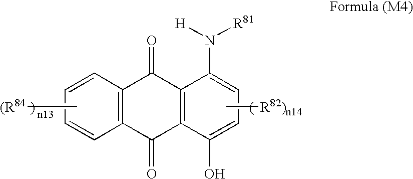

wherein, in formula (M4), R⁸¹ represents a hydrogen atom or a substituent; R⁸² and R⁸⁴ each independently represent a substituent; n13 represents an integer of 0 to 4; n14 represents an integer of 0 to 2; when n13 represents an integer of 2 to 4, R⁸⁴s may be the same or different from each other; and when n14 represents 2, R⁸²s may be the same or different from each other.

(3) The image-forming method as described in the above item (1) or (2), wherein the heat-sensitive transfer sheet has at least three kinds of heat transfer layers comprising yellow, magenta, and cyan, formed panel sequentially, on the surface of the same support.

(4) The image-forming method as described in any one of the above items (1) to (3), wherein the heat-sensitive transfer sheet further has a heat transferable protective layer.

(5) The image-forming method as described in the above item (4), wherein the heat transferable protective layer has the maximum absorption within the wavelength region of from 330 nm to 370 nm and exhibits absorption density of 0.8 or more at the maximum absorption wavelength.

(6) The image-forming method as described in any one of the above items (1) to (5), wherein at least one of the hydrophilic polymer contained in the heat insulation layer of the heat-sensitive transfer image-receiving sheet is gelatin.

(7) The image-forming method as described in any of the above items (1) to (6), comprising the steps of:

superposing the heat-sensitive transfer sheet on the heat-sensitive transfer image-receiving sheet so that the receptor layer of the heat-sensitive transfer image-receiving sheet is in contact with the heat transfer layer of the heat-sensitive transfer sheet; and

giving thermal energy from a thermal head in accordance with image signals, thereby to form an image.

(8) An image-forming method comprising

employing

a heat-sensitive transfer image-receiving sheet having a support, at least one receptor layer on the support, and at least one heat insulation layer containing both hollow polymer particles and a hydrophilic polymer, the heat insulation layer being disposed between the receptor layer and the support, and

a heat-sensitive transfer sheet having three kinds of heat transfer layers of at least yellow, magenta, and cyan, on the support,
wherein a magenta dye incorporated in the magenta heat transfer layer contains at least one compound represented by formula (M) set forth below, a yellow dye incorporated in the yellow heat transfer layer contains at least one compound represented by formula (YA), (YB), (YC), (YD), or (YE) set forth below, and a cyan dye incorporated in the cyan heat transfer layer contains at least one compound represented by formula (C1) or (C) set forth below;

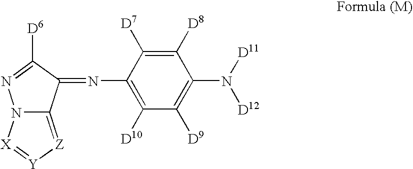

wherein, in formula (M), D⁶, D⁷, D⁸, D⁹, and D¹⁰ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D¹¹ and D¹² each independently represent a hydrogen atom, an alkyl group, or an aryl group; D¹¹ and D¹² may be bonded together to form a ring; D⁸ and D¹¹ and/or D⁹ and D¹² may be bonded together to form a ring; X, Y, and Z each independently represent ═C(D¹³)- or a nitrogen atom, in which D³ represents a hydrogen atom, an alkyl group, an aryl group, an alkoxy group, an aryloxy group, or an amino group; when X and Y each represents ═C(D¹³)- or Y and Z each represents ═C(D¹³)-, two D¹³s may be bonded together to form a saturated or unsaturated carbon ring; and each of the above-mentioned groups may further be substituted;

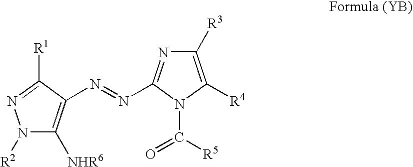

wherein, in formula (YB), R¹, R², R³, R⁴, and R⁶ each independently represent a hydrogen atom or a monovalent substituent; and R⁵ represents a monovalent substituent;

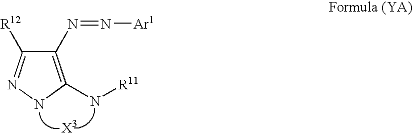

wherein, in formula (YA), R¹¹ represents a monovalent substituent; R¹² represents a hydrogen atom or a monovalent substituent; Ar¹ represents a group selected from the members of the heterocyclic group set (1) set forth below; and X³ represents atoms necessary to form a ring;

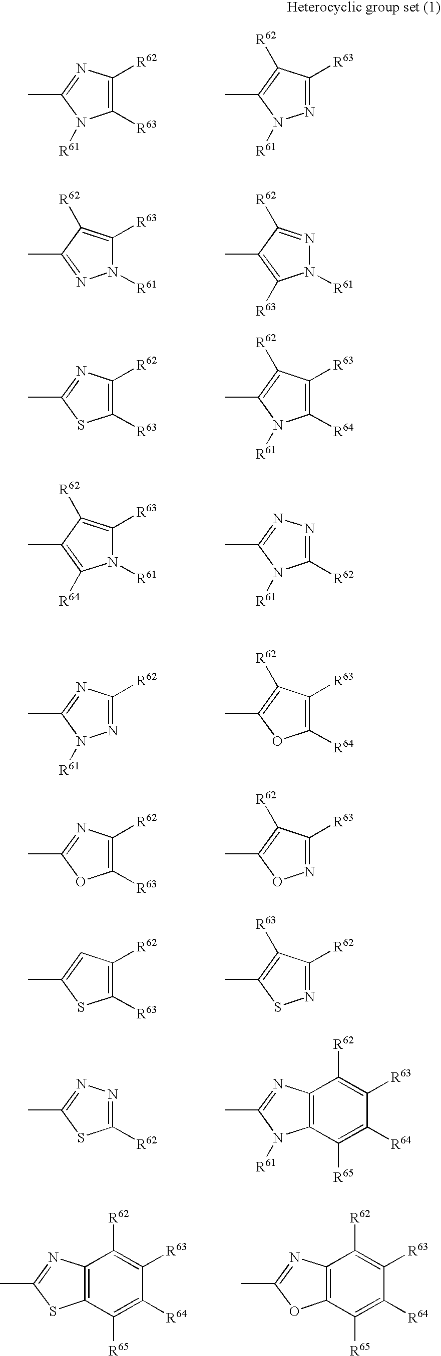

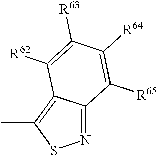

wherein, in the heterocyclic group set (I), R⁶¹, R⁶², R⁶³, R⁶⁴, and R⁶⁵ each independently represent a hydrogen atom or a substituent;

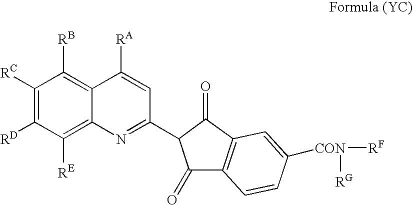

wherein, in formula (YC), R^{A}, R^{B}, R^{C}, R^{D}, and R^{E} each independently represent a hydrogen atom, a halogen atom, an alkyl group having 1 to 8 carbon atoms, a cycloalkyl group, an alkoxy group, an alkoxyalkoxy group, an alkoxycarbonyl group, a thioalkoxy group, an alkylsulfonyl group, an amino group, a substituted or unsubstituted phenoxy group, or a substituted or unsubstituted thiophenoxy group; R^{F} and R^{G} each independently represent a hydrogen atom, an alkyl group, an alkoxyalkyl group, a cycloalkyl group, an allyl group, an optionally substituted aryl group, an aralkyl group, a furfuryl group, a tetrahydrofuryl group, a tetrahydrofurfuryl group, or a hydroxylalkyl group; each of these groups may further be substituted;

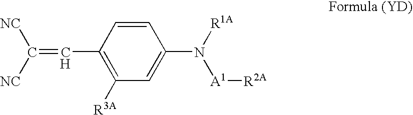

wherein, in formula (YD), R^{1A} represents an allyl group or an alkyl group; R^{2A} represents a substituted or unsubstituted alkyl group or aryl group; A¹ represents —CH₂—, —CH₂CH₂—, —CH₂CH₂O—, —CH₂CH₂OCH₂—, or —CH₂CH₂OCH₂CH₂—; R^{3A} represents an alkyl group; each of these groups may further be substituted;

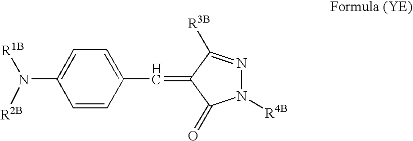

wherein, in formula (YE), R^{1B}, R^{2B}, R^{3B}, and R^{4B} each independently represent a hydrogen atom or a substituent;

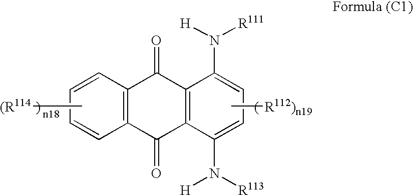

wherein, in formula (C1), R¹¹¹ and R¹¹³ each independently represent a hydrogen atom or a substituent; R¹¹² and R¹⁴ each independently represent a substituent; n18 represents an integer of 0 to 4; n19 represents an integer of 0 to 2; when n18 represents an integer of 2 to 4, R¹¹⁴s may be the same or different from each other; and when n19 represents 2, R¹¹²s may be the same or different from each other; each of these groups may further be substituted;

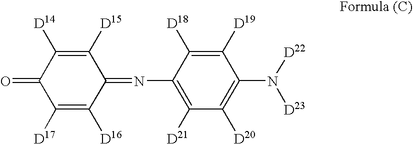

wherein, in formula (C), D¹⁴, D¹⁵, D¹⁶, D¹⁷, D¹⁸, D¹⁹, D²⁰, and D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D²² and D²³ each independently represent a hydrogen atom, an alkyl group, or an aryl group; D¹⁷ and D¹⁶ may be bonded together to form a ring; D²² and D²³ may be bonded together to form a ring; D¹⁹ and D²² and/or D²⁰ and D²³ may be bonded together to form a ring; and each of the above-mentioned groups may further be substituted.

(9) The image-forming method as described in the above item (8), wherein, in formula (M), X and Z each represent a nitrogen atom, and Y represents ═C(D¹³)-.

(10) The image-forming method as described in the above item (8) or (9), wherein the heat-sensitive transfer sheet has at least three kinds of heat transfer layers comprising yellow, magenta, and cyan, formed panel sequentially, on the surface of the same support.

(11) The image-forming method as described in any one of the items (8) to (10), wherein at least one of the hydrophilic polymer contained in the heat insulation layer of the heat-sensitive transfer image-receiving sheet is gelatin.

(12) The image-forming method as described in any of the above items (8) to (11), comprising the steps of:

superposing the heat-sensitive transfer sheet on the heat-sensitive transfer image-receiving sheet so that the receptor layer of the heat-sensitive transfer image-receiving sheet is in contact with the heat transfer layer of the heat-sensitive transfer sheet; and

giving thermal energy from a thermal head in accordance with image signals, thereby to form an image.

(13) An image-forming method comprising:

employing

a heat-sensitive transfer image-receiving sheet having a support, at least one receptor layer on the support, and at least one heat insulation layer containing both hollow polymer particles and a hydrophilic polymer, the heat insulation layer being disposed between the receptor layer and the support, and

a heat-sensitive transfer sheet having three kinds of heat transfer layers of at least yellow, magenta, and cyan, on the support,
wherein a magenta dye incorporated in the magenta heat transfer layer contains at least one compound represented by formula (M) set forth below, and a cyan dye incorporated in the cyan heat transfer layer is exclusively composed of at least one compound represented by formula (C) set forth below:

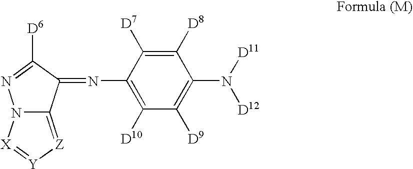

wherein, in formula (M), D⁶, D⁷, D⁸, D⁹, and D¹⁰ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D¹¹ and D¹² each independently represent a hydrogen atom, an alkyl group, or an aryl group; D¹¹ and D¹² may be bonded together to form a ring; D′ and D″ and/or D⁹ and D¹² may be bonded together to form a ring; X, Y, and Z each independently represent ═C(D¹³)- or a nitrogen atom, in which D¹³ represents a hydrogen atom, an alkyl group, an aryl group, an alkoxy group, an aryloxy group, or an amino group; when X and Y each represents ═C(D¹³)- or Y and Z each represents ═C(D¹³)-, two D¹³s may be bonded together to form a saturated or unsaturated carbon ring; and each of the above-mentioned groups may further be substituted;

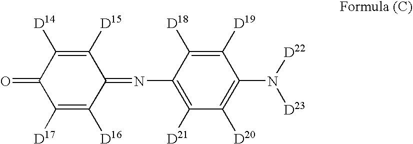

wherein, in formula (C), D¹⁴, D¹⁵, D¹⁶, D¹⁷, D¹⁸, D¹⁹, D²⁰, and D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D²² and D²³ each independently represent a hydrogen atom, an alkyl group, or an aryl group; D²² and D²³ may be bonded together to form a ring; D¹⁹ and D²² and/or D²⁰ and D²³ may be bonded together to form a ring; and each of the above-mentioned groups may further be substituted.

(14) The image-forming method as described in the above item (13), wherein at least one yellow dye contained in the yellow heat transfer layer disposed in the heat-sensitive transfer sheet is a compound represented by formula (YA), (YB), (YC), (YD), or (YE):

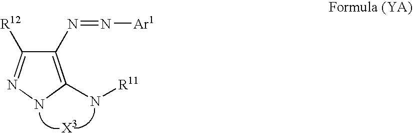

wherein, in formula (YA), R¹¹ represents a monovalent substituent; R¹² represents a hydrogen atom or a monovalent substituent; Ar¹ represents a group selected from the members of the heterocyclic group set (1) set forth below; and X³ represents atoms necessary to form a ring;

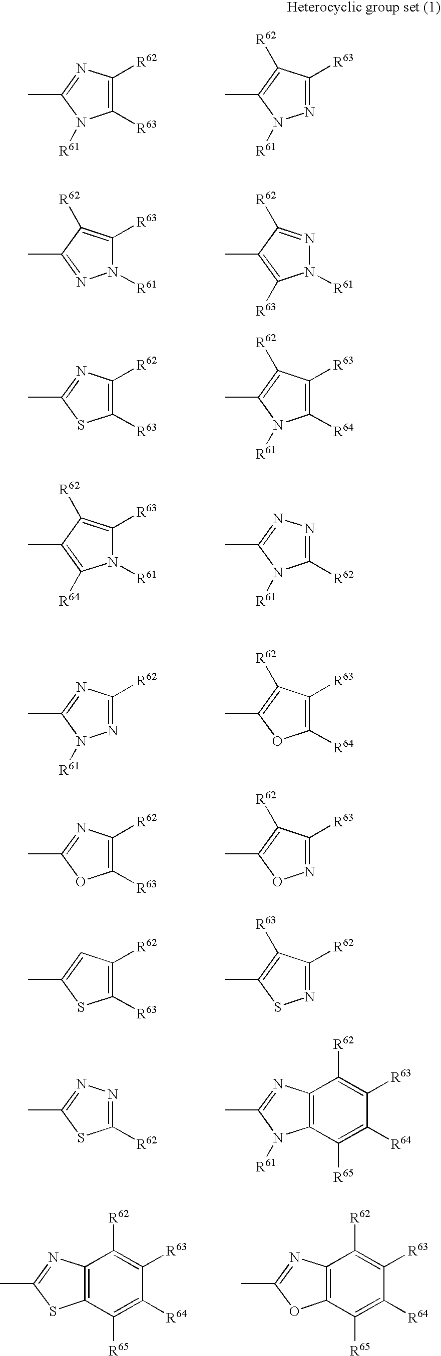

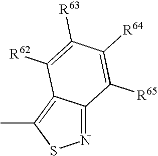

wherein, in the heterocyclic group set (I), R⁶¹, R⁶², R⁶³, R⁶⁴ and R⁶⁵ each independently represent a hydrogen atom or a substituent;

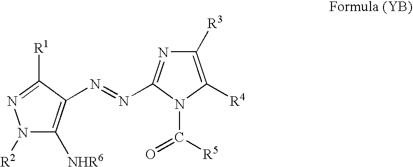

wherein, in formula (YB), R¹, R², R³, R⁴, and R⁶ each independently represent a hydrogen atom or a monovalent substituent; and R⁵ represents a monovalent substituent;

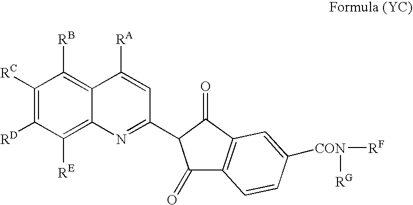

wherein, in formula (YC), R^{A}, R^{B}, R^{C}, R^{D}, and R^{E} each independently represent a hydrogen atom, a halogen atom, an alkyl group having 1 to 8 carbon atoms, a cycloalkyl group, an alkoxy group, an alkoxyalkoxy group, an alkoxycarbonyl group, a thioalkoxy group, an alkylsulfonyl group, an amino group, a substituted or unsubstituted phenoxy group, or a substituted or unsubstituted thiophenoxy group; R^{F} and R^{G} each independently represent a hydrogen atom, an alkyl group, an alkoxyalkyl group, a cycloalkyl group, an allyl group, an optionally substituted aryl group, an aralkyl group, a furfuryl group, a tetrahydrofuryl group, a tetrahydrofurfuryl group, or a hydroxylalkyl group; each of these groups may further be substituted;

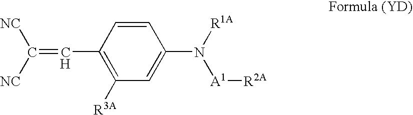

wherein, in formula (YD), R^{1A} represents an allyl group or an alkyl group; R^{2A} represents a substituted or unsubstituted alkyl group or aryl group; A¹ represents —CH₂—, —CH₂CH₂—, —CH₂CH₂O—, —CH₂CH₂OCH₂—, or —CH₂CH₂OCH₂CH₂—; R^{3A} represents an alkyl group; each of these groups may further be substituted;

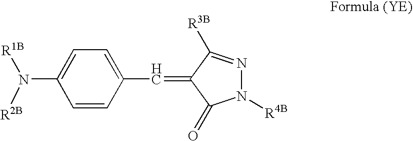

wherein, in formula (YE), R^{1B} and R^{2B} each independently represent a hydrogen atom, an optionally substituted alkyl group, an allyl group, an optionally substituted aryl group, or an optionally substituted cycloalkyl group; R^{3B} represents a hydrogen atom, an optionally substituted alkyl group, a NR^{5C}R^{6C} group, an optionally substituted alkoxy group, an optionally substituted alkoxycarbonyl group, an optionally substituted aryl group, or a C(O)NR^{5D}R^{6D} group; R^{4B}, R^{5C}, R^{5D}, R^{6C}, and R^{6D} each independently represent a hydrogen atom, an optionally substituted alkyl group, or an optionally substituted aryl group.

(15) The image-forming method as described in the above item (13) or (14), wherein at least one of a yellow dye contained in the yellow heat transfer layer disposed in the heat-sensitive transfer sheet is a compound represented by the above-described formula (YA) or (YB).

(16) The image-forming method as described in any one of the above items (13) to (15), wherein with respect to the above-described formula (M), X and Z are a nitrogen atom and Y is a ═C(D¹³)-, wherein D¹³ represents a hydrogen atom, an alkyl group, an aryl group, an alkoxy group, an aryloxy group, or an amino group.

(17) The image-forming method as described in any one of the above items (13) to (116), wherein the heat-sensitive transfer sheet has at least three kinds of heat transfer layers comprising yellow, magenta, and cyan, formed panel sequentially, on the surface of the same support.

(18) The image-forming method as described in any one of the above items (13) to (117), wherein the heat-sensitive transfer sheet further has a heat transferable protective layer.

(19) The image-forming method as described in the above item (18), wherein the heat transferable protective layer has a maximum absorption within the wavelength region of from 330 nm to 370 nm and exhibits an absorption density of 0.8 or more at the maximum absorption wavelength.

(20) The image-forming method as described in any one of the above items (13) to (119), wherein at least one of the hydrophilic polymer contained in the heat insulation layer of the heat-sensitive transfer image-receiving sheet is gelatin.

(21) The image-forming method as described in any of the above items (13) to (20), comprising the steps of:

superposing the heat-sensitive transfer sheet on the heat-sensitive transfer image-receiving sheet so that the receptor layer of the heat-sensitive transfer image-receiving sheet is in contact with the heat transfer layer of the heat-sensitive transfer sheet; and

giving thermal energy from a thermal head in accordance with image signals, thereby to form an image.

Hereinafter, a first embodiment of the present invention means to include the image-forming method as described in the items (1) to (7) above.

Further, a second embodiment of the present invention means to include the image-forming method as described in the items (8) to (12) above.

Further, a third embodiment of the present invention means to include the image-forming method as described in the items (13) to (21) above.

Herein, the present invention means to include all of the above first, second, and third embodiments, unless otherwise specified.

The present invention will be explained in detail below.

(1) Heat-Sensitive Transfer Image-Receiving Sheet

First, the heat-sensitive transfer image-receiving sheet (hereinafter also referred to as an image-receiving sheet) used in the present invention will be explained.

The heat-sensitive (thermal) transfer image-receiving sheet used in the present invention is provided with at least one dye-receiving layer (receptor layer) on a support, and at least one heat insulation layer (porous layer) between the support and the receptor layer. Moreover, an undercoat layer such as a white-background-control layer, a charge-control layer (an electrification-control layer), an adhesive layer, and a primer layer, may be provided between the receptor layer and the heat insulation layer.

The receptor layer and the heat insulation layer are preferably formed by a simultaneous multi-layer coating. When the undercoat layer is provided, the receptor layer, the undercoat layer, and the heat insulation layer may be formed by the simultaneous multi-layer coating.

It is preferable that a curling control layer, a writing layer, or a charge-control layer be formed on the backside of the support. Each of these layers may be applied using a usual method such as a roll coating, a bar coating, a gravure coating, and a gravure reverse coating.

<Receptor Layer>

[Thermoplastic Resin]

In the present invention, a thermoplastic resin is preferably used in the receptor layer. Examples of the thermoplastic resin (polymer) that is preferably used in the receptor layer in the present invention include vinyl-series resins, such as halogenated polymers (e.g., polyvinyl chloride and polyvinylidene chloride), polyvinyl acetate, ethylene-vinyl acetate copolymer, vinyl chloride-vinyl acetate copolymer, polyacryl ester, polystylene, and polystylene acrylate; acetal-series resins, such as polyvinylformal, polyvinylbutyral and polyvinylacetal; polyester-series resins, such as polyethylene terephthalate, polybutylene terephthalate and polycaprolactone (e.g., PLACCEL H-5 (trade name) manufactured by DAICEL CHEMICAL INDUSTRIES, LTD.); polycarbonate-series resins; cellulose-series resins, such as those described in JP-A-4-296595 and JP-A-2002-264543; cellulose-series resins, such as cellulose acetate butyrate (e.g., CAB551-0.2 and CAB321-0.1 (each trade name) manufactured by Eastman Chemical Company); polyolefin-series resins, such as polypropylene; and polyamide-series resins, such as urea resins, melamine resins and benzoguanamine resins. These resins may be used optionally blending with each other in the range of compatibility. Resins used for forming the receptor layer are also disclosed in JP-A-57-169370, JP-A-57-207250 and JP-A-60-25793.

It is further preferable that, among these polymers, the receptor layer preferably contain a polycarbonate, a polyester, a polyurethane, a polyvinyl chloride or its copolymer, a styrene-acrylonitrile copolymer, a polycaprolactone, or a mixture of two or more of these. It is particularly preferable that the receptor layer contain a polycarbonate, a polyester, a polyvinyl chloride or its copolymer, or a mixture of two or more of these. The following is a more detailed explanation of polycarbonate, polyester, and polyvinyl chloride. Incidentally, these polymers may be used singly or as mixtures thereof.

(Polyester Polymers)

The polyester polymers used in the receptor layer in the present invention is explained in more detail.

The polyester polymers are obtained by polycondensation of a dicarboxylic acid component (including a derivative thereof) and a diol component (including a derivative thereof). The polyester polymers preferably contain an aromatic ring and/or an aliphatic ring. As to technologies related to the alicyclic polyester, those described in JP-A-5-238167 are useful from the viewpoints of ability to incorporate a dye and image stability.

Examples of the dicarboxylic acid component include adipic acid, azelaic acid, isophtharic acid, trimellitic acid, terephtharic acid, 1,4-cyclohexane dicarboxylic acid, and a mixture of two or more of these acids. The dicarboxylic acid component is preferably isophtharic acid, trimellitic acid, terephtharic acid, or a mixture of two or more of these acids. From a viewpoint of improvement in light resistance, a dicarboxylic acid component having an alicyclic structure is more preferable as the dicarboxylic acid component. The dicarboxylic acid component is further preferably 1,4-cyclohexane dicarboxylic acid or isophtharic acid. Specifically, as the dicarboxylic acid component, a mixture of isophtharic acid in an amount of 50 to 100 mol %, trimellitic acid in an amount of 0 to 1 mol %, terephtharic acid in an amount of 0 to 50 mol %, and 1,4-cyclohexane dicarboxylic acid in an amount of 0 to 15 mol %, in which a total amount of these components is 100 mol %, is furthermore preferably used.

Examples of the diol component include ethylene glycol, polyethylene glycol, tricyclodecane dimethanol, 1,4-butanediol, bisphenol, and a mixture of two or more of these diols. The diol component is preferably ethylene glycol, polyethylene glycol or tricyclodecane dimethanol. From a viewpoint of improvement in light resistance, a diol component having an alicyclic structure is more preferable as the diol component. Use can be made of an alicyclic diol component such as cyclohexanediol, cyclohexanedimethanol and cyclohexanediethanol, in addition to tricyclodecane dimethanol. The alicyclic diol component is preferably tricyclodecane dimethanol. Specifically, as the diol component, a mixture of ethylene glycol in an amount of 0 to 50 mol %, polyethylene glycol in an amount of 0 to 10 mol %, tricyclodecane dimethanol in an amount of 0 to 90 mol % (preferably from 30 to 90 mol %, more preferably from 40 to 90 mol %), 1,4-butanediol in an amount of 0 to 50 mol %, and bisphenol A in an amount of 0 to 50 mol %, in which a total amount of these components is 100 mol %, is furthermore preferably used.

In the present invention, as the polyester polymers, it is preferable to use polyester polymers obtained by polycondensation using at least one of the above-described dicarboxylic acid component and at least one of the above-described diol component, so that the thus-obtained polyester polymers could have a molecular weight (mass average molecular weight (Mw)) of generally about 11,000 or more, preferably about 15,000 or more, and more preferably about 17,000 or more. If polyester polymers of too low molecular weight are used, elastic coefficient of the formed receptor layer becomes low and also it raises lack of thermal resistance. Resultantly, it sometimes becomes difficult to assure the releasing property of the heat-sensitive transfer sheet and the image-receiving sheet. A higher molecular weight is more preferable from a viewpoint of increase in elastic coefficient. The molecular weight is not limited in particular, so long as such failure does not occur that a higher molecular weight makes the polymer difficult to be dissolved in a solvent for a coating solution at the time of forming the receptor layer, or that an adverse effect arises in adhesive properties of the receptor layer to a substrate sheet after coating and drying the receptor layer. However, the molecular weight is preferably about 25,000 or less, and at highest a degree of about 30,000. The polyester polymers may be synthesized according to a known method.

Examples of a saturated polyester used as the polyester polymers, include VYLON 200, VYLON 290 and VYLON 600 (each trade name, manufactured by Toyobo Co., Ltd.), KA-1038C (trade name, manufactured by Arakawa Chemical Industries, Ltd.), and TP220 and TP235 (each trade name, manufactured by The Nippon Synthetic Chemical Industry Co., Ltd.).

(Polycarbonate Polymers)

The polycarbonate-series polymer used in the receptor layer in the present invention is explained in more detail.

The polycarbonate polymers mean a polyester composed of a carbonic acid and a diol as a unit. The polycarbonate polymers can be synthesized by, for example, a method in which a diol and a phosgene are reacted or a method in which a diol and a carbonic acid ester are reacted.

Examples of the diol component include bisphenol A, ethylene glycol, propylene glycol, diethylene glycol, butanediol, pentanediol, hexanediol, 1,4-cyclohexanedimethanol, nonanediol, 4,4′-bicyclo(2,2,2,)hepto-2-ylidene bisphenol, 4,4′-(octahydro-4,7-methano-5H-indene-5-ylidene)bisphenol and 2,2′,6,6′-tetrachloro bisphenol A. Preferred are bisphenol A, ethylene glycol, diethylene glycol, butanediol and pentanediol. More preferred are bisphenol A, ethylene glycol and butanediol. Especially preferred are bisphenol A and ethylene glycol. As for the polycarbonate polymers used in the present invention, at least one of the above-described diol components is used. A plurality of diols may be used as a mixture thereof.

The following is a detailed explanation of a bisphenol A-polycarbonate that is an especially preferred embodiment.

Technologies related to unmodified polycarbonates that center around the bisphenol A-polycarbonate are described in U.S. Pat. No. 4,695,286. The polycarbonate polymers used in the present invention are a polycondensation compound having a molecular weight (weight average molecular weight (Mw)) of generally about 1,000 or more, preferably about 3,000 or more, more preferably about 5,000 or more, and especially preferably about 10,000 or more. Specific examples of the polycarbonate polymers include Makrolon-5700 (trade name, manufactured by Bayer AG) and LEXAN-141 (trade name, manufactured by General Electric Corporation).

Technologies of producing modified polycarbonates by mixing bisphenol A with a diol such as ethylene glycol are described in U.S. Pat. No. 4,927,803. The polyether block unit may be produced from a linear aliphatic diol having 2 to about 10 carbon atoms. But, a polyether block unit produced from ethylene glycol is preferred. In a preferred embodiment of the present invention, the polyether block unit has a number molecular weight of about 4,000 to about 50,000, while the bisphenol A-polycarbonate block unit has a number molecular weight of about 15,000 to about 250,000. A molecular weight of the whole block copolymer is preferably in the range of about 30,000 to about 300,000. Specific examples thereof include Makrolon KL3-1013 (trade name, manufactured by Bayer AG).

It is also preferable that these unmodified and modified bisphenol A-polycarbonates are mixed together. Specifically, it is preferred to blend an unmodified bisphenol A-polycarbonate with a polyether-modified polycarbonate in a ratio by mass of from 80:20 to 10:90. The ratio by mass of from 50:50 to 40:60 is especially preferred from a viewpoint of improvement in resistance to finger print. Technologies of blending the unmodified and modified bisphenol A-polycarbonates are also described in JP-A-6-227160.

As for a preferable embodiment of the thermoplastic resin (polymers) used in the receptor layer, use can be made of a blend of the above-described polycarbonate polymers and the above-described polyester polymers. In the blend, it is preferred to secure compatibility of the polycarbonate polymers and the polyester polymers. The polyester polymers preferably have a glass transition temperature (Tg) of about 40° C. to about 100° C., and the polycarbonate polymers preferably have a Tg of about 100° C. to about 200° C. It is preferable that the polyester polymers have a Tg lower than that of the polycarbonate polymers and act as a plasticizer to the polycarbonate polymers. A preferable Tg of a finished polyester/polycarbonate blend is in the range of 40° C. to 100° C. Even though a polyester/polycarbonate blend polymer has a higher Tg, it may be used advantageously by addition of a plasticizer.

In a further preferable embodiment, an unmodified bisphenol A-polycarbonate and polyester polymers are blended in such a ratio by mass that a Tg of the finished blend not only becomes a preferable value but also a cost can be controlled to the minimum. The polycarbonate polymers and the polyester polymers can be blended advantageously in a ratio by mass of approximately from 75:25 to 25:75. It is more preferable to blend them in a ratio by mass of from about 60:40 to about 40:60. Technologies of a blend series of the polycarbonate polymers and the polyester polymers are disclosed in JP-A-6-227161.

As for the polycarbonate polymers used in the receptor layer, a net structure of a crosslinked polymer may be formed in the receptor layer by reacting a polycarbonate having an average molecular weight of about 1,000 to about 10,000, the ends of which have at least 2 hydroxyl groups, with a crosslinking agent capable of reacting with the hydroxyl groups. As described in JP-A-6-155933, there are known technologies for a crosslinking agent such as a multifunctional isocyanate, thereby to improve adhesiveness to a dye donator after transfer. Besides, as the technologies disclosed in JP-A-8-39942, there are technologies in which a receiving sheet for a heat-sensitive dye transfer process is constructed using dibutyl tin diacetate at a time of crosslinking reaction of a polycarbonate with isocyanate. Such the technologies enable to improve not only acceleration of the crosslinking reaction, but also image stability, resistance to finger print, and the like.

(Vinyl Chloride Polymers)

The vinyl chloride polymers, particularly a copolymer using vinyl chloride, used in the receptor layer are explained in more detail.

The polyvinyl chloride copolymer is preferably one having a vinyl chloride constituent content of 85 to 97% by mass and a polymerization degree of 200 to 800. A monomer forming such a copolymer together with vinyl chloride has no particular restrictions, and any monomer may be used as far as it can be copolymerized with vinyl chloride. However, it is particularly preferably vinyl acetate. Accordingly, the polyvinyl chloride copolymer used in the receptor layer is advantageously a vinyl chloride-vinyl acetate copolymer. However, the vinyl chloride-vinyl acetate copolymer is not necessarily constituted of vinyl chloride and vinyl acetate alone, and may include vinyl alcohol and maleic acid constituents to an extent to which the effects of the present invention would be obtained. Examples of other monomer constituents of such a copolymer constituted mainly of vinyl chloride and vinyl acetate include vinyl alcohol and its derivatives such as vinyl propionate; acrylic or methacrylic acids and their derivatives such as their methyl, ethyl, propyl, butyl and 2-ethylhexyl esters; maleic acid and its derivatives such as diethyl maleate, dibutyl maleate and dioctyl maleate; vinyl ether derivatives such as methyl vinyl ether, butyl vinyl ether and 2-ethylhexyl vinyl ether; acrylonitrile and methacrylonitrile; and styrene. The ratio of each of the vinyl chloride and vinyl acetate components in the copolymer may be any ratio, but it is preferable that the ratio of the vinyl chloride component is 50 mass % or more of the copolymer. In addition, it is preferable that the ratio of the above-recited constituents other than the vinyl chloride and vinyl acetate is 10 mass % or less of the copolymer.

Examples of such a vinyl chloride-vinyl acetate copolymer include SOLBIN C, SOLBIN CL, SOLBIN CH, SOLBIN CN, SOLBIN C5, SOLBIN M, SOLBIN MF, SOLBIN A, SOLBIN AL, SOLBIN TA5R, SOLBIN TAO, SOLBIN MK6, and SOLBIN TA2 (trade names, manufactured by Nissin Chemical Industry Co., Ltd.); S-LEC A, S-LEC C and S-LEC M (trade names, manufactured by Sekisui Chemical Co., Ltd.); Vinylite VAGH, Vinylite VYHH, Vinylite VMCH, Vinylite VYHD, Vinylite VYLF, Vinylite VYNS, Vinylite VMCC, Vinylite VMCA, Vinylite VAGD, Vinylite VERR and Vinylite VROH (trade names, manufactured by Union Carbide Corporation); and DENKA VINYL 1000GKT, DENKA VINYL 1000L, DENKA VINYL 1000CK, DENKA VINYL 1000A, DENKA VINYL 1000LK2, DENKA VINYL 1000AS, DENKA VINYL 1000MT2, DENKA VINYL 1000CSK, DENKA VINYL 1000CS, DENKA VINYL 1000GK, DENKA VINYL 1000GSK, DENKA VINYL 1000GS, DENKA VINYL 1000LT3, DENKA VINYL 1000D and DENKA VINYL 1000W (trade names, manufactured by Denki Kagaku Kogyo Kabushiki Kaisha).

(Latex Polymer)

In the present invention, other than the aforementioned polymers, latex polymers can also be preferably used. Hereinafter, the latex polymer will be explained.

In the heat-sensitive transfer image-receiving sheet used in the present invention, the latex polymer used in the receptor layer is a dispersion in which hydrophobic polymers comprising a monomer unit of water-insoluble vinyl chloride are dispersed as fine particles in a water-soluble dispersion medium. The dispersed state may be one in which polymer is emulsified in a dispersion medium, one in which polymer underwent emulsion polymerization, one in which polymer underwent micelle dispersion, one in which polymer molecules partially have a hydrophilic structure and thus the molecular chains themselves are dispersed in a molecular state, or the like. Latex polymers are described in “Gosei Jushi Emulsion (Synthetic Resin Emulsion)”, compiled by Taira Okuda and Hiroshi Inagaki, issued by Kobunshi Kanko Kai (1978); “Gosei Latex no Oyo (Application of Synthetic Latex)”, compiled by Takaaki Sugimura, Yasuo Kataoka, Souichi Suzuki, and Keishi Kasahara, issued by Kobunshi Kanko Kai (1993); Soichi Muroi, “Gosei Latex no Kagaku (Chemistry of Synthetic Latex)”, issued by Kobunshi Kanko Kai (1970); Yoshiaki Miyosawa (supervisor) “Suisei Coating-Zairyo no Kaihatsu to Oyo (Development and Application of Aqueous Coating Material)”, issued by CMC Publishing Co., Ltd. (2004) and JP-A-64-538, and so forth. The dispersed particles preferably have a mean particle size (diameter) of about 1 to 50,000 nm, more preferably about 5 to 1,000 nm.

The particle size distribution of the dispersed particles is not particularly limited, and the particles may have either wide particle-size distribution or monodispersed particle-size distribution.

The latex polymer for use in the present invention may be latex of the so-called core/shell type, other than ordinary latex polymer of a uniform structure. When using a core/shell type latex polymer, it is preferred in some cases that the core and the shell have different glass transition temperatures. The glass transition temperature (Tg) of the latex polymer for use in the present invention is preferably −30° C. to 100° C., more preferably 0° C. to 80° C., further more preferably 10° C. to 70° C., and especially preferably 15° C. to 60° C.

In the present invention, as a preferable embodiment of the latex polymer used in the receptor layer, use can be made of polyvinyl chlorides, a copolymer comprising vinyl chloride unit, such as a vinyl chloride-vinyl acetate copolymer and a vinyl chloride acrylate copolymer. In this case, the vinyl chloride unit in molar ratio is preferably in the range of from 50% to 95%. These polymers may be straight-chain, branched, or cross-linked polymers, the so-called homopolymers obtained by polymerizing single type of monomers, or copolymers obtained by polymerizing two or more types of monomers. In the case of the copolymers, these copolymers may be either random copolymers or block copolymers. The molecular weight of each of these polymers is preferably 5,000 to 1,000,000, and further preferably 10,000 to 500,000 in terms of number average molecular weight. Polymers having excessively small molecular weight impart insufficient dynamic strength to the layer containing the latex, and polymers having excessively large molecular weight bring about poor filming ability. Crosslinkable latex polymers are also preferably used.

The latex polymer that can be used in the present invention is commercially available, and polymers described below may be utilized. Examples thereof include G351 and G576 (trade names, manufactured by Nippon Zeon Co., Ltd.); VINYBLAN 240, 270, 277, 375, 386, 609, 550, 601, 602, 630, 660, 671, 683, 680, 680S, 681N, 685R, 277, 380, 381, 410, 430, 432, 860, 863, 865, 867, 900, 900GT, 938 and 950 (trade names, manufactured by Nissin Chemical Industry Co., Ltd.).

These latex polymers may be used singly, or two or more of these polymers may be blended, if necessary.

In the receptor layer, a ratio of the latex polymer comprising a component of vinyl chloride is preferably 50 mass % or more of the whole solid content in the layer.

In the present invention, it is preferable to prepare the receptor layer by applying an aqueous type coating solution and then drying it. The “aqueous type” so-called here means that 60% by mass or more of the solvent (dispersion medium) of the coating solution is water. As a component other than water in the coating solution, a water miscible organic solvent may be used, such as methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethylene glycol monoethyl ether, and oxyethyl phenyl ether.

The latex polymer for use in the present invention preferably has a minimum film-forming temperature (MFT) of from −30 to 90° C., more preferably from 0 to 70° C. In order to control the minimum film-forming temperature, a film-forming aid may be added. The film-forming aid is also called a temporary plasticizer, and it is an organic compound (usually an organic solvent) that reduces the minimum film-forming temperature of a latex polymer. It is described in, for example, Souichi Muroi, “Gosei Latex no Kagaku (Chemistry of Synthetic Latex)”, issued by Kobunshi Kanko Kai (1970). Preferable examples of the film-forming aid are listed below, but the compounds that can be used in the present invention are not limited to the following specific examples.

Z-1: Benzyl alcohol

Z-2: 2,2,4-Trimethylpentanediol-1,3-monoisobutyrate

Z-3: 2-Dimethylaminoethanol

Z-4: Diethylene glycol

The latex polymer used in the present invention may be used (blended) with another latex polymer. Preferable examples of the another latex polymer include polylactates, polyurethanes, polycarbonates, polyesters, polyacetals, and SBR's. Among these, polyesters and polycarbonates are preferable.

In combination with the above-described latex polymer for use in the present invention, any polymer can be used. The polymer that can be used in combination is preferably transparent or translucent, and colorless. The polymer may be a natural resin, polymer, or copolymer; a synthetic resin, polymer, or copolymer; or another film-forming medium; and specific examples include gelatins, polyvinyl alcohols, hydroxyethylcelluloses, cellulose acetates, cellulose acetate butyrates, polyvinylpyrrolidones, caseins, starches, polyacrylic acids, polymethylmethacrylic acids, polyvinyl chlorides, polymethacrylic acids, styrene-maleic anhydride copolymers, styrene-acrylonitrile copolymers, styrene-butadiene copolymers, polyvinyl acetals (e.g. polyvinyl formals, polyvinyl butyrals, etc.), polyesters, polyurethanes, phenoxy resins, polyvinylidene chlorides, polyepoxides, polycarbonates, polyvinyl acetates, polyolefins, and polyamides. In the coating liquid, a binder may be dissolved or dispersed in an aqueous solvent or in an organic solvent, or may be in the form of an emulsion.

The glass transition temperature (Tg) of the binder for use in the present invention is preferably in the range of −30° C. to 70° C., more preferably −10° C. to 50° C., still more preferably 0° C. to 40° C., in view of film-forming properties (brittleness for working) and image preservability. A blend of two or more types of polymers can be used as the binder. When a blend of two or more polymers is used, the average Tg obtained by summing up the Tg of each polymer weighted by its proportion, is preferably within the foregoing range. Also, when phase separation occurs or when a core-shell structure is adopted, the weighted average Tg is preferably within the foregoing range.

The glass transition temperature (Tg) is calculated according to the following equation:
1/Tg=Σ(Xi/Tgi)
wherein, assuming that the polymer is a copolymer composed of n monomers from i=1 to i=n, Xi is a weight fraction of the i-th monomer (ΣXi=1) and Tgi is glass transition temperature (measured in absolute temperature) of a homopolymer formed from the i-th monomer. The symbol Σ means the sum of i=1 to i=n. The value of the glass transition temperature of a homopolymer formed from each monomer (Tgi) can be adopted from J. Brandrup and E. H. Immergut, “Polymer Handbook, 3rd. Edition”, Wiley-Interscience (1989).

The polymer used for the binder for use in the present invention can be easily obtained by a solution polymerization method, a suspension polymerization method, an emulsion polymerization method, a dispersion polymerization method, an anionic polymerization method, a cationic polymerization method, or the like. Above all, an emulsion polymerization method in which the polymer is obtained as a latex is the most preferable. Also, a method is preferable in which the polymer is prepared in a solution, and the solution is neutralized or an emulsifier is added to the solution, to which water is then added, to prepare an aqueous dispersion by forced stirring. For example, an emulsion polymerization method comprises conducting polymerization under stirring at about 30° C. to about 100° C. (preferably 60° C. to 90° C.) for 3 to 24 hours by using water or a mixed solvent of water and a water-miscible organic solvent (such as methanol, ethanol, or acetone) as a dispersion medium, a monomer mixture in an amount of 5 mass % to 150 mass % based on the amount of the dispersion medium, an emulsifier and a polymerization initiator. Various conditions such as the dispersion medium, the monomer concentration, the amount of initiator, the amount of emulsifier, the amount of dispersant, the reaction temperature, and the method for adding monomers are suitably determined considering the type of the monomers to be used. Furthermore, it is preferable to use a dispersant when necessary.

In the coating solution of the latex polymer to be used in the present invention, an aqueous solvent can be used as the solvent, and a water-miscible organic solvent may optionally be used in combination. Examples of the water-miscible organic solvent include alcohols (for example, methyl alcohol, ethyl alcohol, and propyl alcohol), cellosolves (for example, methyl cellosolve, ethyl cellosolve, and butyl cellosolve), ethyl acetate, and dimethylformamide. The amount of the organic solvent to be added is preferably 50 mass % or less of the entire solvent, more preferably 30 mass % or less of the entire solvent.

Furthermore, in the latex polymer to be used in the present invention, the polymer concentration is, based on the amount of the latex liquid, preferably 10 mass % to 70 mass %, more preferably 20 mass % to 60 mass %, and especially preferably 30 mass % to 55 mass %.

The latex polymer in the image-receiving sheet that can be used in the present invention includes a state of a gel or dried film formed by removing a part of solvents by drying after coating.

[Emulsified Dispersion]

In the present invention, incorporation of an emulsified dispersion (emulsion) in the receptor layer is preferable, especially when the latex polymer is used.

The term “emulsification” as used herein follows the commonly used definition. According to “Kagaku Daijiten (ENCYCLOPEDIA CHIMICA)”, Kyoritsu Shuppan Co., Ltd., for example, “emulsification” is defined as “a phenomenon in which, in one liquid, another liquid which does not dissolve in the first liquid are dispersed as fine globules, to form an emulsion”. In addition, the term “emulsified dispersion” refers to “a dispersion in which fine globules of one liquid are dispersed in another liquid which does not dissolve the globules”. The “emulsified dispersion” preferred in the present invention is “a dispersion of oil globules in water”. The content of an emulsified dispersion in the image-receiving sheet for use in the present invention is preferably from 0.03 g/m² to 25.0 g/m², more preferably from 1.0 g/m² to 20.0 g/m².

In the present invention, it is preferable that a high-boiling solvent be included as an oil-soluble substance in the emulsified dispersion. Examples of the high-boiling solvent preferably used include phthalic acid esters (such as dibutyl phthalate, dioctyl phthalate, and di-2-ethyl-hexyl phthalate), phosphoric or phosphonic acid esters (such as triphenyl phosphate, tricresyl phosphate, tri-2-ethylhexyl phosphate), fatty acid esters (such as di-2-ethylhexyl succinate and tributyl citrate), benzoic acid esters (such as 2-ethylhexyl benzoate and dodecylbenzoate), amides (such as N,N-diethyldodecanamide and N,N-dimethyloleinamide), alcohol and phenol compounds (such as isostearyl alcohol and 2,4-di-tert-amylphenol), anilines (such as N,N-dibutyl-2-butoxy-5-tert-octylaniline), chlorinated paraffins, hydrocarbons (such as dodecylbenzene and diisopropylnaphthalene), and carboxylic acids (such as 2-(2,4-di-tert-amylphenoxy)butyric acid). Of these high-boiling solvents, phosphoric or phosphonic acid esters (such as triphenyl phosphate, tricresyl phosphate, and tri-2-ethylhexyl phosphate) are preferred over the others. In addition to such a high-boiling solvent, an organic solvent having a boiling point of 30° C. to 160° C. (such as ethyl acetate, butyl acetate, methyl ethyl ketone, cyclohexanone, methyl cellosolve acetate, or dimethylformamide) may be used as an auxiliary solvent. The content of high-boiling solvent in the emulsified dispersion is preferably from 3.0 to 25% by mass, and more preferably from 5.0 to 20% by mass.

It is preferable that the emulsified dispersion further contain an agent for imparting fastness to images and an ultraviolet absorbent. The compounds preferably used as such agents are any of the compounds represented by formulae (B), (Ph), (E-1) to (E-3), (TS-1) to (TS-VII), (TS-VIIIA), (UA) to (UE) disclosed in JP-A-2004-361936. Further, homopolymers or copolymers insoluble in water and soluble in organic solvents (preferably the compounds disclosed in JP-A-2004-361936, paragraph Nos. 0208 to 0234) may be included therein.

[Plasticizer]

For the purpose of enhancing the sensitivity of the receptor layer, a plasticizer (high boiling organic solvent) may also be added. Examples of such a plasticizer include compounds generally used as plasticizers for vinyl chloride resins, and more specifically monomeric plasticizers such as phthalates, phosphates, adipates and sebacates, and polyester-type plasticizers produced by polymerization of adipic acid or sebacic acid and propylene glycol. Although the former plasticizers are generally low in molecular weight, olefin-type special copolymer resins, which are used as polymeric plasticizer usable for vinyl chloride, may also be used. Examples of resins usable for such a purpose include products marketed under the names of ELVALOY 741, ELVALOY 742, ELVALOY HP443, ELVALOY HP553, ELVALOY EP4015, ELVALOY EP4043, ELVALOY EP4051 (trade names, manufactured by DuPont-Mitsui Polychemicals Co., Ltd.). Such plasticizers can be added to the resins in a proportion of about 100% by mass based on the resin in the receptor layer, but it is appropriate to use them in a proportion of 30% by mass or below in view of bleeding of prints. When the latex polymer is used, it is preferable that those plasticizers be used in a state of the emulsified dispersion as mentioned above.

The receptor layer for use in the present invention can be cast by extrusion coating of a melt of the polymer resin as recited above without resorting to solvent coating. The techniques of this extrusion coating are described in Encyclopedia of Polymer Science and Engineering, vol. 3, p. 563, John Wiley, New York (1985), and ibid., vol. 6, p. 608 (1986). In addition, the technique for heat-sensitive dye transfer materials is disclosed in JP-A-7-179075, and it is also preferably applicable to the present invention. As the polymer resin, copolymer obtained by condensing cyclohexane dicarboxylate and a 50:50 by mole % mixture of ethylene glycol and bisphenol-A-diethanol (COPOL; registered trade mark) is especially preferred.

[Releasing Agent]

If the image-receiving surface of the heat-sensitive transfer image-receiving sheet lacks a sufficient releasing property, problems of so-called abnormal transfer arises. Examples of the abnormal transfer include a problem that a heat-sensitive transfer sheet and a heat-sensitive transfer image-receiving sheet mutually weld by heat from a thermal head for the image-forming, and thereby a big noise due to peeling arises at the time of peeling; a problem that a dye layer is entirely transferred; and a problem that the receptor layer is peeled from the support. As a method of solving such problems of releasing property, there are known a method of introducing various kinds of releasing agents (lubricant) in the receptor layer and a method of disposing a releasing layer additionally on the receptor layer. In the present invention, it is preferable to use a releasing agent in the receptor layer in order to keep more securely the releasing property between the heat-sensitive transfer sheet and the image-receiving sheet at the time of printing images.

As the releasing agent, solid waxes such as polyethylene wax, amide wax and Teflon (registered trade name) powder; silicone oil, phosphate-series compounds, fluorine-based surfactants, silicone-based surfactants and others including releasing agents known in the technical fields concerned may be used. Among these, fluorine-series compounds typified by fluorine-based surfactants, silicone-based surfactants and silicone-series compounds such as silicone oil and/or its hardened products are preferably used.

As the silicone oil, straight silicone oil and modified silicone oil or their hardened products may be used.

Examples of the straight silicone oil include dimethylsilicone oil, methylphenylsilicone oil and methyl hydrogen silicone oil. Examples of the dimethylsilicone oil include KF96-10, KF96-100, KF96-1000, KF96H-10000, KF96H-12500 and KF96H-100000 (all of these names are trade names, manufactured by Shin-Etsu Chemical Co., Ltd.). Examples of the methylphenylsilicone oil include KF50-100, KF54 and KF56 (all of these names are trade names, manufactured by Shin-Etsu Chemical Co., Ltd.).

The modified silicone oil may be classified into reactive silicone oils and non-reactive silicone oils. Examples of the reactive silicone oils include amino-modified, epoxy-modified, carboxyl-modified, hydroxy-modified, methacryl-modified, mercapto-modified, phenol-modified or one-terminal reactive/hetero-functional group-modified silicone oils. Examples of the amino-modified silicone oil include KF-393, KF-857, KF-858, X-22-3680, X-22-3801C, KF-8010, X-22-161A and KF-8012 (all of these names are trade names, manufactured by Shin-Etsu Chemical Co., Ltd.). Examples of the epoxy-modified silicone oil include KF-100T, KF-101, KF-60-164, KF-103, X-22-343 and X-22-3000T (all of these names are trade names, manufactured by Shin-Etsu Chemical Co., Ltd.). Examples of the carboxyl-modified silicone oil include X-22-162C (trade name, manufactured by Shin-Etsu Chemical Co., Ltd.). Examples of the hydroxy-modified silicone oil include X-22-160AS, KF-6001, KF-6002, KF-6003, X-22-170DX, X-22-176DX, X-22-176D and X-22-176DF (all of these names are trade names, manufactured by Shin-Etsu Chemical Co., Ltd.). Examples of the methacryl-modified silicone oil include X-22-164A, X-22-164C, X-24-8201, X-22-174D and X-22-2426 (all of these names are trade names, manufactured by Shin-Etsu Chemical Co., Ltd.).

Reactive silicone oils may be hardened upon use, and may be classified into a reaction-curable type, photocurable type, catalyst-curable type, and the like. Among these types, silicone oil that is the reaction-curable type is particularly preferable. As the reaction-curable type silicone oil, products obtained by reacting an amino-modified silicone oil with an epoxy-modified silicone oil and then by curing are preferable. Also, examples of the catalyst-curable type or photocurable type silicone oil include KS-705F-PS, KS-705F-PS-1 and KS-770-PL-3 (all of these names are trade names, catalyst-curable silicone oils, manufactured by Shin-Etsu Chemical Co., Ltd.) and KS-720 and KS-774-PL-3 (all of these names are trade names, photocurable silicone oils, manufactured by Shin-Etsu Chemical Co., Ltd.). The addition amount of the curable type silicone oil is preferably 0.5 to 30% by mass based on the resin constituting the receptor layer. The releasing agent is used preferably in an amount of 2 to 4% by mass and further preferably 2 to 3% by mass based on 100 parts by mass of the polyester resin. If the amount is too small, the releasability cannot be secured without fail, whereas if the amount is excessive, a protective layer is not transferred to the image-receiving sheet resultantly.

Examples of the non-reactive silicone oil include polyether-modified, methylstyryl-modified, alkyl-modified, higher fatty acid ester-modified, hydrophilic special-modified, higher alkoxy-modified or fluorine-modified silicone oils. Examples of the polyether-modified silicone oil include KF-6012 (trade name, manufactured by Shin-Etsu Chemical Co., Ltd.) and examples of the methylstyryl-modified silicone oil include 24-510 (trade name, manufactured by Shin-Etsu Chemical Co., Ltd.). Modified silicones represented by any one of the following Formulae 1 to 3 may also be used.

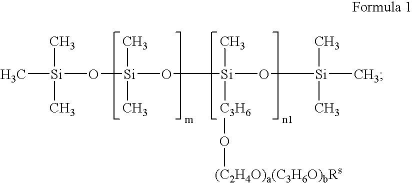

In the Formula 1, R^{S} represents a hydrogen atom or a straight-chain or branched alkyl group which may be substituted with an aryl or cycloalkyl group. m and n1 respectively denote an integer of 2,000 or less, and a and b respectively denote an integer of 30 or less.

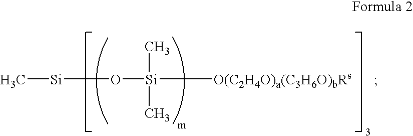

In the Formula 2, R^{S} represents a hydrogen atom or a straight-chain or branched alkyl group which may be substituted with an aryl or cycloalkyl group. m denotes an integer of 2,000 or less, and a and b respectively denote an integer of 30 or less.

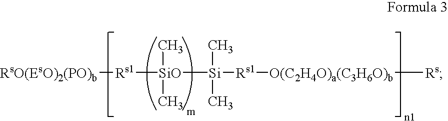

In the Formula 3, R^{S} represents a hydrogen atom or a straight-chain or branched alkyl group which may be substituted with an aryl or cycloalkyl group. m and n1 respectively denote an integer of 2,000 or less, and a and b respectively denote an integer of 30 or less. R^{S1} represents a single bond or a divalent linking group, E^{S} represents an ethylene group which may be further substituted, and P represents a propylene group which may be further substituted.

Silicone oils such as those mentioned above are described in “SILICONE HANDBOOK” (The Nikkan Kogyo Shimbun, Ltd.) and the technologies described in each publication of JP-A-8-108636 and JP-A-2002-264543 may be preferably used as the technologies to cure the curable type silicone oils.

In some cases, a dye binder is transferred to the receptor layer in a highlight portion of monochrome printing, to cause an irregular transfer. In addition, it is known that an addition polymerization-type silicone generally progresses a hardening reaction in the presence of a catalyst, and that almost all of complexes of transition metal of VIII group, such as Fe group and Pt group, are effective as the hardening catalyst. Among these, a platinum compound has the highest efficiency in general, and a platinum catalyst, which is generally a platinum complex soluble in the silicone oil, is preferably used. Addition amount necessary for the reaction is generally sufficiently about 1 to 100 ppm.

This platinum catalyst has a strong interaction with an organic compound containing an element such as N, P and S, an ionic compound of heavy metal such as Sn, Pb, Hg, Bi and As, or an organic compound containing a polyvalent bond such as an acetylene group. Therefore, if the above-described compounds (catalyst poison) are used together with the platinum catalyst, the ability of the catalyst to hydrosilylate is lost. Resultantly, the platinum catalyst cannot work as the hardening catalyst. Therefore, a problem arises that the platinum catalyst causes silicone to lack in hardening ability, when used with such a catalyst poison (See “Silicone Handbook” published by Nikkan Kogyo Shunbun shya). As a result, such an addition polymerization-type silicone causing such a hardening failure cannot show a releasability needed, when it is used in the receptor layer. As a hardener reacting with an active hydrogen, it is considered to use an isocyanate compound. However, this isocyanate compound and an organic tin compound working as a catalyst to the isocyanate compound act as a catalyst poison to the platinum catalyst. Therefore, the addition polymerization-type silicone has been never used together with the isocyanate compound in the past. Resultantly, the addition polymerization-type silicone has been never used together with a modified silicone having an active hydrogen that shows a releasability needed when hardened with the isocyanate compound.

However, the hardening failure of the addition polymerization-type silicone can be prevented by 1) setting an equivalent amount of the reactive group of the hardener capable of reacting with the active hydrogen, to the reactive group of both the thermoplastic resin and the modified silicone having an active hydrogen, in the range of from 1:1 to 10:1, and 2) setting an addition amount of the platinum catalyst based on the addition polymerization-type silicone in the range of 100 to 10,000 ppm in terms of platinum atom of the platinum catalyst. If the equivalent amount of the reactive group of the hardener capable of reacting with the active hydrogen according to the 1) described above is too small, an amount of silicone having an active hydrogen hardened with an active hydrogen of the thermoplastic resin is so small that an excellent releasability needed cannot be achieved. On the other hand, if the equivalent ratio is too large, a time which is allowed to use an ink in a coating solution for the receptor layer is so short that such the equivalent ratio cannot be substantially applied to the present invention. Beside, if the addition amount of the platinum catalyst according to the 2) described above is too small, activity is lost by the catalyst poison, whereas if the addition amount is too large, a time which is allowed to use an ink in a coating solution for the receptor layer is so short that such the addition amount cannot be substantially applied to the present invention.

In the present invention, the amount of the receptor layer to be applied is preferably 0.5 to 10 g/m² (solid basis, hereinafter, the amount to be applied in the present specification is a value on solid basis unless otherwise noted).

<Releasing Layer>

In the case where the hardened modified silicone oil is not added to the receptor layer, the silicone oil may be added to a releasing layer provided on the receptor layer. In this case, the receptor layer may be provided using at least one of the above-described thermoplastic resins. Besides, a receptor layer to which silicone is added may be used. The releasing layer contains a hardened modified silicone oil. A kind of the silicone to be used and a method of using the silicone are the same as for use in the receptor layer. Also, in the case where a catalyst or a retardant is used, the above described descriptions related to addition of these additives to the receptor layer may be applied. The releasing layer may be formed using only a silicone, or alternatively a mixture of a silicone and a binder resin having a good compatibility therewith. A thickness of the releasing layer is generally in the range of about 0.001 to about g/m².

Examples of the fluorine surfactants include Fluorad FC-430 and FC-431 (trade names manufactured by 3M).

<Undercoat Layer>

An undercoat layer is preferably formed between the receptor layer and the support. As the undercoat layer, for example, at least one of a white background controlling layer, a charge controlling layer, an adhesive layer, and a primer layer is formed. These layers may be formed in the same manner as those described in, for example, each specification of Japanese Patent Nos. 3585599 and 2925244.

<Heat Insulation Layer>

A heat insulation layer serves to protect the support from heat when a thermal head or the like is used to carry out a transfer operation under heating. Also, because the heat insulation layer has high cushion characteristics, a heat-sensitive transfer image-receiving sheet having high printing sensitivity can be obtained even in the case of using paper as a substrate (support). The heat insulation layer may be a single layer, or multi-layers. The heat insulation layer is generally arranged at a nearer location to the support than the receptor layer.

(Hollow Polymer)

In the image-receiving sheet for use in the present invention, the heat insulation layer contains hollow polymer particles and a hydrophilic polymer.

The hollow polymer particles in the present invention are polymer particles having independent pores inside of the particles. Examples of the hollow polymer particles include (1) non-foaming type hollow particles obtained in the following manner: a dispersion medium such as water is contained inside of a capsule wall formed of a polystyrene, acryl resin, or styrene/acryl resin and, after a coating solution is applied and dried, the dispersion medium in the particles is vaporized out of the particles, with the result that the inside of each particle forms a hollow; (2) foaming type microballoons obtained in the following manner: a low-boiling point liquid such as butane and pentane is encapsulated in a resin constituted of any one of polyvinylidene chloride, polyacrylonitrile, polyacrylic acid and polyacrylate, and their mixture or polymer, and after the resin coating material is applied, it is heated to expand the low-boiling point liquid inside of the particles whereby the inside of each particle is made to be hollow; and (3) microballoons obtained by foaming the above (2) under heating in advance, to make hollow polymer particles.

The particle size of the hollow polymer particles is preferably 0.1 to 20 μm, more preferably 0.1 to 2 μm, further preferably 0.1 to 1 μm, particularly preferably 0.2 to 0.8 μm. It is because an excessively small size may lead to decrease of the void ratio (hollow ratio) of the particles, prohibiting desirable heat-insulating efficiency, while an excessively large size in relation to the thickness of the heat insulation layer may result in problems for preparation of smooth surface and may cause coating troubles due to the bulky particles.

These hollow polymer particles preferably have a hollow ratio of about 20 to 70%, more preferably 20 to 50%. With too small hollow ratio, it cannot give a sufficient heat-insulating efficiency, while with an excessively large hollow ratio for the hollow particles that have the above-described preferable particle diameter, imperfect hollow particles increase prohibiting sufficient film strength.

The “hollow ratio” of the hollow polymer particles as referred to here is a value P1 calculated according to the Formula (a), based on the transmission image photographed by a transmission micrograph of hollow particles.

$$P 1 = \{ 1 / n \times {\sum }_{i = 1}^{n} {( Rai / Rbi )}^{3} \} \times 100 ( \% ) \qquad Formula ( a )$$

In formula (a), Rai represents the circle-equivalent diameter of the inner periphery (which shows the periphery of a hollow portion), among two peripheries constituting an image of a specific particle i; Rbi represents the circle-equivalent diameter of the outer periphery (which shows the outer shape of a particle in interest), among the two peripheries constituting the image of the specific particle i; and n is the number of measured particles, and n is generally 300 or more. Herein, the term “circle-equivalent diameter” means the diameter of a circle having an area equivalent to the (projected) area that the hollow portion's periphery or the particle's outer shape has.

The glass transition temperature (Tg) of the hollow polymer particles is preferably 70° C. or more and more preferably 100° C. or more. These hollow polymer particles may be used in combinations of two or more.

Such hollow polymer particles are commercially available. Specific examples of the above (I) include Rohpake 1055 manufactured by Rohm and Haas Co.; Boncoat PP-1000 manufactured by Dainippon Ink and Chemicals, Incorporated; SX866(B) manufactured by JSR Corporation; and Nippol MH5055 manufactured by Nippon Zeon (all of these product names are trade names). Specific examples of the above (2) include F-30 and F-50 manufactured by Matsumoto Yushi-Seiyaku Co., Ltd. (all of these product names are trade names). Specific examples of the above (3) include F-30E manufactured by Matsumoto Yushi-Seiyaku Co., Ltd, and Expancel 461DE, 551DE and 551DE20 manufactured by Nippon Ferrite (all of these product names are trade names). Among these, the hollow polymer particles of the above (I) may be preferably used.

A water-dispersible resin or water-soluble type resin is preferably contained, as a binder, in the heat insulation layer containing the hollow polymer particles. As the binder resin that can be used in the present invention, known resins such as an acryl resin, styrene/acryl copolymer, polystyrene resin, polyvinyl alcohol resin, vinyl acetate resin, ethylene/vinyl acetate copolymer, vinyl chloride/vinyl acetate copolymer, styrene/butadiene copolymer, polyvinylidene chloride resin, cellulose derivative, casein, starch, and gelatin may be used. In the present invention, use of a gelatin is particularly preferable. Also, these resins may be used either singly or as mixtures.

The solid content of the hollow polymer particles in the heat insulation layer preferably falls in a range from 5 to 2,000 parts by mass, more preferably 5 to 1000 parts by mass, and further preferably 5 to 400 parts by mass, assuming that the solid content of the binder resin be 100 parts by mass. The solid content of the hollow polymer particles is preferably 50% by mass or more, more preferably 60% by mass or more, and further preferably 65% by mass or more, based on the total solid content of the hollow polymer particles and the binder resin. Also, the ratio by mass of the solid content of the hollow polymer particles in the coating solution is preferably 1 to 70% by mass and more preferably 10 to 40% by mass. If the ratio of the hollow polymer particles is excessively low, sufficient heat insulation cannot be obtained, whereas if the ratio of the hollow polymer particles is excessively large, the adhesion between the hollow polymer particles is reduced, and thereby sufficient film strength cannot be obtained, causing deterioration in abrasion resistance.

The heat insulation layer of the heat-sensitive transfer image-receiving sheet for use in the present invention is free of any resins that are not resistant to an organic solvent, except for the hollow polymer particles. Incorporation of the resin that is not resistant to an organic solvent (resin having a dye-dyeing affinity) in the heat insulation layer is not preferable in view of increase in loss of image definition after image transfer. It is assumed that the color-edge definition loss increases by the reason that owing to the presence of both the resin having a dye-dyeing affinity and the hollow polymer particles in the heat insulation layer, a transferred dye that has dyed the receptor layer migrates through the heat insulation layer adjacent thereto with the lapse of time.

Herein, the term “the resin that is not resistant to an organic solvent” means a resin having a solubility in an organic solvent (e.g., methyl ethyl ketone, ethyl acetate, benzene, toluene, xylene) of 1 mass % or more, preferably 0.5 mass % or more. For example, the above-mentioned latex polymer is included in the category of “the resin that is not resistant to an organic solvent”.

A thickness of the heat insulation layer containing the hollow polymer particles is preferably from 5 to 50 μm, more preferably from 5 to 40 μm.

A void ratio (porosity ratio) of the heat insulation layer, which is calculated from the thickness of the heat insulation layer containing hollow polymer particles and the solid-matter coating amount of the heat insulation layer including the hollow polymer particles, is preferably 10 to 70% and more preferably 15 to 60%. When the void ratio is too low, sufficient heat insulation property cannot be obtained. When the void ratio is too large, the binding force among hollow polymer particles deteriorates, and thus sufficient film strength cannot be obtained, and abrasion resistance deteriorates.

The void ratio of the heat insulation layer as referred to here is a value V calculated according to the Formula (b) below.
V=1−L/L×Σgi−di Formula (b)

In Formula (b), L represents the thickness of the heat-insulation layer; gi represents the coating amount of a particular material i in terms of solid matter for the heat-insulation layer; and di represents the specific density of the particular material i. When di represents the specific density of the hollow polymer particles, di is the specific density of the wall material of hollow polymer particles.

(Hydrophilic Polymer)

The heat insulation layer preferably contains a hydrophilic polymer (hereinafter also referred to as water-soluble polymer or a water-soluble high molecular compound). The water-soluble polymer which can be used in the present invention is natural polymers (polysaccharide type, microorganism type, and animal type), semi-synthetic polymers (cellulose-based, starch-based, and alginic acid-based), and synthetic polymer type (vinyl type and others); and synthetic polymers including polyvinyl alcohols, and natural or semi-synthetic polymers using celluloses derived from plant as starting materials, which will be explained later, correspond to the water-soluble polymer usable in the present invention.

The latex polymers recited above are not included in the water-soluble polymers which can be used in the present invention. In the present invention, the water-soluble polymer is also referred to as a binder, for differentiation from the latex polymer described above.

Herein, “water-soluble polymer” means a polymer which dissolves, in 100 g water at 20° C., in an amount of preferably 0.05 g or more, more preferably 0.1 g or more, further preferably 0.5 g or more, and particularly preferably 1 g or more.

Among the water-soluble polymers which can be used in the present invention, the natural polymers and the semi-synthetic polymers will be explained in detail. Specific examples include the following polymers: plant type polysaccharides such as gum arabics, K-carrageenans, t-carrageenans, k-carrageenans, guar gums (e.g. Supercol, manufactured by Squalon), locust bean gums, pectins, tragacanths, corn starches (e.g. Purity-21, manufactured by National Starch & Chemical Co.), and phosphorylated starches (e.g. National 78-1898, manufactured by National Starch & Chemical Co.); microbial type polysaccharides such as xanthan gums (e.g. Keltrol T, manufactured by Kelco) and dextrins (e.g. Nadex 360, manufactured by National Starch & Chemical Co.); animal type natural polymers such as gelatins (e.g. Crodyne B419, manufactured by Croda), caseins, sodium chondroitin sulfates (e.g. Cromoist CS, manufactured by Croda); cellulose-based polymers such as ethylcelluloses (e.g. Cellofas WLD, manufactured by I.C.I.), carboxymethylcelluloses (e.g. CMC, manufactured by Daicel), hydroxyethylcelluloses (e.g. HEC, manufactured by Daicel), hydroxypropylcelluloses (e.g. Klucel, manufactured by Aqualon), methylcelluloses (e.g. Viscontran, manufactured by Henkel), nitrocelluloses (e.g. Isopropyl Wet, manufactured by Hercules), and cationated celluloses (e.g. Crodacel QM, manufactured by Croda); starches such as phosphorylated starches (e.g. National 78-1898, manufactured by National Starch & Chemical Co.); alginic acid-based compounds such as sodium alginates (e.g. Keltone, manufactured by Kelco) and propylene glycol alginates; and other polymers such as cationated guar gums (e.g. Hi-care 1000, manufactured by Alcolac) and sodium hyaluronates (e.g. Hyalure, manufactured by Lifecare Biomedial) (all of the names are trade names).

Gelatin is one of preferable embodiments in the present invention. Gelatin having a molecular weight of from 10,000 to 1,000,000 may be used in the present invention. Gelatin that can be used in the present invention may contain an anion such as Cl⁻ and SO₄²⁻, or alternatively a cation such as Fe²⁺, Ca²⁺, Mg²⁺, Sn²⁺, and Zn²⁺. Gelatin is preferably added as an aqueous solution.

Among the water-soluble polymers which can be used in the present invention, the synthetic polymers will be explained in detail. Examples of the acryl type include sodium polyacrylates, polyacrylic acid copolymers, polyacrylamides, polyacrylamide copolymers, and polydiethylaminoethyl(meth)acrylate quaternary salts or their copolymers. Examples of the vinyl type include polyvinylpyrrolidones, polyvinylpyrrolidone copolymers, and polyvinyl alcohols. Examples of the others include polyethylene glycols, polypropylene glycols, polyisopropylacrylamides, polymethyl vinyl ethers, polyethyleneimines, polystyrenesulfonic acids or their copolymers, naphthalenesulfonic acid condensate salts, polyvinylsulfonic acids or their copolymers, polyacrylic acids or their copolymers, acrylic acid or its copolymers, maleic acid copolymers, maleic acid monoester copolymers, acryloylmethylpropanesulfonic acid or its copolymers, polydimethyldiallylammonium chlorides or their copolymers, polyamidines or their copolymers, polyimidazolines, dicyanamide type condensates, epichlorohydrin/dimethylamine condensates, Hofmann decomposed products of polyacrylamides, and water-soluble polyesters (Plascoat Z-221, Z-446, Z-561, Z-450, Z-565, Z-850, Z-3308, RZ-105, RZ-570, Z-730 and RZ-142 (all of these names are trade names), manufactured by Goo Chemical Co., Ltd.).

In addition, highly-water-absorptive polymers, namely, homopolymers of vinyl monomers having —COOM or —SO₃M (M represents a hydrogen atom or an alkali metal atom) or copolymers of these vinyl monomers among them or with other vinyl monomers (for example, sodium methacrylate, ammonium methacrylate, Sumikagel L-SH (trade name) manufactured by Sumitomo Chemical Co., Ltd.) as described in, for example, U.S. Pat. No. 4,960,681 and JP-A-62-245260, may also be used.

Among the water-soluble synthetic polymers that can be used in the present invention, polyvinyl alcohols are preferable. The polyvinyl alcohols are explained in detail below.

Examples of completely saponificated polyvinyl alcohol include PVA-105 [polyvinyl alcohol (PVA) content: 94.0 mass % or more; degree of saponification: 98.5±0.5 mol %; content of sodium acetate: 1.5 mass % or less; volatile constituent: 5.0 mass % or less; viscosity (4 mass %; 20° C.): 5.6±0.4 CPS]; PVA-110 [PVA content: 94.0 mass %; degree of saponification: 98.5±0.5 mol %; content of sodium acetate: 1.5 mass %; volatile constituent: 5.0 mass %; viscosity (4 mass %; 20° C.): 11.0±0.8 CPS]; PVA-117 [PVA content: 94.0 mass %; degree of saponification: 98.5±0.5 mol %; content of sodium acetate: 1.0 mass %; volatile constituent: 5.0 mass %; viscosity (4 mass %; 20° C.): 28.0±3.0 CPS]; PVA-117H [PVA content: 93.5 mass %; degree of saponification: 99.6±0.3 mol %; content of sodium acetate: 1.85 mass %; volatile constituent: 5.0 mass %; viscosity (4 mass %; 20° C.): 29.0±3.0 CPS]; PVA-120 [PVA content: 94.0 mass %; degree of saponification: 98.5±0.5 mol %; content of sodium acetate: 1.0 mass %; volatile constituent: 5.0 mass %; viscosity (4 mass %; 20° C.): 39.5±4.5 CPS]; PVA-124 [PVA content: 94.0 mass %; degree of saponification: 98.5±0.5 mol %; content of sodium acetate: 1.0 mass %; volatile constituent: 5.0 mass %; viscosity (4 mass %; 20° C.): 60.0±6.0 CPS]; PVA-124H [PVA content: 93.5 mass %; degree of saponification: 99.6±0.3 mol %; content of sodium acetate: 1.85 mass %; volatile constituent: 5.0 mass %; viscosity (4 mass %; 20° C.): 61.0±6.0 CPS]; PVA-CS [PVA content: 94.0 mass %; degree of saponification: 97.5±0.5 mol %; content of sodium acetate: 1.0 mass %; volatile constituent: 5.0 mass %; viscosity (4 mass %; 20° C.): 27.5±3.0 CPS]; PVA-CST [PVA content: 94.0 mass %; degree of saponification: 96.0±0.5 mol %; content of sodium acetate: 1.0 mass %; volatile constituent: 5.0 mass %; viscosity (4 mass %; 20° C.): 27.0±3.0 CPS]; and PVA-HC [PVA content: 90.0 mass %; degree of saponification: 99.85 mol % or more; content of sodium acetate: 2.5 mass %; volatile constituent: 8.5 mass %; viscosity (4 mass %; 20° C.): 25.0±3.5 CPS] (all trade names, manufactured by Kuraray Co., Ltd.), and the like.

Examples of partially saponificated polyvinyl alcohol include PVA-203 [PVA content: 94.0 mass %; degree of saponification: 88.0±1.5 mol %; content of sodium acetate: 1.0 mass %; volatile constituent: 5.0 mass %; viscosity (4 mass %; 20° C.): 3.4±0.2 CPS]; PVA-204 [PVA content: 94.0 mass %; degree of saponification: 88.0±1.5 mol %; content of sodium acetate: 1.0 mass %; volatile constituent: 5.0 mass %; viscosity (4 mass %; 20° C.): 3.9±0.3 CPS]; PVA-205 [PVA content: 94.0 mass %; degree of saponification: 88.0±1.5 mol %; content of sodium acetate: 1.0 mass %; volatile constituent: 5.0 mass %; viscosity (4 mass %; 20° C.): 5.0±0.4 CPS]; PVA-210 [PVA content: 94.0 mass %; degree of saponification: 88.0±1.0 mol %; content of sodium acetate: 1.0 mass %; volatile constituent: 5.0 mass %; viscosity (4 mass %; 20° C.): 9.0±1.0 CPS]; PVA-217 [PVA content: 94.0 mass %; degree of saponification: 88.0±1.0 mol %; content of sodium acetate: 1.0 mass %; volatile constituent: 5.0 mass %; viscosity (4 mass %; 20° C.): 22.5±2.0 CPS]; PVA-220 [PVA content: 94.0 mass %; degree of saponification: 88.0±1.0 mol %; content of sodium acetate: 1.0 mass %; volatile constituent: 5.0 mass %; viscosity (4 mass %; 20° C.): 30.0±3.0 CPS]; PVA-224 [PVA content: 94.0 mass %; degree of saponification: 88.0±1.5 mol %; content of sodium acetate: 1.0 mass %; volatile constituent: 5.0 mass %; viscosity (4 mass %; 20° C.): 44.0±4.0 CPS]; PVA-228 [PVA content: 94.0 mass %; degree of saponification: 88.0±1.5 mol %; content of sodium acetate: 1.0 mass %; volatile constituent: 5.0 mass %; viscosity (4 mass %; 20° C.): 65.0±5.0 CPS]; PVA-235 [PVA content: 94.0 mass %; degree of saponification: 88.0±1.5 mol %; content of sodium acetate: 1.0 mass %; volatile constituent: 5.0 mass %; viscosity (4 mass %; 20° C.): 95.0±15.0 CPS]; PVA-217EE [PVA content: 94.0 mass %; degree of saponification: 88.0±1.0 mol %; content of sodium acetate: 1.0 mass %; volatile constituent: 5.0 mass %; viscosity (4 mass %; 20° C.): 23.0±3.0 CPS]; PVA-217E [PVA content: 94.0 mass %; degree of saponification: 88.0±1.0 mol %; content of sodium acetate: 1.0 mass %; volatile constituent: 5.0 mass %; viscosity (4 mass %; 20° C.): 23.0±3.0 CPS]; PVA-220E [PVA content: 94.0 mass %; degree of saponification: 88.0±1.0 mol %; content of sodium acetate: 1.0 mass %; volatile constituent: 5.0 mass %; viscosity (4 mass %; 20° C.): 31.0±4.0 CPS]; PVA-224E [PVA content: 94.0 mass %; degree of saponification: 88.0±1.0 mol %; content of sodium acetate: 1.0 mass %; volatile constituent: 5.0 mass %; viscosity (4 mass %; 20° C.): 45.0±5.0 CPS]; PVA-403 [PVA content: 94.0 mass %; degree of saponification: 80.0±1.5 mol %; content of sodium acetate: 1.0 mass %; volatile constituent: 5.0 mass %; viscosity (4 mass %; 20° C.): 3.1±0.3 CPS]; PVA-405 [PVA content: 94.0 mass %; degree of saponification: 81.5-1.5 mol %; content of sodium acetate: 1.0 mass %; volatile constituent: 5.0 mass %; viscosity (4 mass %; 20° C.): 4.8±0.4 CPS]; PVA-420 [PVA content: 94.0 mass %; degree of saponification: 79.5±1.5 mol %; content of sodium acetate: 1.0 mass %; volatile constituent: 5.0 mass %]; PVA-613 [PVA content: 94.0 mass %; degree of saponification: 93.5±1.0 mol %; content of sodium acetate: 1.0 mass %; volatile constituent: 5.0 mass %; viscosity (4 mass %; 20° C.): 16.5±2.0 CPS]; L-8 [PVA content: 96.0 mass %; degree of saponification: 71.0±1.5 mol %; content of sodium acetate: 1.0 mass % (ash); volatile constituent: 3.0 mass %; viscosity (4 mass %; 20° C.): 5.4±0.4 CPS] (all trade names, manufactured by Kuraray Co., Ltd.), and the like.

The above values were measured in the manner described in JIS K-6726-1977.

With respect to modified polyvinyl alcohols, those described in Koichi Nagano, et al., “Poval”, Kobunshi Kankokai, Inc. are useful. The modified polyvinyl alcohols include polyvinyl alcohols modified by cations, anions, —SH compounds, alkylthio compounds, or silanols.

Examples of such modified polyvinyl alcohols (modified PVA) include C polymers such as C-118, C-318, C-318-2A, and C-506 (all being trade names of Kuraray Co., Ltd.); HL polymers such as HL-12E and HL-1203 (all being trade names of Kuraray Co., Ltd.); HM polymers such as HM-03 and HM-N-03 (all being trade names of Kuraray Co., Ltd.); K polymers such as KL-118, KL-318, KL-506, KM-118T, and KM-618 (all being trade names of Kuraray Co., Ltd.); M polymers such as M-115 (a trade name of Kuraray Co., Ltd.); MP polymers such as MP-102, MP-202, and MP-203 (all being trade names of Kuraray Co., Ltd.); MPK polymers such as MPK-1, MPK-2, MPK-3, MPK-4, MPK-5, and MPK-6 (all being trade names of Kuraray Co., Ltd.); R polymers such as R-1130, R-2105, and R-2130 (all being trade names of Kuraray Co., Ltd.); and V polymers such as V-2250 (a trade name of Kuraray Co., Ltd.).

The viscosity of polyvinyl alcohol can be adjusted or stabilized by adding a trace amount of a solvent or an inorganic salt to an aqueous solution of polyvinyl alcohol, and there can be employed compounds described in the aforementioned reference “Poval”, Koichi Nagano et al., published by Kobunshi Kankokai, pp. 144-154. For example, a coated-surface quality can be improved by an addition of boric acid, and the addition of boric acid is preferable. The amount of boric acid added is preferably 0.01 to 40 mass % with respect to polyvinyl alcohol.

Preferred binders for use in the heat insulation layer are transparent or semitransparent, and generally colorless. Examples include natural resins, polymers and copolymers; synthetic resins, polymers, and copolymers; and other media that form films: for example, rubbers, polyvinyl alcohols, hydroxyethyl celluloses, cellulose acetates, cellulose acetate butylates, polyvinylpyrrolidones, starches, polyacrylic acids, polymethyl methacrylates, polyvinyl chlorides, polymethacrylic acids, styrene/maleic acid anhydride copolymers, styrene/acrylonitrile copolymers, styrene/butadiene copolymers, polyvinylacetals (e.g., polyvinylformals and polyvinylbutyrals), polyesters, polyurethanes, phenoxy resins, polyvinylidene chlorides, polyepoxides, polycarbonates, polyvinyl acetates, polyolefins, cellulose esters, and polyamides. These binders are water-soluble.

In the present invention, preferred water-soluble polymers are polyvinyl alcohols and gelatin, with gelatin being most preferred.

The amount of the water-soluble polymer added to the heat insulation layer is preferably from 1 to 75% by mass, more preferably from 1 to 50% by mass based on the entire mass of the heat insulation layer.

The heat insulation layer preferably contains a gelatin. The amount of the gelatin in the coating solution for the heat insulation layer is preferably 0.5 to 14% by mass, and particularly preferably 1 to 6% by mass. Also, the coating amount of the above hollow polymer particles in the heat insulation layer is preferably 1 to 100 g/m², and more preferably 5 to 20 g/m².

It is preferable that a part or all of the water-soluble polymer contained in the heat insulation layer be cross-linked with a crosslinking agent. Preferable compounds as well as a preferable amount of the crosslinking agent to be used are the same as mentioned above.

A preferred ratio of a cross-linked water-soluble polymer in the heat insulation layer varies depending on the kind of the crosslinking agent, but the water-soluble polymer in the heat insulation layer is crosslinked by preferably 0.1 to 20 mass %, more preferably 1 to 10 mass %, based on the entire water-soluble polymer.

In the present invention, it is also a preferable embodiment that a water-soluble polymer used in the heat insulation layer is also used in the above-described receptor layer. Preferable water-soluble polymers are the same as those of the heat insulation layer.

(Hardener)

As a crosslinking agent (hereinafter also referred to as a crosslinking agent or compound capable of crosslinking a water-soluble polymer), a hardener (hardening agent) may be added in coating layers (e.g., the receptor layer, the heat insulation layer, the undercoat layer) of the image-receiving sheet. Particularly preferably, the crosslinking agent is used in a layer containing a water-soluble polymer.

Preferable examples of the hardener that can be used in the present invention include H-1, 4, 6, 8, and 14 in JP-A-1-214845 in page 17; compounds (H-1 to H-54) represented by one of the formulae (VII) to (XII) in U.S. Pat. No. 4,618,573, columns 13 to 23; compounds (H-1 to H-76) represented by the formula (6) in JP-A-2-214852, page 8, the lower right (particularly, H-14); and compounds described in claim 1 in U.S. Pat. No. 3,325,287. Examples of the hardening agent include hardening agents described, for example, in U.S. Pat. No. 4,678,739, column 41, U.S. Pat. No. 4,791,042, JP-A-59-116655, JP-A-62-245261, JP-A-61-18942, and JP-A-4-218044. More specifically, an aldehyde-series hardening agent (formaldehyde, etc.), an aziridine-series hardening agent, an epoxy-series hardening agent, a vinyl sulfone-series hardening agent (N,N′-ethylene-bis(vinylsulfonylacetamido)ethane, etc.), an N-methylol-series hardening agent (dimethylol urea, etc.), a boric acid, a metaboric acid, or a polymer hardening agent (compounds described, for example, in JP-A-62-234157), can be mentioned.

Preferable examples of the hardener include a vinylsulfone-series hardener and chlorotriazines.

More preferable hardeners in the present invention are compounds represented by the following Formula (B) or (D).
(CH₂═CH—SO₂)ₙ₂-L Formula (B)
(X⁴—CH₂—CH₂—SO₂)ₙ₂-L Formula (D)

In formulae (B) and (D), X⁴ represents a halogen atom, L represents an organic linking group having n2-valency. When the compound represented by formula (B) or (D) is a low-molecular compound, n2 denotes an integer from 1 to 4. When the compound represented by formula (B) or (D) is a high-molecular (polymer) compound, L represents an organic linking group containing a polymer chain and n2 denotes an integer ranging from 10 to 1,000.

In the Formulae (B) and (D), X⁴ is preferably a chlorine atom or a bromine atom, and further preferably a bromine atom. n2 is an integer from 1 to 4, preferably an integer from 2 to 4, more preferably 2 or 3 and most preferably 2.

L represents an organic group having n2-valency, and preferably an aliphatic hydrocarbon group, an aromatic hydrocarbon group or a heterocyclic group, provided that these groups may be combined through an ether bond, ester bond, amide bond, sulfonamide bond, urea bond, urethane bond or the like. Also, each of these groups may be further substituted. Examples of the substituent include a halogen atom, alkyl group, aryl group, heterocyclic group, hydroxyl group, alkoxy group, aryloxy group, alkylthio group, arylthio group, acyloxy group, alkoxycarbonyl group, carbamoyloxy group, acyl group, acyloxy group, acylamino group, sulfonamido group, carbamoyl group, sulfamoyl group, sulfonyl group, phosphoryl group, carboxyl group and sulfo group. Among these groups, a halogen atom, alkyl group, hydroxy group, alkoxy group, aryloxy group and acyloxy group are preferable.

Specific examples of the vinylsulfone-series hardener include, though not limited to, the following compounds (VS-1) to (VS-27).

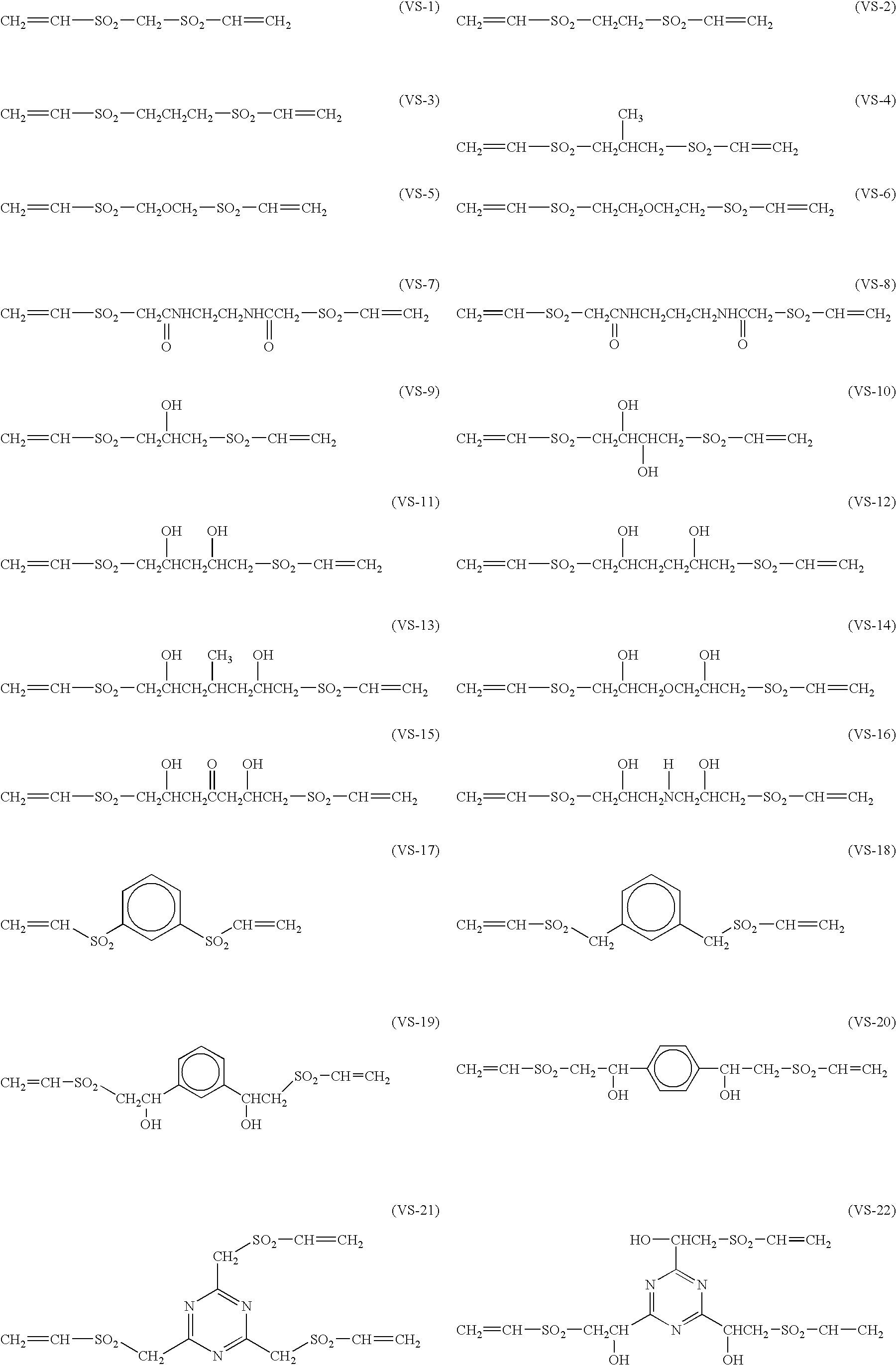

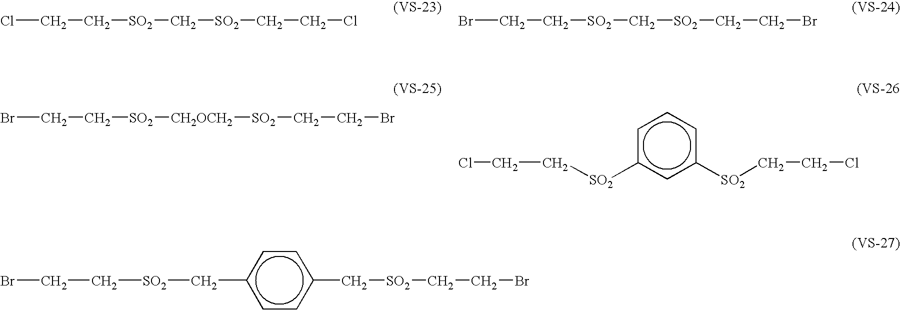

These hardeners may be obtained with reference to the method described in, for example, the specification of U.S. Pat. No. 4,173,481.

Furthermore, as the chlorotriazine-series hardener, a 1,3,5-triazine compound in which at least one of the 2-position, 4-position and 6-position of the triazine ring in the compound is substituted with a chlorine atom, is preferable. A 1,3,5-triazine compound in which two or three of the 2-position, 4-position and 6-position of the triazine ring each are substituted with a chlorine atom, is more preferable. Alternatively, use may be made of a 1,3,5-triazine compound in which at least one of the 2-position, 4-position and 6-position of the triazine ring is substituted with a chlorine atom, and the remainder position(s) is/are substituted with a group(s) or atom(s) other than a chlorine atom. Examples of these other groups or atoms include a hydrogen atom, bromine atom, fluorine atom, iodine atom, alkyl group, alkenyl group, alkynyl group, cycloalkyl group, cycloalkenyl group, aryl group, heterocyclic group, hydroxy group, nitro group, cyano group, amino group, hydroxylamino group, alkylamino group, arylamino group, heterocyclic amino group, acylamino group, sulfonamido group, carbamoyl group, sulfamoyl group, sulfo group, carboxyl group, alkoxy group, alkenoxy group, aryloxy group, heterocyclic oxy group, acyl group, acyloxy group, alkyl- or aryl-sulfonyl group, alkyl- or aryl-sulfinyl group, alkyl- or aryl-sulfonyloxy group, mercapto group, alkylthio group, alkenylthio group, arylthio group, heterocyclic thio group and alkyloxy- or aryloxy-carbonyl group.

Specific examples of the chlorotriazine-series hardener include, though not limited to, 4,6-dichloro-2-hydroxy-1,3,5-triazine or its Na salt, 2-chloro-4,6-diphenoxytriazine, 2-chloro-4,6-bis[2,4,6-trimethylphenoxy]triazine, 2-chloro-4,6-diglycidoxy-1,3,5-triazine, 2-chloro-4-(n-butoxy)-6-glycidoxy-1,3,5-triazine, 2-chloro-4-(2,4,6-trimethylphenoxy)-6-glycidoxy-1,3,5-triazine, 2-chloro-4-(2-chloroethoxy)-6-(2,4,6-trimethylphenoxy)-1,3,5-triazine, 2-chloro-4-(2-bromoethoxy)-6-(2,4,6-trimethylphenoxy)-1,3,5-triazine, 2-chloro-4-(2-di-n-butylphosphateethoxy)-6-(2,4,6-trimethylphenoxy)-1,3,5-triazine and 2-chloro-4-(2-di-n-butylphosphateethoxy)-6-(2,6-xylenoxy)-1,3,5-triazine.

Such a compound is easily produced by reacting cyanur chloride (namely, 2,4,6-trichlorotriazine) with, for example, a hydroxy compound, thio compound or amino compound corresponding to the substituent on the heterocycle.

These hardeners are preferably used in an amount of 0.001 to 1 g, and further preferably 0.005 to 0.5 g, per 1 g of the water-soluble polymer.

(Undercoat Layer)

An undercoat layer may be formed between the receptor layer and the heat insulation layer. As the undercoat layer, for example, at least one of a white background controlling layer, a charge controlling layer, an adhesive layer, and a primer layer is formed. These layers may be formed in the same manner as those described in, for example, each specification of Japanese Patent Nos. 3585599 and 2925244.

(Support)

There is no particular limitation to the support that can be used in the present invention. However, preferred are supports known in the field of heat-sensitive transfer image-receiving sheets. A water-proof support is particularly preferably used. The use of the waterproof support makes it possible to prevent the support from absorbing moisture, whereby a fluctuation in the performance of the receptor layer with lapse of time can be prevented. As the waterproof support, for example, coated paper or laminate paper may be used.

—Coated Paper—

The coated paper is paper obtained by coating a sheet such as base paper with various resins, rubber latexes, or high-molecular materials, on one side or both sides of the sheet, wherein the coating amount differs depending on its use. Examples of such coated paper include art paper, cast coated paper, and Yankee paper.

It is proper to use a thermoplastic resin as the resin to be applied to the surface(s) of the base paper and the like. As such a thermoplastic resin, the following thermoplastic resins (A) to (H) may be exemplified.

(A) Polyolefin resins such as polyethylene resin and polypropylene resin; copolymer resins composed of an olefin such as ethylene or propylene and another vinyl monomer; and acrylic resins.

(B) Thermoplastic resins having an ester linkage: for example, polyester resins obtained by condensation of a dicarboxylic acid component (such a dicarboxylic acid component may be substituted with a sulfonic acid group, a carboxyl group, or the like) and an alcohol component (such an alcohol component may be substituted with a hydroxyl group, or the like); polyacrylate resins or polymethacrylate resins such as polymethylmethacrylate, polybutylmethacrylate, polymethylacrylate, polybutylacrylate, or the like; polycarbonate resins, polyvinyl acetate resins, styrene acrylate resins, styrene-methacrylate copolymer resins, vinyltoluene acrylate resins, or the like.

Concrete examples of them are those described in JP-A-59-101395, JP-A-63-7971, JP-A-63-7972, JP-A-63-7973, and JP-A-60-294862.

Commercially available thermoplastic resins usable herein are, for example, Vylon 290, Vylon 200, Vylon 280, Vylon 300, Vylon 103, Vylon GK-140, and Vylon GK-130 (products of Toyobo Co., Ltd.); Tafton NE-382, Tafton U-5, ATR-2009, and ATR-2010 (products of Kao Corporation); Elitel UE 3500, UE 3210, XA-8153, KZA-7049, and KZA-1449 (products of Unitika Ltd.); and Polyester TP-220 and R-188 (products of The Nippon Synthetic Chemical Industry Co., Ltd.); and thermoplastic resins in the Hyros series from Seiko Chemical Industries Co., Ltd., and the like (all of these names are trade names).

(C) Polyurethane resins, etc.

(D) Polyamide resins, urea resins, etc.

(E) Polysulfone resins, etc.

(F) Polyvinyl chloride resins, polyvinylidene chloride resins, vinyl chloride/vinyl acetate copolymer resins, vinyl chloride/vinyl propionate copolymer resins, etc.

(G) Polyol resins such as polyvinyl butyral; and cellulose resins such as ethyl cellulose resin and cellulose acetate resin.

(H) Polycaprolactone resins, styrene/maleic anhydride resins, polyacrylonitrile resins, polyether resins, epoxy resins, and phenolic resins.

The thermoplastic resins may be used either alone or in combination of two or more.

The thermoplastic resin may contain a whitener, a conductive agent, a filler, a pigment or dye including, for example, titanium oxide, ultramarine blue, and carbon black; or the like, if necessary.

—Laminated Paper—

The laminated paper is a paper which is formed by laminating various kinds of resin, rubber, polymer sheets or films on a sheet such as a base paper or the like. Specific examples of the materials useable for the lamination include polyolefins, polyvinyl chlorides, polyethylene terephthalates, polystyrenes, polymethacrylates, polycarbonates, polyimides, and triacetylcelluloses. These resins may be used alone, or in combination of two or more.

Generally, the polyolefins are prepared by using a low-density polyethylene. However, for improving the thermal resistance of the support, it is preferred to use a polypropylene, a blend of a polypropylene and a polyethylene, a high-density polyethylene, or a blend of a high-density polyethylene and a low-density polyethylene. From the viewpoint of cost and its suitableness for the laminate, it is preferred to use the blend of a high-density polyethylene and a low-density polyethylene.

The blend of a high-density polyethylene and a low-density polyethylene is preferably used in a blend ratio (a mass ratio) of 1/9 to 9/1, more preferably 2/8 to 8/2, and most preferably 3/7 to 7/3. When the thermoplastic resin layer is formed on the both surfaces of the support, the back side of the support is preferably formed using, for example, the high-density polyethylene or the blend of a high-density polyethylene and a low-density polyethylene. The molecular weight of the polyethylenes is not particularly limited. Preferably, both of the high-density polyethylene and the low-density polyethylene have a melt index of 1.0 to 40 g/10 minute and a high extrudability.

The sheet or film may be subjected to a treatment to impart white reflection thereto. As a method of such a treatment, for example, a method of incorporating a pigment such as titanium oxide into the sheet or film can be mentioned.

The thickness of the support is preferably from 25 μm to 300 μm, more preferably from 50 μm to 260 μm, and further preferably from 75 μm to 220 μm. The support can have any rigidity according to the purpose. When it is used as a support for electrophotographic image-receiving sheet of photographic image quality, the rigidity thereof is preferably near to that in a support for use in color silver halide photography.

(Curling Control Layer)

When the support is exposed as it is, there is the case where the heat-sensitive transfer image-receiving sheet is made to curl by moisture and/or temperature in the environment. It is therefore preferable to form a curling control layer on the backside of the support. The curling control layer not only prevents the image-receiving sheet from curling but also has a water-proof function. For the curling control layer, a polyethylene laminate, a polypropylene laminate or the like is used. Specifically, the curling control layer may be formed in a manner similar to those described in, for example, JP-A-61-110135 and JP-A-6-202295.

(Writing Layer and Charge Controlling Layer)

For the writing layer and the charge control layer, an inorganic oxide colloid, an ionic polymer, or the like may be used. As the antistatic agent, use may be made of any antistatic agent including a cationic antistatic agent, such as a quaternary ammonium salt and a polyamine derivative, an anionic antistatic agent, such as an alkyl phosphate, and a nonionic antistatic agent, such as a fatty acid ester. Specifically, the writing layer and the charge control layer may be formed in a manner similar to those described, for example, in the specification of Japanese Patent No. 3585585.

The method of producing the heat-sensitive transfer image-receiving sheet for use in the present invention is explained below.

The heat-sensitive transfer image-receiving sheet for use in the present invention can be preferably formed, by applying at least one receptor layer, at least one intermediate layer and at least one heat-insulation layer, on a support, through simultaneous multi-layer coating.

It is known that in the case of producing an image-receiving sheet composed of plural layers having different functions from each other (for example, an air cell layer, a heat insulation layer, an intermediate layer and a receptor layer) on a support, it may be produced by applying each layer successively one by one, or by overlapping the layers each already coated on a support or substrate, as shown in, for example, JP-A-2004-106283, JP-A-2004-181888 and JP-A-2004-345267. It has been known in photographic industries, on the other hand, that productivity can be greatly improved, for example, by providing plural layers through simultaneous multi-layer coating. For example, there are known methods such as the so-called slide coating (slide coating method) and curtain coating (curtain coating method) as described in, for example, U.S. Pat. Nos. 2,761,791, 2,681,234, 3,508,947, 4,457,256 and 3,993,019; JP-A-63-54975, JP-A-61-278848, JP-A-55-86557, JP-A-52-31727, JP-A-55-142565, JP-A-50-43140, JP-A-63-80872, JP-A-54-54020, JP-A-5-104061, JP-A-5-127305, and JP-B-49-7050 (“JP-B” means examined Japanese patent publication); and Edgar B. Gutoff, et al., “Coating and Drying Defects: Troubleshooting Operating Problems”, John Wiley & Sons Company, 1995, pp. 101-103.

In the present invention, the productivity is greatly improved and, at the same time, image defects can be remarkably reduced, by using the above simultaneous multilayer coating for the production of an image-receiving sheet having a multilayer structure.

The plural layers in the present invention are structured using resins as its major components. Coating solutions forming each layer are preferably water-dispersible latexes. The solid content by mass of the resin put in a latex state in each layer coating solution is preferably in a range from 5 to 80% and particularly preferably 20 to 60%. The average particle size of the resin contained in the above water-dispersed latex is preferably 5 μm or less and particularly preferably 1 μm or less. The above water-dispersed latex may contain a known additive, such as a surfactant, a dispersant, and a binder resin, according to the need.

In the present invention, it is preferred that a laminate composed of plural layers be formed on a support and solidified just after the forming, according to the method described in U.S. Pat. No. 2,761,791. For example, in the case of solidifying a multilayer structure by using a resin, it is preferable to raise the temperature immediately after the plural layers are formed on the support. Also, in the case where a binder (e.g., a gelatin) to be gelled at lower temperatures is contained, there is the case where it is preferable to drop the temperature immediately after the plural layers are formed on the support.

In the present invention, the coating amount of a coating solution per one layer constituting the multilayer is preferably in a range from 1 g/m² to 500 g/m². The number of layers in the multilayer structure may be arbitrarily selected from a number of 2 or more. The receptor layer is preferably disposed as a layer most apart from the support.

(2) Heat-Sensitive Transfer Sheet

Next, the heat-sensitive (thermal) transfer sheet (hereinafter also referred to as “ink sheet”) for use in the present invention is explained below.

The ink sheet that is used in combination with the above-mentioned heat-sensitive transfer image-receiving sheet at the time when a thermal transfer image is formed, is provided with, on a support, a heat transfer layer containing a diffusion transfer dye (hereinafter, also referred to as “dye layer”). The dye layer is applied using a usual method such as a roll coating, a bar coating, a gravure coating, and a gravure reverse coating.

The kind of the support is not limited in particular. Examples of the support include thin leaf papers such as a glassine paper, a capacitor paper, and a paraffin paper; plastics such as polyester, polypropylene, cellophane, polycarbonate, cellulose acetate, polyethylene, polyvinylchloride, polystyrene, nylon, polyimide, polyvinylidene chloride, and ionomer; and a composite substrate film of these plastics and the above-exemplified paper. The thickness of the support may be properly changed according to the materials used for the support so that physical properties thereof such as strength and heat resistance become suitable. A preferable thickness of the support is from 1 μm to 100 μm.

In the ink sheet used for the present invention, particularly in the first embodiment of the present invention, the yellow heat transfer layer (yellow dye layer) contains at least one compound represented by formula (Y) as a yellow dye, and the cyan heat transfer layer (cyan dye layer) contains only a compound represented by formula (C) as a cyan dye.

In the present invention, particularly in the first embodiment of the present invention, the cyan dye contained in the cyan heat transfer layer is only a compound represented by formula (C), and therefore no other cyan dye is contained therein. However, the compound represented by formula (C) may be a single compound or mixed compounds.

In the magenta heat transfer layer (magenta dye layer) used for the present invention, particularly the first embodiment thereof, known heat transfer dyes are used. Of these magenta dyes, particularly preferred are compounds represented by formulae (M1), (M2), (M3), and (M4).

In the present invention, particularly in the second embodiment of the present invention, it is essential that the heat transfer layer of the ink sheet used in combination with the above-described heat-sensitive transfer image-receiving sheet contains at least one dye represented by the above-described formula (M) as a magenta dye, at least one dye represented by the above-described formula (YB), (YA), (YC), (YD) or (YE) as a yellow dye, and at least one dye represented by the above-described formula (C1) or (C) as a cyan dye.

With respect to the ink sheet used in the present invention, particularly in the third embodiment of the present invention, at least one compound represented by formula (M) is contained as a magenta dye in a magenta heat transfer layer (magenta dye layer), whereas only a compound represented by formula (C) is contained as a cyan dye in a cyan heat transfer layer (cyan dye layer). Further, a yellow heat transfer layer (yellow dye layer) preferably contains at least one compound represented by any one of formulae (YA) to (YE).

In the present invention, particularly in the third embodiment of the present invention, the cyan dye contained in the cyan heat transfer layer is only a compound represented by the above-described formula (C), and therefore no other cyan dye is contained therein. Herein, the compound represented by formula (C) may be used singly or by combining two or more kinds of them as a mixture.

In the third embodiment of the present invention, as the yellow dye contained in the yellow heat transfer layer (also referred to as a yellow ink layer), there is no particular limitation, so far as the compound can be used as a yellow dye for a heat transfer sheet. However, it is preferred to use a dye compound represented by any one of the above-described formulae (YA) to (YE). Of these compounds, more preferred are dye compounds represented by formula (YA) or (YB).

In an image formed in the receptor layer of the heat-sensitive transfer image-receiving sheet associated with the heat-sensitive transfer sheet according to the image-forming method of the present invention, particularly of the third embodiment of the present invention, it is preferable that a yellow dye component of the image is a dye originated from the compound represented by formula (YA) or (YB), a magenta dye component of the image is a dye originated from the compound represented by formula (M), and a cyan dye component of the image is a dye originated from the compound represented by formula (C).

A preferred specific mode is wherein heat-sensitive transfer layers each containing a dye having a different color from each other are successively coated on the above-described heat-sensitive transfer sheet in the longitudinal direction of the sheet with forming layers (panels) arranged side-by-side (i.e. sequential panel coating), and, as the dyes each having a different color, a corresponding dye compound (e.g., the compounds represented by formula (YA), (YB), (M), or (C)) is contained in each of the heat-sensitive transfer layers.

In the following, the dyes for use in various embodiments of the present invention will be explained.

The compound represented by formula (Y) is explained in detail below.

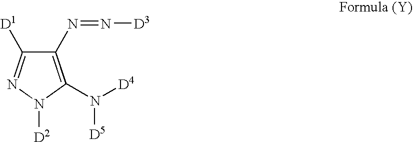

In formula (Y), D¹ represents a hydrogen atom, an alkyl group, an alkoxy group, an aryl group, an alkoxycarbonyl group, a cyano group, or a carbamoyl group; D² represents a hydrogen atom, an alkyl group, an aryl group, or a heteroaryl group; D³ represents an aryl group or a heteroaryl group; D⁴ and D⁵ each independently represent a hydrogen atom or an alkyl group; and each of the above-mentioned groups may further be substituted.

The compound represented by formula (Y) is preferably a compound to be a yellow dye.

D¹ represents a hydrogen atom, an alkyl group (preferably an alkyl group having 1 to 12 carbon atoms, e.g., methyl, ethyl, isopropyl, n-propyl, t-butyl), an alkoxy group (preferably an alkoxy group having 1 to 12 carbon atoms, e.g., methoxy, butoxy, octyloxy, dodecyloxy), an aryl group (preferably an aryl group having 6 to 10 carbon atoms, e.g., phenyl, m-nitrophenyl, p-nitrophenyl, p-tolyl), an alkoxycarbonyl group (preferably an alkoxycarbonyl group having 2 to 10 carbon atoms, e.g., methoxycarbonyl, ethoxycarbonyl, isopropoxycarbonyl, n-octyloxycarbonyl), a cyano group, or a carbamoyl group (preferably a carbamoyl group having 1 to 10 carbon atoms, e.g., methyl carbamoyl, ethyl carbamoyl, dimethyl carbamoyl). Among these, an alkyl group having 1 to 4 carbon atoms is preferable.

D² represents a hydrogen atom, an alkyl group (preferably an alkyl group having 1 to 12 carbon atoms, e.g., methyl, ethyl, isopropyl, n-propyl, t-butyl), an aryl group (preferably an aryl group having 6 to 25 carbon atoms, e.g., phenyl, m-nitrophenyl, p-nitrophenyl, p-tolyl, naphthyl), or a heteroaryl group (preferably a 5- or 6-membered hetero-aromatic ring having 0 to 25 carbon atoms, containing, as a ring-constituting atom(s), a hetero atom selected from a nitrogen atom, an oxygen atom and a sulfur atom, in which the ring may be a ring condensed with another ring, and specifically, e.g., thiophene ring, furan ring, pyrrol ring, imidazole ring, pyrazole ring, pyridine ring, pyrazine ring, pyrimidine ring, pyridazine ring, indole ring, purine ring, quinoxaline ring). Among these, an alkyl group and an aryl group are preferable; and a methyl group, and a phenyl group, which may further be substituted, are more preferable.

D³ represents an aryl group (preferably an aryl group having 6 to 25 carbon atoms, e.g., phenyl and naphthyl, that may be substituted with a substituent such as an alkyl group, an alkoxy group, an aryloxy group, an aralkyl group, an aryl group, a halogen atom, a cyano group, a nitro group, an ester group, a carbamoyl group, an acyl group, an acylamino group, a sulfonyl group, a sulfamoyl group, a sulfonamido group, an amino group, an alkylamino group, an arylamino group and a hydroxyl group) or a heteroaryl group (preferably a 5- or 6-membered hetero-aromatic ring having 0 to 25 carbon atoms, and more preferably 3 to 10 carbon atoms, containing, as a ring-constituting atom(s), a hetero atom selected from a nitrogen atom, an oxygen atom and a sulfur atom, in which the ring may be a ring condensed with another ring, and specifically, e.g., a thiophene ring, a furan ring, a pyrrol ring, an imidazole ring, a pyrazole ring, a pyridine ring, a pyrazine ring, a pyrimidine ring, a pyridazine ring, an indole ring, a purine ring, a quinoxaline ring, each of which may be further substituted with a substituent(s) such as an alkyl group, an alkoxy group, an aryloxy group, an aralkyl group, an aryl group, a halogen atom, a cyano group, a nitro group, an ester group, a carbamoyl group, an acyl group, an acylamino group, a sulfonyl group, a sulfamoyl group, a sulfonamido group, an amino group, an alkylamino group, an arylamino group and a hydroxyl group). Among these, D³ is preferably an aryl group, more preferably a phenyl group which may be further substituted, and still further preferably a phenyl group substituted with 1 to 3 electron-attractive groups (e.g., a halogen atom, a cyano group, a nitro group, a carbamoyl group, an acyl group, a sulfonyl group, a sulfamoyl group).

D⁴ and D⁵ each independently represent a hydrogen atom or an alkyl group (preferably an alkyl group having 1 to 12 carbon atoms, e.g., methyl, ethyl, isopropyl, n-propyl, t-butyl). Among these, a hydrogen atom is preferable.

Specific examples of the dye represented by formula (Y) for use in the present invention are shown below. However, the present invention should not be construed as being limited to these compounds.

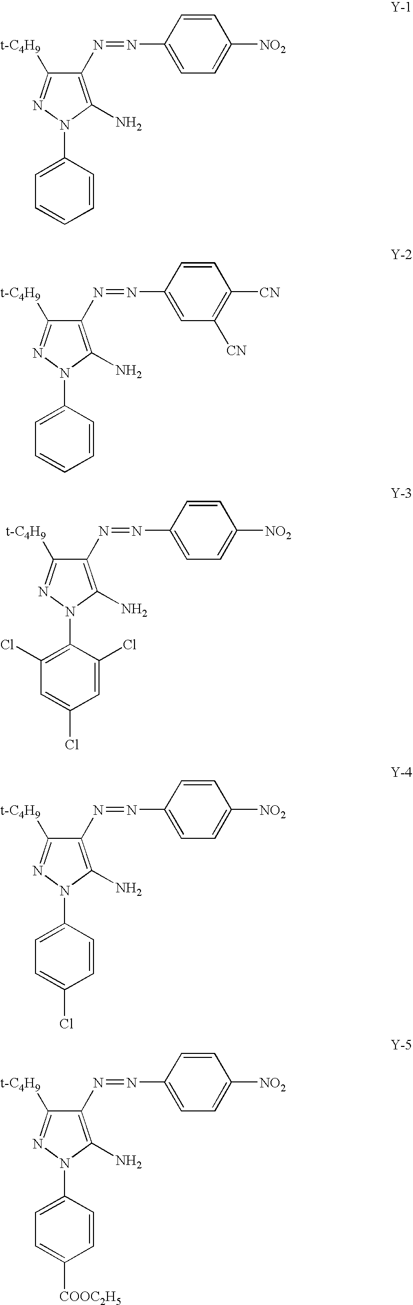

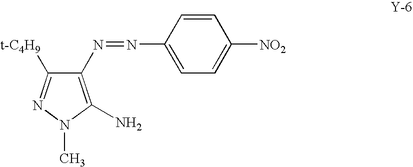

These dyes may be easily synthesized by or in accordance with the method described in JP-A-1-225592.

Next, the dye represented by formula (YB) is explained in detail.

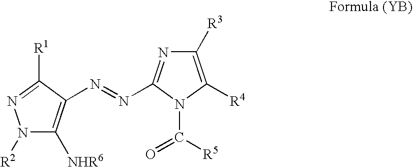

In formula (YB), R¹, R², R³, R⁴, and R⁶ each independently represent a hydrogen atom or a monovalent substituent; and R⁵ represents a monovalent substituent.

The azo dye represented by formula (YB) is a dye characterized in that a coupler component is an aminopyrazole, and a carbonyl group is introduced as a substituent at the 1-position of the imidazole that is a diazo component.

Such the dye is overwhelmingly excellent in light fastness, as compared to a dye wherein the substituent at the 1-position of the imidazole is a hydrogen atom or an alkyl group. It is assumed that, in these compound, the oxygen atom of the carbonyl group and the nitrogen atom of the azo group form a cross linking with a hydrogen atom of the amino group in the coupler component, and this cross linking enables the dye to be effectively inactive against excitation energy.

In formula (YB), R¹, R³, and R⁴ each independently represent a hydrogen atom or a monovalent substituent. There is no particular limitation on the substituent. Representative examples of the substituent include a halogen atom, an alkyl group (the term “alkyl group” used in this specification means a saturated aliphatic group including a cycloalkyl group and a bicycloalkyl group), an alkenyl group (the term “alkenyl group” used in this specification means an unsaturated aliphatic group having a double bond, that includes a cycloalkenyl group and a bicycloalkenyl group), an alkynyl group, an aryl group, a heterocyclic group, a cyano group, an alkoxy group, an aryloxy group, an acyloxy group, a carbamoyloxy group, an alkoxycarbonyloxy group, an aryloxycarbonyloxy group, an amino group (including an alkylamino group, an anilino group, and a heterocyclic amino group), an acylamino group, an aminocarbonylamino group, an alkoxycarbonylamino group, an aryloxycarbonylamino group, a sulfamoylamino group, an alkyl- or aryl-sulfonylamino group, an alkylthio group, a sulfamoyl group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, and an imido group. Each of these groups may further be substituted.

In formula (YB), R² and R⁶ each independently represent a hydrogen atom or a monovalent substituent. There is no particular limitation on the substituent. Representative examples of the substituent include an alkyl group, an alkenyl group, an alkynyl group, an aryl group, a heterocyclic group, an acyl group, an aryloxycarbonyl group, an alkoxycarbonyl group, and a carbamoyl group. Each of these groups may further be substituted.

In formula (YB), R⁵ represents a monovalent substituent. There is no particular limitation on the substituent. Representative examples of the substituent include an alkyl group, an alkenyl group, an alkynyl group, an aryl group, a heterocyclic group, an alkoxy group, an aryloxy group, an acyloxy group, an amino group (including an alkylamino group, an anilino group, and a heterocyclic amino group), an acylamino group, an aminocarbonylamino group, an alkoxycarbonylamino group, an aryloxycarbonylamino group, a sulfamoylamino group, an alkyl- or aryl-sulfonylamino group, and an alkylthio group. Each of these groups may further be substituted.

In the following, the “monovalent substituent” is explained in more detail.

The following explanation started from “halogen atom” to “imido group” applies to all the explanations of the dyes in the present specification. The term “substituent” in the phrases such as “substituent”, “a monovalent substituent”, and “may further be substituted”, “may further have a substituent”, “optionally substituted” refers to those mentioned in the following explanation. Hereinafter, the following explanation is also referred to as “the specific examples of the substituents”.

Examples of the halogen atom include a fluorine atom, a chlorine atom, a bromine atom, and an iodine atom. Among these, a chlorine atom and a bromine atom are preferable, and a chlorine atom is particularly preferable.

The alkyl group includes a cycloalkyl group and a bicycloalkyl group. The alkyl group also includes straight or branched chain and substituted or unsubstituted alkyl groups. The straight or branched chain and substituted or unsubstituted alkyl groups are preferably ones having 1 to 30 carbon atoms. Examples thereof include methyl, ethyl, n-propyl, isopropyl, t-butyl, n-octyl, eicosyl, 2-chloroethyl, 2-cyanoethyl and 2-ethylhexyl. The cycloalkyl group includes substituted or unsubstituted cycloalkyl groups. The substituted or unsubstituted cycloalkyl groups are preferably ones having 3 to 30 carbon atoms. Examples thereof include cyclohexyl, cyclopentyl, and 4-n-dodecylcyclohexyl. The bicycloalkyl group is preferably a substituted or unsubstituted bicycloalkyl group having from 5 to 30 carbon atoms, namely, a monovalent group resultant from removing one hydrogen atom of a bicycloalkane having from 5 to 30 carbon atoms. Examples thereof include bicyclo[1,2,2]heptane-2-yl and bicyclo[2,2,2]octane-3-yl. The alkyl group also includes alkyl groups having a multi-ring structure such as a tricyclo structure. The above-mentioned concept of the alkyl group is also applied to an alkyl moiety of the substituents (e.g., an alkyl moiety of the alkylthio group) that are explained below.

The alkenyl group includes a cycloalkenyl group and a bicycloalkenyl group. The alkenyl group also includes straight or branched chain or cyclic, and substituted or unsubstituted alkenyl groups. The alkenyl group is preferably a substituted or unsubstituted alkenyl group having 2 to 30 carbon atoms. Examples thereof include vinyl, allyl, prenyl, geranyl and oleyl. The cycloalkenyl group is preferably a substituted or unsubstituted cycloalkenyl group having 3 to 30 carbon atoms, namely a monovalent group resultant from removing one hydrogen atom of a cycloalkene group having 3 to 30 carbon atoms. Examples thereof include 2-cyclopentene-1-yl and 2-cyclohexene-1-yl. The bicycloalkenyl group includes a substituted or unsubstituted bicycloalkenyl group. The bicycloalkenyl group is preferably a substituted or unsubstituted bicycloalkenyl group having 5 to 30 carbon atoms, namely a monovalent group resultant from removing one hydrogen atom from a bicycloalkene having one double bond. Examples thereof include bicyclo[2,2,1]hept-2-ene-1-yl and bicyclo[2,2,2]oct-2-ene-4-yl.

The alkynyl group is preferably a substituted or unsubstituted alkynyl group having 2 to 30 carbon atoms. Examples thereof include ethynyl and propargyl.

The aryl group is preferably a substituted or unsubstituted aryl group having 6 to 30 carbon atoms. Examples thereof include phenyl, p-tolyl, naphthyl, m-chlorophenyl and o-hexadecanoylaminophenyl.

The heterocyclic group is preferably a monovalent group resultant from removing one hydrogen atom from a substituted or unsubstituted and aromatic or non-aromatic heterocyclic compound. The hetero ring in the heterocyclic group may be a condensed ring. The heterocyclic group is more preferably a 5- or 6-membered heterocyclic group. As the hetero atom constituting the ring, an oxygen atom, a sulfur atom, and a nitrogen atom are preferable. Furthermore preferably, the heterocyclic group is a 5- or 6-membered aromatic heterocyclic group having 3 to 30 carbon atoms. In place of examples of the heterocyclic group, hetero rings which may constitute the heterocyclic group are exemplified below without denotation of their substitution sites: pyridine, pyrazine, pyridazine, pyrimidine, triazine, quinoline, isoquinoline, quinazoline, cinnoline, phthalazine, quinoxaline, pyrrol, indole, furan, benzofuran, thiophene, benzothiophene, pyrrazole, imidazole, benzimidazole, triazole, oxazole, benzoxazole, thiazole, benzothiazole, isothiazole, benzisothiazole, thiadiazole, isoxazole, benzoisoxazole, pyrrolidine, piperidine, piperazine, imidazolidine and thiazoline.

The alkoxy group includes a substituted or unsubstituted alkoxy group. The substituted or unsubstituted alkoxy group is preferably an alkoxy group having 1 to 30 carbon atoms. Examples of the alkoxy group include methoxy, ethoxy, isopropoxy, n-octyloxy, methoxyethoxy, hydroxyethoxy and 3-carboxypropoxy.

The aryloxy group is preferably a substituted or unsubstituted aryloxy group having 6 to 30 carbon atoms. Examples of the aryloxy group include phenoxy, 2-methylphenoxy, 4-t-butylphenoxy, 3-nitrophenoxy and 2-tetradecanoylaminophenoxy.

The acyloxy group is preferably a formyloxy group, a substituted or unsubstituted alkylcarbonyloxy group having 2 to 30 carbon atoms, and a substituted or unsubstituted arylcarbonyloxy group having 6 to 30 carbon atoms. Examples of the acyloxy group include formyloxy, acetyloxy, pivaloyloxy, stearoyloxy, benzoyloxy and p-methoxyphenyl carbonyloxy.

The carbamoyloxy group is preferably a substituted or unsubstituted carbamoyloxy group having 1 to 30 carbon atoms. Examples of the carbamoyloxy group include N,N-dimethylcarbamoyloxy, N,N-diethylcarbamoyloxy, morpholino carbonyloxy, N,N-di-n-octylaminocarbonyloxy and N-n-octylcarbamoyloxy.

The alkoxycarbonyloxy group is preferably a substituted or unsubstituted alkoxycarbonyloxy group having 2 to 30 carbon atoms. Examples of the alkoxycarbonyloxy group include methoxycarbonyloxy, ethoxycarbonyloxy, t-butoxycarbonyloxy and n-octylcarbonyloxy.

The aryloxycarbonyloxy group is preferably a substituted or unsubstituted aryloxycarbonyloxy group having 7 to 30 carbon atoms. Examples of the aryloxycarbonyloxy group include phenoxycarbonyloxy, p-methoxyphenoxycarbonyloxy and p-n-hexadecyloxyphenoxycarbonyloxy.

The amino group includes an alkylamino group, an arylamino group, and a heterocyclic amino group. The amino group is preferably a substituted or unsubstituted alkylamino group having 1 to 30 carbon atoms or a substituted or unsubstituted arylamino group having 6 to 30 carbon atoms. Examples of the amino group include amino, methylamino, dimethylamino, anilino, N-methyl-anilino, diphenylamino, hydroxyethylamino, carboxyethylamino, sulfoethylamino, 3,5-dicarboxyanilino, and 4-quinolylamino.

The acylamino group is preferably a formylamino group, a substituted or unsubstituted alkylcarbonylamino group having 1 to 30 carbon atoms or a substituted or unsubstituted arylcarbonylamino group having 6 to 30 carbon atoms. Examples of the acylamino group include formylamino, acetylamino, pivaloylamino, lauroylamino, benzoylamino and 3,4,5-tri-n-octyloxyphenylcarbonylamino.

The aminocarbonylamino group is preferably a substituted or unsubstituted aminocarbonylamino group having 1 to 30 carbon atoms. Examples of the aminocarbonylamino group include carbamoylamino, N,N-dimethylaminocarbonylamino, N,N-diethylaminocarbonylamino and morpholinocarbonylamino. Herein, the term “amino” in the aminocarbonylamino group has the same meaning as the above explained amino group.

The alkoxycarbonylamino group is preferably a substituted or unsubstituted alkoxycarbonylamino group having 2 to 30 carbon atoms. Examples of the alkoxycarbonylamino group include methoxycarbonylamino, ethoxycarbonylamino, t-butoxycarbonylamino, n-octadecyloxycarbonylamino and N-methyl-methoxycarbonylamino.

The aryloxycarbonylamino group is preferably a substituted or unsubstituted aryloxycarbonylamino group having 7 to 30 carbon atoms. Examples of the aryloxycarbonylamino group include phenoxycarbonylamino, p-chlorophenoxycarbonylamino and m-n-octyloxyphenoxycarbonylamino.

The sulfamoylamino group is preferably a substituted or unsubstituted sulfamoylamino group having 0 to 30 carbon atoms. Examples of the sulfamoylamino group include sulfamoylamino, N,N-dimethylaminosulfonylamino and N-n-octylaminosulfonylamino.

The alkyl- or aryl-sulfonylamino group is preferably a substituted or unsubstituted alkylsulfonylamino group having 1 to 30 carbon atoms or a substituted or unsubstituted arylsulfonylamino group having 6 to 30 carbon atoms. Examples of the alkylsulfonylamino group and the arylsulfonylamino group include methylsulfonylamino, butylsulfonylamino, phenylsulfonylamino, 2,3,5-trichlorophenylsulfonylamino and p-methylphenylsulfonylamino.

The alkylthio group is preferably a substituted or unsubstituted alkylthio group having 1 to 30 carbon atoms. Examples of the alkylthio group include methylthio, ethylthio and n-hexadecylthio.

The sulfamoyl group is preferably a substituted or unsubstituted sulfamoyl group having 0 to 30 carbon atoms. Examples of the sulfamoyl group include N-ethylsulfamoyl, N-(3-dodecyloxypropyl)sulfamoyl, N,N-dimethylsulfamoyl, N-acetylsulfamoyl, N-benzoylsulfamoyl and N-(N′-phenylcarbamoyl)sulfamoyl.

The alkyl- or aryl-sulfinyl group is preferably a substituted or unsubstituted alkylsulfinyl group having 1 to 30 carbon atoms or a substituted or unsubstituted arylsulfinyl group having 6 to 30 carbon atoms. Examples of the alkylsulfinyl group and the arylsulfinyl group include methylsulfinyl, ethylsulfinyl, phenylsulfinyl and p-methylphenylsulfinyl.

The alkyl- or aryl-sulfonyl group is preferably a substituted or unsubstituted alkylsulfonyl group having 1 to 30 carbon atoms or a substituted or unsubstituted arylsulfonyl group having 6 to 30 carbon atoms. Examples of the alkylsulfonyl group and the arylsulfonyl group include methylsulfonyl, ethylsulfonyl, phenylsulfonyl and p-toluenesulfonyl.

The acyl group is preferably a formyl group, a substituted or unsubstituted alkylcarbonyl group having 2 to 30 carbon atoms, a substituted or unsubstituted arylcarbonyl group having 7 to 30 carbon atoms, or a substituted or unsubstituted heterocyclic carbonyl group having 4 to 30 carbon atoms in which one of the carbon atoms in the hetero ring bonds to the carbonyl moiety. Examples of the acyl group include acetyl, pivaloyl, 2-chloroacetyl, stearoyl, benzoyl, p-n-octyloxyphenylcarbonyl, 2-pyridylcarbonyl and 2-furylcarbonyl.

The aryloxycarbonyl group is preferably a substituted or unsubstituted aryloxycarbonyl group having 7 to 30 carbon atoms. Examples of the aryloxycarbonyl group include phenoxycarbonyl, o-chlorophenoxycarbonyl, m-nitrophenoxycarbonyl and p-t-butylphenoxycarbonyl.

The alkoxycarbonyl group is preferably a substituted or unsubstituted alkoxycarbonyl group having 2 to 30 carbon atoms. Examples of the alkoxycarbonyl group include methoxycarbonyl, ethoxycarbonyl, t-butoxycarbonyl and n-octadecyloxycarbonyl.

The carbamoyl group is preferably a substituted or unsubstituted carbamoyl group having 1 to 30 carbon atoms. Examples of the carbamoyl group include carbamoyl, N-methylcarbamoyl, N,N-dimethylcarbamoyl, N,N-di-n-octylcarbamoyl and N-(methylsulfonyl)carbamoyl.

Examples of the aryl- or heterocyclic-azo group include phenylazo, 4-methoxyphenylazo, 4-pivaloylaminophenylazo and 2-hydroxy-4-propanoylphenylazo.

Examples of the imido group include N-succinimido and N-phthalimido.

R¹ is preferably a substituted or unsubstituted alkyl group having 1 to 4 carbon atoms, a substituted or unsubstituted aryl group, a cyano group, a substituted or unsubstituted alkoxycarbonyl group having 1 to 4 carbon atoms, a substituted or unsubstituted acylamino group, or a carbamoyl group; more preferably a substituted or unsubstituted alkyl group having 1 to 4 carbon atoms, a substituted or unsubstituted aryl group, a substituted or unsubstituted alkoxycarbonyl group having 1 to 4 carbon atoms, or a carbamoyl group; and most preferably an unsubstituted alkyl group having 1 to 4 carbon atoms.

R² is preferably a substituted or unsubstituted alkyl group having 1 to 4 carbon atoms, a substituted or unsubstituted aryl group, a substituted or unsubstituted heterocyclic group, or a substituted or unsubstituted acyl group; more preferably a substituted or unsubstituted alkyl group having 1 to 4 carbon atoms or a substituted or unsubstituted aryl group; and most preferably an unsubstituted alkyl group having 1 to 4 carbon atoms.

R³ and R⁴ each independently represent preferably an electron attractive group having Hammett' substitution constant σₚ value of from 0.2 to 1.0. R³ is preferably an electron attractive group having σₚ value of 0.30 or more, more preferably 0.45 or more, and especially preferably 0.60 or more. The upper limit of the σₚ value is preferably 1.0. Examples of the electron attractive group having σₚ value of 0.60 or more include a nitro group, a cyano group, a methane sulfonyl group, a trifluoromethane sulfonyl group, a trifluoroacetyl group, a dimethylaminosulfonyl group, and a sulfamoyl group. Examples of the electron attractive group having σₚ value of 0.45 or more include an alkoxycarbonyl group, a cyano group, and a carboxyl group. Examples of the electron attractive group having σₚ value of 0.30 or more include a sulfo group, and a carbamoyl group.

More preferred are a cyano group, a carboxyl group, an alkoxycarbonyl group, and a carbamoyl group. Furthermore preferred are a cyano group, an alkoxycarbonyl group, and a carbamoyl group. A cyano group is most preferred.

The expression “Hammett substituent constant σₚ value” used herein will be briefly described.

Hammett's rule is a rule of thumb advocated by L. P. Hammett in 1935 for quantitatively considering the effect of substituents on the reaction or equilibrium of benzene derivatives, and the appropriateness thereof is now widely recognized. The substituent constant determined in the Hammett's rule involves σₚ value and σₘ value. These values can be found in a multiplicity of general publications, and are detailed in, for example, “Lange's Handbook of Chemistry” 12th edition by J. A. Dean, 1979 (McGraw-Hill) and “Kagaku no Ryoiki” special issue, no. 122, pp. 96 to 103, 1979 (Nankodo). Although in the present specification, substituents are defined by the Hammett substituent constant σₚ or described thereby, this should not be construed as limitation to only substituents whose values are known by literature and can be found in the above publications, and should naturally be construed as including substituents whose values, even if unknown by literature, would be included in the stated ranges when measured according to the Hammett's rule. Further, although some of the compounds represented by formulae in the present specification are not benzene derivatives, the σₚ value is used, irrespective of the position of substitution, as a scale for evaluating the electronic effect of substituents thereof. In the present specification, the σₚ value will be used in the above meaning.

R⁵ is preferably a substituted or unsubstituted alkyl group having 1 to 4 carbon atoms, a dialkylamino group having 2 to 10 carbon atoms, a substituted or unsubstituted alkoxy group, and a substituted or unsubstituted aryl group, more preferably a substituted or unsubstituted alkyl group having 1 to 4 carbon atoms, a dialkylamino group having 2 to 10 carbon atoms, and a substituted or unsubstituted alkoxy group, and most preferably a dialkylamino group having 2 to 10 carbon atoms.

The following is an explanation about a preferable combination of various substituents (atoms) that a dye represented by formula (YB) may have: A preferred compound is a compound in which at least one of the substituents is the above-described preferable substituent. A more preferred compound is a compound in which more substituents are the above-described preferable substituents. The most preferred compound is a compound in which all substituents are the above-described preferable substituents.

A preferable combination of the substituents is a combination where R¹ is a substituted or unsubstituted alkyl group having 1 to 4 carbon atoms, R² is a substituted or unsubstituted alkyl group having 1 to 4 carbon atoms or a substituted or unsubstituted aryl group, R³ is a cyano group or an alkoxycarbonyl group, R⁴ is a cyano group or an alkoxycarbonyl group, and R⁵ is a substituted or unsubstituted alkyl group having 1 to 4 carbon atoms, a dialkylamino group having 2 to 10 carbon atoms, a substituted or unsubstituted alkoxy group, and a substituted or unsubstituted aryl group.

A more preferable combination of the substituents is a combination where R¹ is a substituted or unsubstituted alkyl group having 1 to 4 carbon atoms, R² is a substituted or unsubstituted alkyl group having 1 to 4 carbon atoms or a substituted or unsubstituted aryl group, R³ is a cyano group, R⁴ is a cyano group, and R⁵ is a dialkylamino group having 2 to 10 carbon atoms.

The most preferable combination of the substituents is a combination where R¹ is a substituted or unsubstituted alkyl group having 1 to 4 carbon atoms, R² is a substituted or unsubstituted alkyl group having 1 to 4 carbon atoms or a substituted or unsubstituted aryl group, R³ is a cyano group, R⁴ is a cyano group, and R⁵ is a dialkylamino group having 2 to 4 carbon atoms.

A molecular weight of the compound represented by formula (YB) is preferably 500 or less, and more preferably 450 or less, from a viewpoint of thermal diffusion.

Hereinafter, specific examples of the azo dye represented by formula (YB) for use in the present invention will be shown, but the azo dye represented by formula (YB) in the present invention is not limited thereto. In the specific examples, “Ph” represents a phenyl group (—C₆H₅).

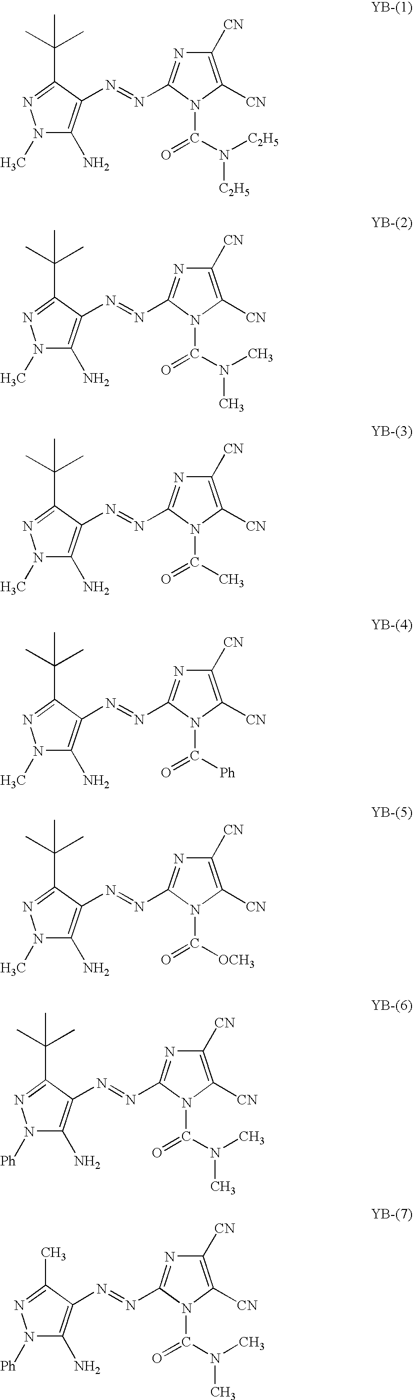

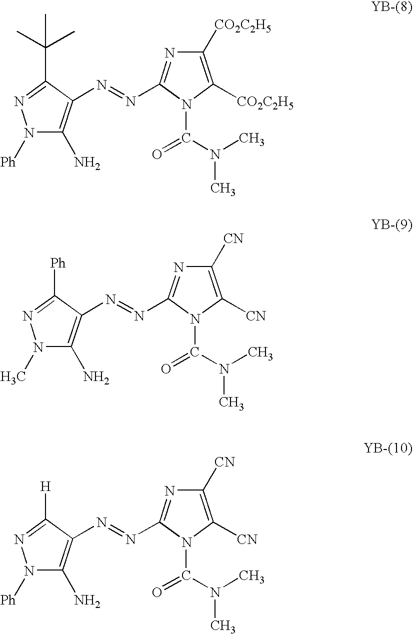

These azo dyes can be synthesized according to an ordinary diazo coupling, followed by acylation using acid chlorides.

Specifically these azo dyes can be easily synthesizes as follows: The amino group of a 2-aminoimidazole derivative represented by formula (2) set forth below is converted to a diazonium salt represented by formula (3) set forth below using a diazotizing agent. Said diazonium salt and a 2H-pyrazole-3-ylamine derivative represented by formula (4) set forth below are subjected to a coupling reaction to obtain a compound represented by formula (5) set forth below. Thereafter, the resultant compound represented by formula (5) is acylated with such a compound as represented by formula (6) set forth below.

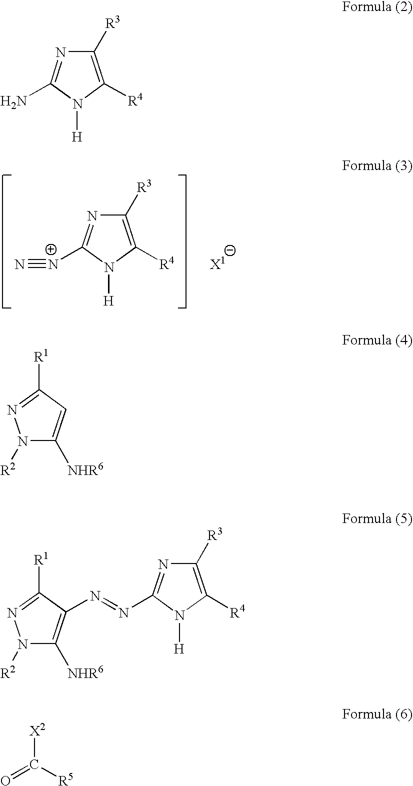

In the above-described formulae (2) to (6), R¹ to R⁶ each have the same meanings as R¹ to R⁶ of the above-described formula (YB). X¹ in formulae (3) is a counter anion of the diazonium salt. X² in formulae (6) represents a halogen atom.

Many of the compounds represented by formulae (2) to (6) are available on the market (for example, catalog Nos. 019-11005, 321-46045 manufactured by Waco Pure Chemical Industries). In addition, the compound represented by formula (4) may be synthesized in accordance with the method described in, for example, Bioorg. Med. Chem. Lett., vol. 12, p. 1559 (2000).

Next, the compound represented by formula (YA) is explained in detail.

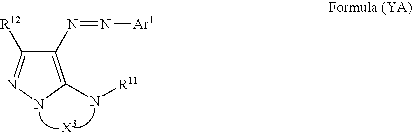

In formula (YA), R¹¹ represents a monovalent substituent; R¹² represents a hydrogen atom or a monovalent substituent; Ar¹ represents a group selected from the members of the heterocyclic group set (I) set forth below; and X³ represents atoms necessary to form a ring;

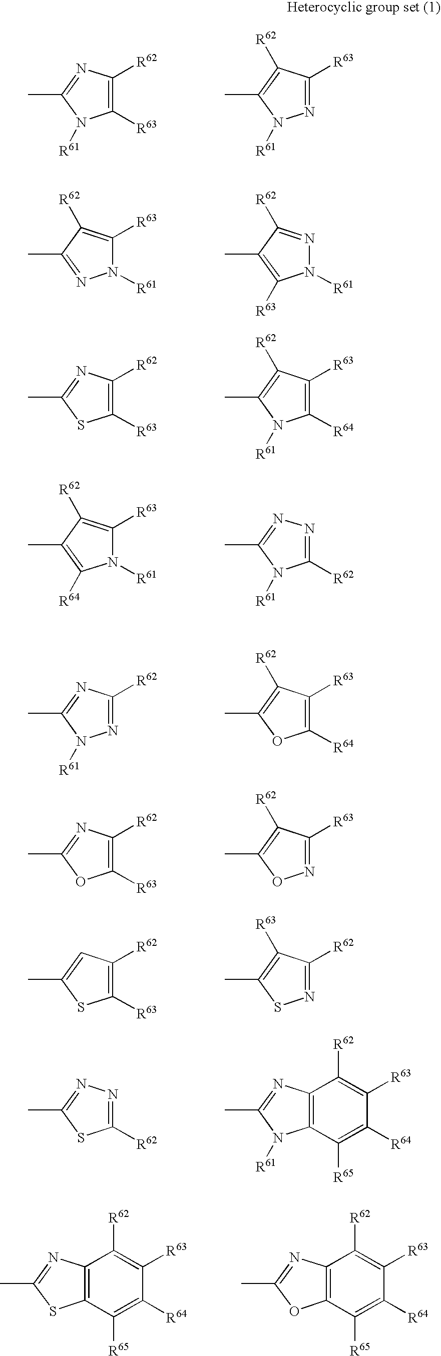

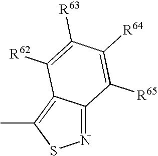

wherein, in the heterocyclic group set (I), R⁶¹, R⁶², R⁶³, R⁶⁴, and R⁶⁵ each independently represent a hydrogen atom or a substituent;

The azo dye represented by the above-described formula (YA) is characterized by the diazo component in addition to R¹¹ being a monovalent substituent. A high solubility is given to the azo dye by these characteristics, which results in preventing the dye from deposition in a heat-sensitive transfer ink sheet with the passage of time. As a result, such the problem of deposition with the passage of time can be settled, and at the same time an excellent light fastness is given to the azo dye by these characteristics.

In formula (YA), R¹¹ represents a monovalent substituent, and R¹² represents a hydrogen atom or a monovalent substituent. There is no particular limitation on the substituent. Representative examples of the substituent include a halogen atom, an alkyl group (the term “alkyl group” used in this specification means a saturated aliphatic group including a cycloalkyl group and a bicycloalkyl group), an alkenyl group (the term “alkenyl group” used in this specification means an unsaturated aliphatic group having a double bond, that includes a cycloalkenyl group and a bicycloalkenyl group), an alkynyl group, an aryl group, a heterocyclic group, a cyano group, an alkoxy group, an aryloxy group, an acyloxy group, a carbamoyloxy group, an alkoxycarbonyloxy group, an aryloxycarbonyloxy group, an amino group (including an alkylamino group, an anilino group, and a heterocyclic amino group), an acylamino group, an aminocarbonylamino group, an alkoxycarbonylamino group, an aryloxycarbonylamino group, a sulfamoylamino group, an alkyl- or aryl-sulfonylamino group, an alkylthio group, a sulfamoyl group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, and an imido group. Each of these may further be substituted.

Specific examples of the “monovalent substituent” represented by the above R¹¹ or R¹² are the same as those described in the “specific examples of the substituents” mentioned in the explanation of formula (YB).

In formula (YA), X³ represents atoms necessary to form a ring. There is no particular limitation to the atoms necessary to form a ring. Typical examples are atoms represented by —C(R¹³)═N—, —N═C(R¹³)—, —C(═O)—C(R¹³)═C(R¹⁴)—, or —C(═O)—N(R¹³)—C(═O)—, wherein R¹³ and R¹⁴ each independently represent a hydrogen atom or a substituent. Examples of the substituent are the same as examples of the substituent represented by R¹¹ and R¹².

In formula (YA), Ar¹ is a group selected from the above-described heterocyclic group set (I). With respect to each group of the set (I), R⁶¹, R⁶², R⁶³, R⁶⁴ and R⁶⁵ each independently represent a hydrogen atom or a substituent. Examples of the substituent are the same as examples of the substituent represented by R¹¹ and R¹².

R¹¹ is preferably a substituted or unsubstituted alkyl group having 1 to 4 carbon atoms, a substituted or unsubstituted aryl group, a substituted or unsubstituted heterocyclic group, or a substituted or unsubstituted acyl group; and more preferably an unsubstituted alkyl group having 1 to 4 carbon atoms.

R¹² is preferably a hydrogen atom, a substituted or unsubstituted alkyl group, a substituted or unsubstituted aryl group, a substituted or unsubstituted heterocyclic group, a substituted or unsubstituted amino group, a substituted or unsubstituted alkoxy group, or a hydroxy group; more preferably a substituted or unsubstituted alkyl group or a substituted or unsubstituted aryl group; further preferably a substituted or unsubstituted alkyl group; and particularly preferably a branched alkyl group.

X³ is preferably —C(R¹⁴)═N— or —N═C(R¹⁴)—.

With respect to each group of the heterocyclic group set (I), R⁶¹ is preferably a hydrogen atom, a substituted or unsubstituted alkyl group, a substituted or unsubstituted aryl group, or a substituted or unsubstituted heterocyclic group. More preferred are a substituted or unsubstituted alkyl group and a substituted or unsubstituted aryl group. R⁶², R⁶³, R⁶⁴, and R⁶⁵ each independently are preferably a hydrogen atom, a substituted or unsubstituted alkyl group, a substituted or unsubstituted alkenyl group, a substituted or unsubstituted aryl group, a substituted or unsubstituted heterocyclic group, a substituted or unsubstituted acyl group, a cyano group, a carbamoyl group, or an alkoxycarbonyl group; and more preferably a hydrogen atom, a substituted or unsubstituted alkyl group, a substituted or unsubstituted aryl group, a substituted or unsubstituted heterocyclic group, or a cyano group.

The following is an explanation about a preferable combination of various substituents (atoms) that a dye represented by formula (YA) may have: A preferred compound is a compound in which at least one of the substituents is the above-described preferable substituent. A more preferred compound is a compound in which more substituents are the above-described preferable substituents. The most preferred compound is a compound in which all substituents are the above-described preferable substituents. Specifically, a preferable example of the combination of the substituents is such the embodiment that R¹¹ is an unsubstituted alkyl group having 1 to 6 carbon atoms; R¹² is a substituted or unsubstituted alkyl group having 1 to 6 carbon atoms, or a substituted or unsubstituted aryl group; X³ is —C(R¹⁴)═N—, or —N═C(R¹⁴)—; and Ar¹ is a group selected from the above-described heterocyclic group set (I).

The molecular weight of the compound represented by formula (YA) is preferably 500 or less, and more preferably 450 or less, from a viewpoint of thermal diffusion.

Hereinafter, specific examples of the azo dye represented by formula (YA) according to the present invention will be shown, but the present invention is not limited thereto. In the specific examples, “Ph” represents a phenyl group (—C₆H₅).

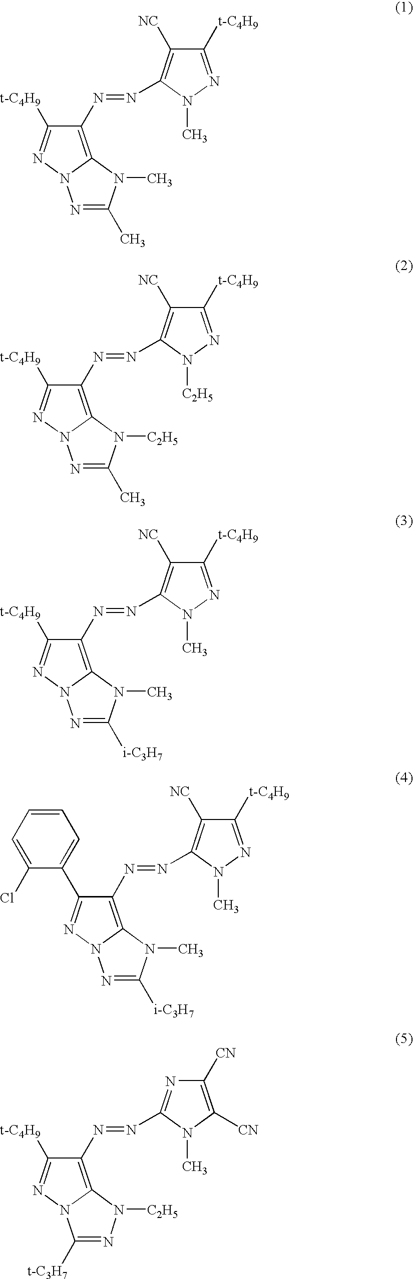

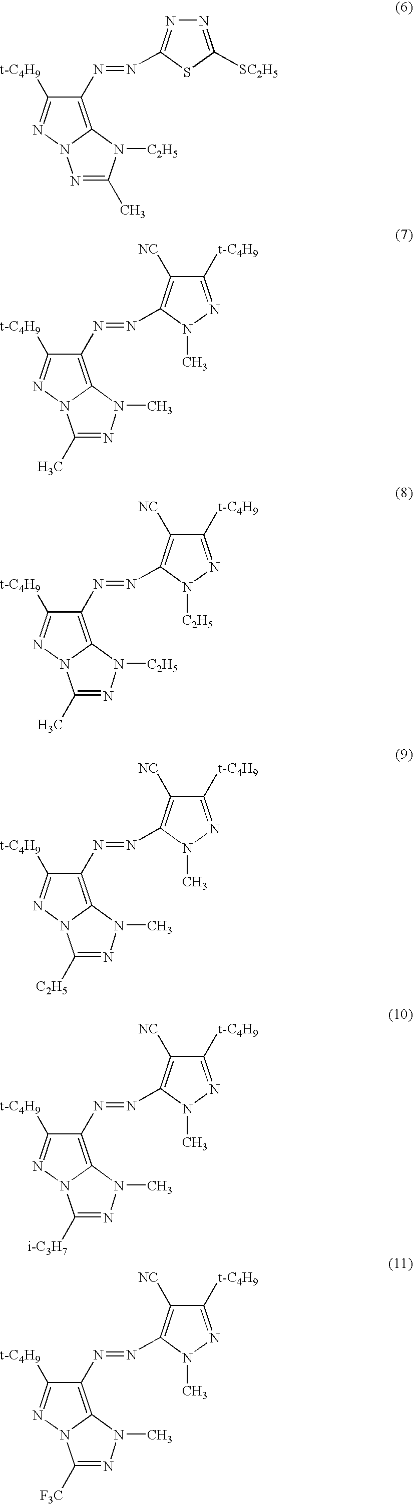

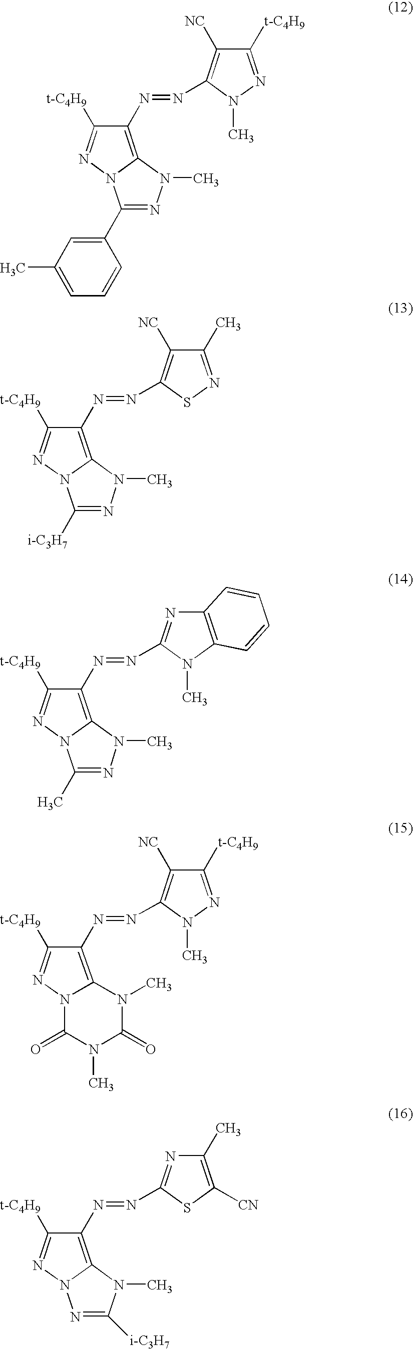

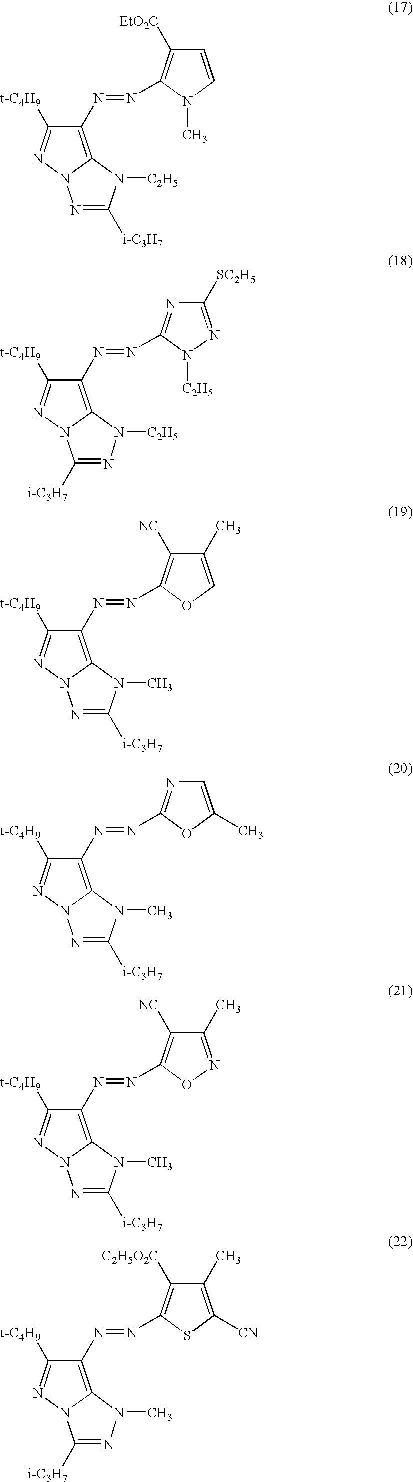

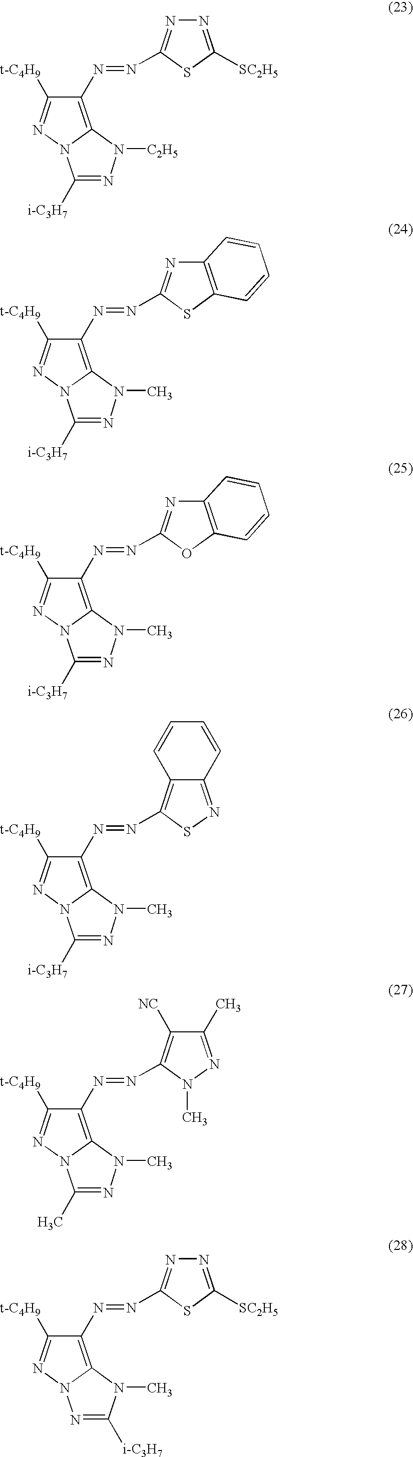

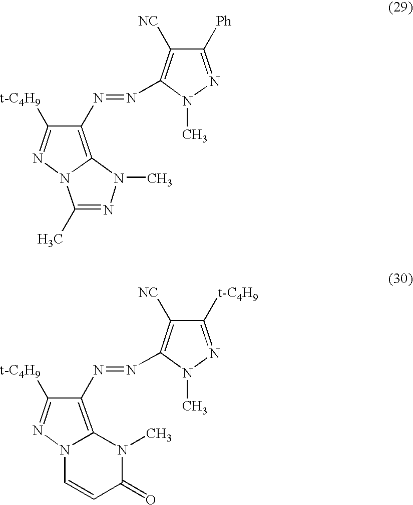

These compounds can be easily synthesized by diazo-coupling a diazonium salt obtained from a heterocyclic amino group represented by Ar¹ and a condensed heterocyclic compound.

The maximum absorption wavelength of the azo dye used in the present invention is preferably in the range of from 400 nm to 480 nm, more preferably from 420 nm to 460 nm.

Next, the compound represented by formula (YC) is explained in detail.

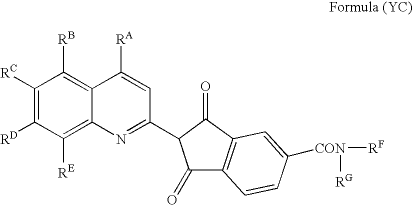

In formula (YC), R^{A}, R^{B}, R^{C}, R^{D} and R^{E} each independently represent a hydrogen atom, a halogen atom, an alkyl group having 1 to 8 carbon atoms, a cycloalkyl group, an alkoxy group, an alkoxyalkoxy group, an alkoxycarbonyl group, a thioalkoxy group, an alkylsulfonyl group, an amino group, a substituted or unsubstituted phenoxy group, or a substituted or unsubstituted thiophenoxy group. R^{F} and R^{G} each independently represent a hydrogen atom, an alkyl group, an alkoxyalkyl group, a cycloalkyl group, an allyl group, an optionally substituted aryl group, an aralkyl group, a furfuryl group, a tetrahydrofuryl group, a tetrahydrofurfuryl group, or a hydroxylalkyl group. These groups may further be substituted.

Specific examples of the dyes represented by formula (YC) are shown below. However, the preset invention should not be construed as being limited to the compounds set forth below.

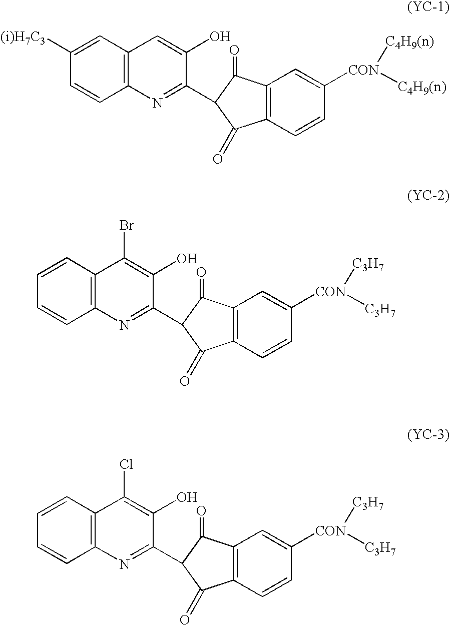

Next, the dye represented by formula (YD) is explained in detail.

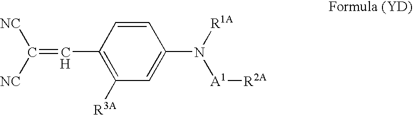

In formula (YD), R^{1A} represents an allyl group or an alkyl group; R^{2A} represents a substituted or unsubstituted alkyl or aryl group; A¹ represents —CH₂—, —CH₂CH₂—, —CH₂CH₂O—, —CH₂CH₂OCH₂—, or —CH₂CH₂OCH₂CH₂—; and R^{3A} represents an alkyl group. Each group may further be substituted.

Specific examples of the dye represented by formula (YD) are shown below. However, the present invention should not be construed as being limited to these compounds.

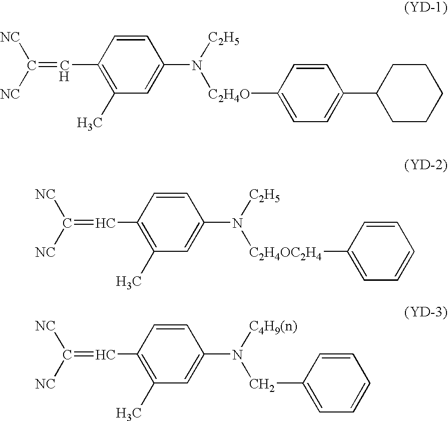

Next, the compound represented by formula (YE) is explained in detail.

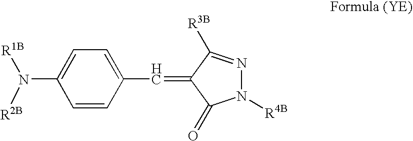

In formula (YE), R^{1B}, R^{2B}, R^{3B}, and R^{4B} each independently represent a hydrogen atom or a substituent.

In formula (YE), it is preferred that R^{1B} and R^{2B} each independently represent a hydrogen atom, an optionally substituted alkyl group, an allyl group, an optionally substituted aryl group, or an optionally substituted cycloalkyl group. R^{3B} represents a hydrogen atom, an optionally substituted alkyl group, a NR^{5C}R^{6C} group, an optionally substituted alkoxy group, an optionally substituted alkoxycarbony group, an optionally substituted aryl group, or a C(O)NR^{5D}R^{6D} group. R^{4B}, R^{5C}, R^{5D}, R^{6C} and R^{6D} each independently represent a hydrogen atom, an optionally substituted alkyl group, or an optionally substituted aryl group.

Specific examples of the dye represented by formula (YE) are shown below. However, the present invention should not be construed as being limited to these compounds.

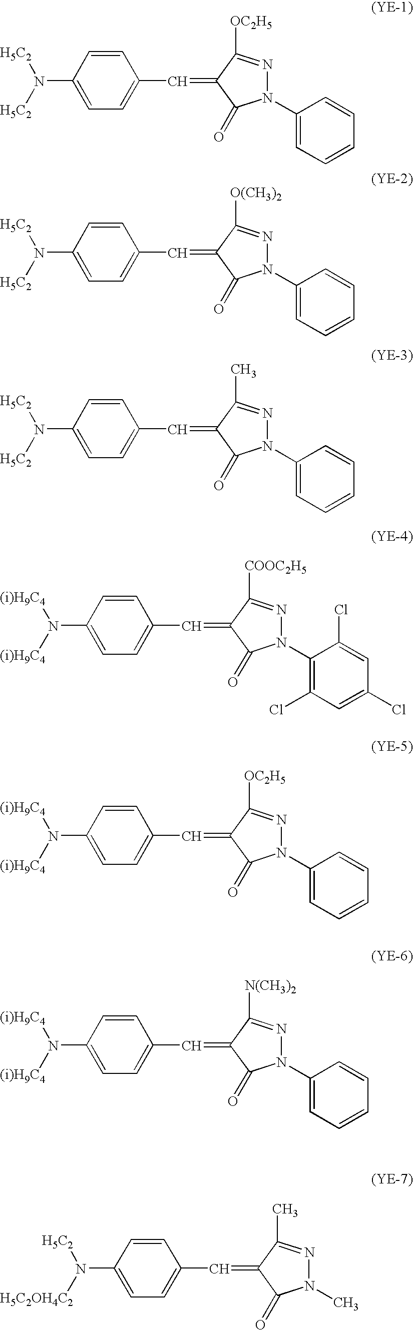

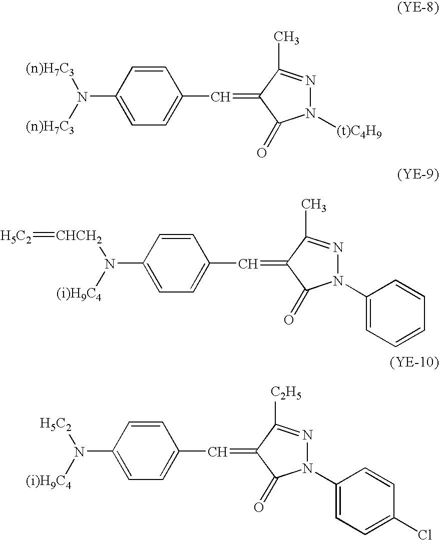

The dyes represented by formula (YC), (YD), or (YE) can be synthesized according to a known method.

Next, the compound represented by formula (C) is explained.

The compound represented by formula (C) is preferably a compound to be a cyan dye.

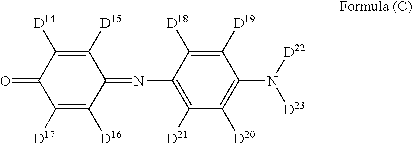

In formula (C), D¹⁴ to D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group or an amino group; D²² and D²³ each independently represent a hydrogen atom, an alkyl group or an aryl group; D²² and D²³ may be bonded together to form a ring; D¹⁹ and D²² and/or D²⁰ and D²³ may be bonded together to form a ring; and each of the above-mentioned groups may further be substituted.

D¹⁴ is preferably an acylamino group, a ureido group or an alkoxycarbonyl group, more preferably an acylamino group, or a ureido group, furthermore preferably an acylamino group, and most preferably a group represented by the following formula (IV).

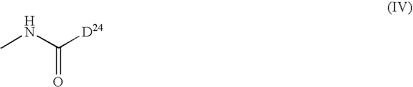

In formula (IV), D²⁴ is an alkyl group (preferably an alkyl group having 1 to 12 carbon atoms, e.g., methyl, ethyl, isopropyl, n-propyl, t-butyl), an aryl group (preferably an aryl group having 6 to 10 carbon atoms, e.g., phenyl, m-nitrophenyl, p-nitrophenyl, p-tolyl, p-methoxyphenyl, naphthyl, m-chlorophenyl, p-chlorophenyl) or a heterocyclic group (preferably a 5- to 8-membered heterocyclic group having 0 to 10 carbon atoms and containing, as a ring-constituting atom(s), a hetero atom selected from an oxygen atom, a nitrogen atom and a sulfur atom, e.g., pyridyl, furyl, tetrahydrofuryl). D²⁴ is preferably a heterocyclic group, and more preferably a pyridyl group, a furyl group, or a tetrahydrofuryl group.

D¹⁵, D¹⁶, D¹⁸, D¹⁹, D²⁰, and D²¹ each are preferably a hydrogen atom or an alkyl group (preferably an alkyl group having 1 to 12 carbon atoms, e.g., methyl, ethyl, isopropyl, n-propyl, t-butyl), and more preferably a hydrogen atom, a methyl group or an ethyl group. D¹⁷ is preferably a hydrogen atom, an alkyl group (preferably an alkyl group having 1 to 12 carbon atoms, e.g., methyl, ethyl, isopropyl, n-propyl, t-butyl), a halogen atom, a cyano group, a nitro group, or a heterocyclic group; and more preferably a hydrogen atom or a halogen atom. D²² and D²³ each are preferably a hydrogen atom or an alkyl group (preferably an alkyl group having 1 to 12 carbon atoms, e.g., methyl, ethyl, isopropyl, n-propyl, t-butyl), and more preferably a methyl group, an ethyl group or an n-propyl group. These alkyl groups may be substituted with another substituent. In the case that the alkyl group is substituted with another substituent, preferable examples of the “another” substituent include a heterocyclic group, a halogen atom, an alkoxy group, an aryloxy group, an amino group, an acyl group, a acyloxy group, an acylamino group, an alkylthio group, an arylthio group, a sulfonylamino group, a sulfonyl group, a sulfinyl group, a carbamoyl group, a sulfamoyl group, an alkoxycarbonyl group and an aryloxycarbonyl group, with more preferable example being a carbamoyl group. D²² and D²³ each are further preferably a hydrogen atom, a methyl group or an ethyl group.

Specific examples of the dye represented by formula (C) are shown below. However, the present invention should not be construed as being limited to these compounds.

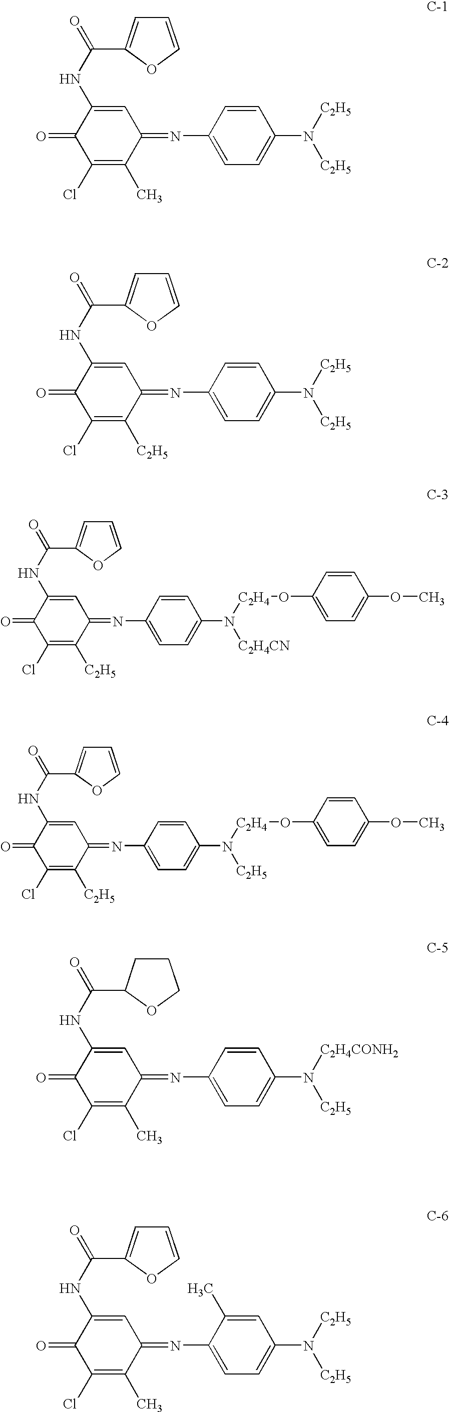

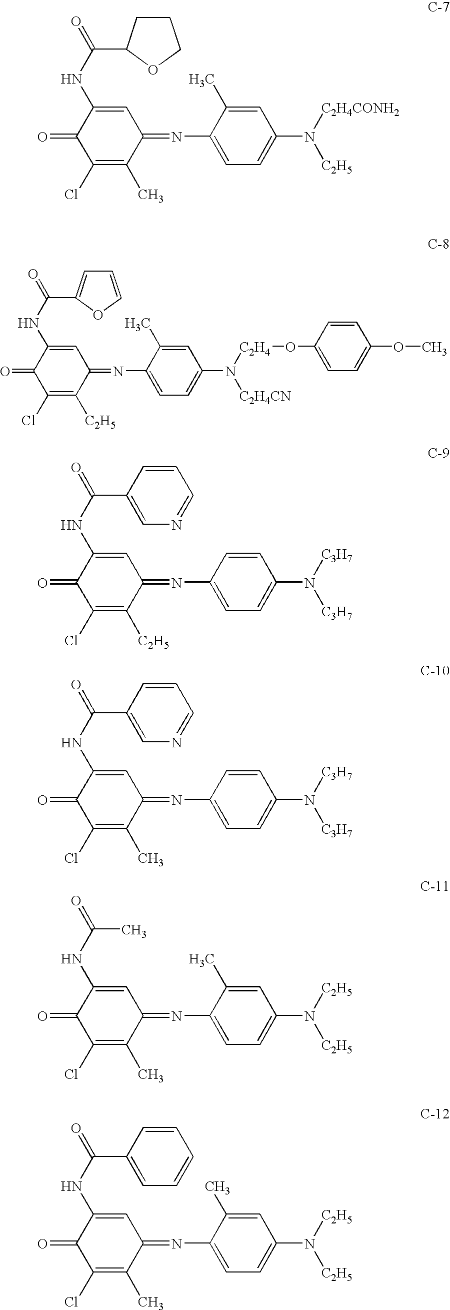

These dyes represented by formula (C) may be easily synthesized by or in accordance with the method described in JP-A-5-305776.

Next, the compound represented by formula (C1) is explained.

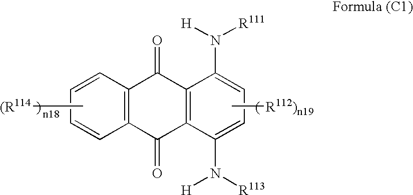

In formula (C1), R¹¹¹ and R¹¹³ each independently represent a hydrogen atom or a substituent; R¹¹² and R¹¹⁴ each independently represent a substituent; n18 represents an integer of 0 to 4; n19 represents an integer of 0 to 2; when n18 represents an integer of 2 to 4, R¹¹⁴s may be the same or different from each other; and when n19 represents 2, R¹¹²s may be the same or different from each other; and each of these groups may further be substituted. Specific examples of the “substituent” represented by the above R¹¹¹ to R¹¹⁴ are the same as those described in the “specific examples of the substituents” mentioned in the explanation of R¹, R², and R³ in formula (YB).

R¹¹¹ and R¹¹³ each independently are preferably a hydrogen atom, a substituted or unsubstituted alkyl group, a substituted or unsubstituted alkenyl group, a substituted or unsubstituted aryl group, and a substituted or unsubstituted heterocyclic group. R¹¹¹ and R¹¹³ each independently are more preferably a hydrogen atom, a substituted or unsubstituted alkyl group having 1 to 6 carbon atoms, or a substituted or unsubstituted aryl group.

R¹¹² and R¹¹⁴ each independently are preferably a halogen atom, an alkyl group, an alkenyl group, an alkynyl group, an aryl group, a heterocyclic group, a cyano group, an alkoxy group, an aryloxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, an alkyl- or aryl-sulfonylamino group, an alkylthio group, an sulfamoyl group, an alkyl- or aryl-sulfinyl group, an alkyl- or aryl-sulfonyl group, an acyl group, an aryloxycarbonyl group, an alkoxycarbonyl group, and a carbamoyl group. R¹¹² and R¹¹⁴ each independently are more preferably a halogen atom, an alkyl group, an alkenyl group, an aryl group, a heterocyclic group, an alkoxy group, an aryloxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, an alkylthio group, an acyl group, an aryloxycarbonyl group, an alkoxycarbonyl group, or carbamoyl group; further preferably a halogen atom, a substituted or unsubstituted alkyl group, a substituted or unsubstituted alkenyl group, a substituted or unsubstituted aryl group, or a substituted or unsubstituted heterocyclic group; and further more preferably a substituted or unsubstituted alkyl group.

Specific examples of the dye represented by formula (C1) are shown below. However, the present invention should not be construed as being limited to these compounds.

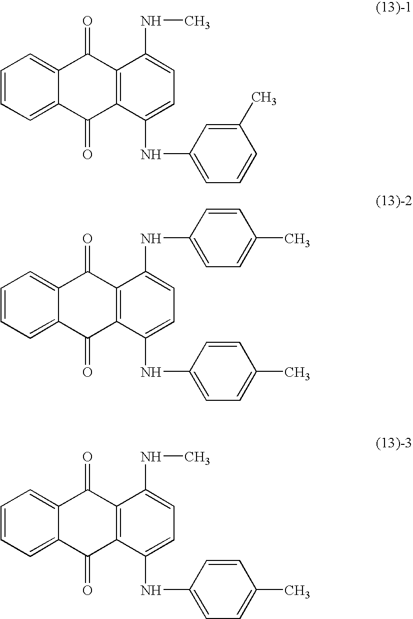

Among the dyes represented by the above-described formula (C1), those not available on the market can be synthesized according to the methods described in publications or specifications of U.S. Pat. Nos. 4,757,046 and 3,770,370, German Patent No. 2316755, JP-A-2004-51873, JP-A-7-137455, and JP-A-61-31292, and J. Chem. Soc. Perkin. Transfer 1, 2047 (1977), Merocyanine Dye-Doner Element Used in thermal Dye Transfer, authored by Champan.

In the following, magenta dyes will be explained.

First, magenta dyes represented by any one of formulas (M1) to (M4) will be explained.

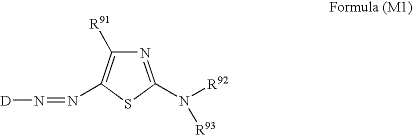

In formula (M1), R⁹¹ represents a hydrogen atom, a substituted or unsubstituted alkyl group, cycloalkyl group, aryl group, or heterocyclic group; R⁹² and R⁹³ each independently represent a hydrogen atom, a substituted or unsubstituted alkyl group, alkoxy group, cycloalkyl group, or aryl group; and D represents an optionally substituted aryl group or heterocyclic group.
A-N═N-E formula (M2)

In formula (M2), A represents an optionally substituted heterocyclic group wherein the heterocyclic ring is selected from a group consisting of imidazole, pyrazole, thiazole, benzothiazole, isothiazole, benzoisothiazole, and thiophene; and E represents an optionally substituted aminophenyl group, tetrahydroquinolinyl group, julolidyl group, or aminoquinolinyl group.

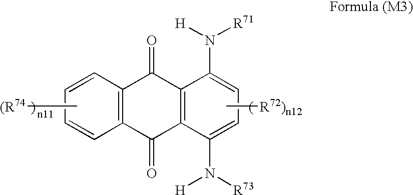

In formula (M3), R⁷¹ and R⁷³ each independently represent a hydrogen atom or a substituent; R⁷² and R⁷⁴ each independently represent a substituent; n11 represents an integer of 0 to 4; n12 represents an integer of 0 to 2; when n11 represents an integer of 2 to 4, R⁷⁴s may be the same or different from each other; and when n12 represents 2, R⁷²s may be the same or different from each other.

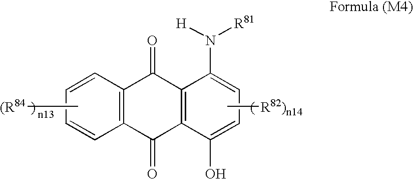

In formula (M4), R⁸¹ represents a hydrogen atom or a substituent; R⁸² and R⁸⁴ each independently represent a substituent; n13 represents an integer of 0 to 4; n14 represents an integer of 0 to 2; when n13 represents an integer of 2 to 4, R⁸⁴s may be the same or different from each other; and when n14 represents 2, R⁸²s may be the same or different from each other.

In the following, the compound represented by formula (M1) is explained in detail.

The compound represented by formula (M1) is preferably a compound to be a magenta dye.

In formula (M1), R⁹¹ represents a hydrogen atom, an alkyl group (preferably an alkyl group having 1 to 15 carbon atoms, which may have a phenyl or phenoxy group as a substituent), a cycloalkyl group (preferably a cyclohexyl group, which may further be substituted by any one of an alkyl group having 1 to 5 carbon atoms, an alkoxy group having 1 to 5 carbon atoms, and a halogen atom), an aryl group (preferably a phenyl group, which may further be substituted by any one of an alkyl group having 1 to 5 carbon atoms, an alkoxy group having 1 to 5 carbon atoms, a sulfonamido group and a halogen atom), or a heterocyclic group (preferably a thienyl group, a furanyl group or a pyridyl group, each of which may further be substituted by any one of an alkyl group having 1 to 5 carbon atoms, and a halogen atom). R⁹² and R⁹³ each represent a hydrogen atom, an alkyl group (preferably an alkyl group having 1 to 15 carbon atoms, which may be non-substituted or substituted with any one of a phenyl group, an alkylphenyl group wherein the alkyl moiety has 1 to 4 carbon atoms, an alkoxyphenyl group wherein the alkoxy moiety has 1 to 4 carbon atoms, a halogenated phenyl group, a benzyloxy group, an alkylbenzyloxy group wherein the alkyl moiety has 1 to 4 carbon atoms, an alkoxybenzyloxy group wherein the alkoxy moiety has 1 to 4 carbon atoms, a halogenated benzyloxy group, a halogen atom, a hydroxyl group, and a cyano group), an alkoxy group (preferably an alkoxy group having 1 to 15 carbon atoms, which is substituted with any one of a phenyl group, an alkylphenyl group whose alkyl moiety has 1 to 4 carbon atoms; an alkoxyphenyl group whose alkoxy moiety has 1 to 4 carbon atoms; a halogenated phenyl group, a benzyloxy group, an alkylbenzyloxy group whose alkyl moiety has 1 to 4 carbon atoms; an alkoxybenzyloxy group whose alkoxy moiety has 1 to 4 carbon atoms; a halogenated benzyloxy group, a halogen atom, a hydroxyl group, and a cyano group), a cycloalkyl group (preferably a cyclohexyl group, which may further be substituted by any one of an alkyl group having 1 to 15 carbon atoms, an alkoxy group having 1 to 15 carbon atoms, and a halogen atom), or an aryl group (preferably a phenyl group, which may further be substituted by an alkyl groups having 1 to 15 carbon atoms, an alkoxy group having 1 to 15 carbon atoms, a benzyloxy group, and a halogen atom). D represents an optionally substituted aryl group (preferably an aryl group having 6 to 20 carbon atoms, more preferably an optionally substituted phenyl group), or an optionally substituted heterocyclic group (preferably a 5- to 8-membered heterocyclic group containing oxygen, sulfur or nitrogen as a ring-forming atom; said hetero ring may be an aliphatic ring or an aromatic ring, and may be condensed; more preferred are aromatic heterocyclic groups).

Examples of the substituent with which each of the groups of D may be substituted include a halogen atom, a nitro group, a cyano group, an alkyl group, an alkoxy group, an oxycarbonyl group, a carbamoyl group, a sulfonyl group, and a sulfonamido group.

Preferable examples of D include an aniline derivative, an aminothiophene derivative, an aminobenzisothiazole derivative, an aminothiazole derivative, an aminoisothiazole derivative, an aminopyrrole derivative, and an aminoisothiadiazole derivative, each of which is non-substituted or substituted with a halogen atom, a nitro group, a cyano group, an alkyl group, an alkoxy group, an oxycarbonyl group, a carbamoyl group, a sulfonyl group, or a sulfonamido group.

Specific examples of the dye represented by formula (M1) are shown below. However, the present invention should not be construed as being limited to these compounds.

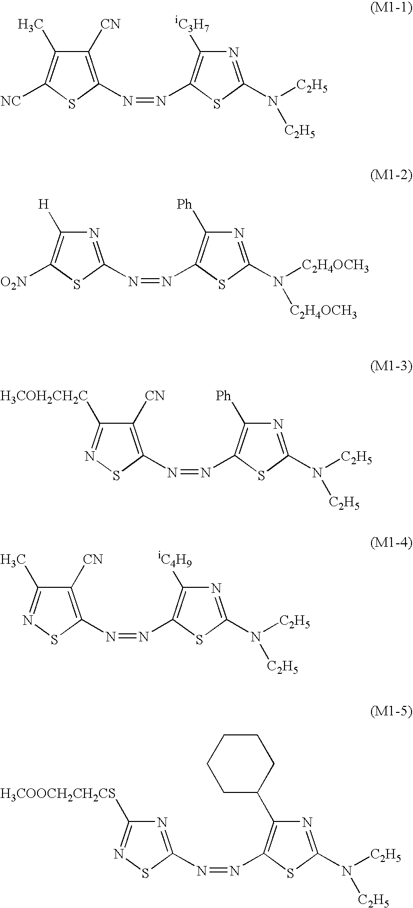

These dyes may be easily synthesized by or in accordance with the method described in “Rev. Prog. Coloration 17”, p. 72-85 (1987) or “Dyes and Pigments 3”, p. 81-121 (1982).

Next, the compound represented by formula (M2) is explained in detail.

The compound represented by formula (M2) is preferably a compound to be a magenta dye.

In formula (M2), A represents an optionally substituted heterocyclic group whose hetero ring is selected from imidazole, pyrrazole, thiazole, benzothiazole, isothiazole, benzoisothiazole, and thiophene. Preferred heterocyclic rings are an imidazoly group, a pyrazolyl group, a thiazolyl group, a benzothiazolyl group, an isothiazolyl group, a benzoisothiazolyl group, or a thienyl group, each of which may further be substituted.

Examples of the substituent with which the heterocyclic group represented by A may be substituted include a cyano group, a thiocyano group, a nitro group, a halogen atom, an alkyl group, an alkoxy group, a formyl group, an alkylthio group, an alkylsulfonyl group, an alkoxycarbonyl group, and an alkylcarbonyl group. Of these substituents, preferred are a cyano group, a thiocyano group, a cyanomethyl group, a nitro group, and methyl group.

E represents an optionally substituted aminophenyl group, tetrahydroquinolinyl group, yulolidyl group, or aminoquinolinyl group. Herein, the amino moiety in the aminophenyl group and the aminoquinolinyl group embraces an amino group and a substituted amino group. Examples of the substituent with which E may be substituted include an alkyl group, an alkenyl group, a cycloalkyl group, an aryl group, and a heterocyclic group.

E is preferably an aminophenyl group which is not substituted or substituted with an alkyl group, an alkoxy group, a carbamoyl group, or an alkoxycarbonyl group.

Specific examples of the compound represented by formula (M2) are shown below. However, the present invention should not be construed as being limited to these compounds.

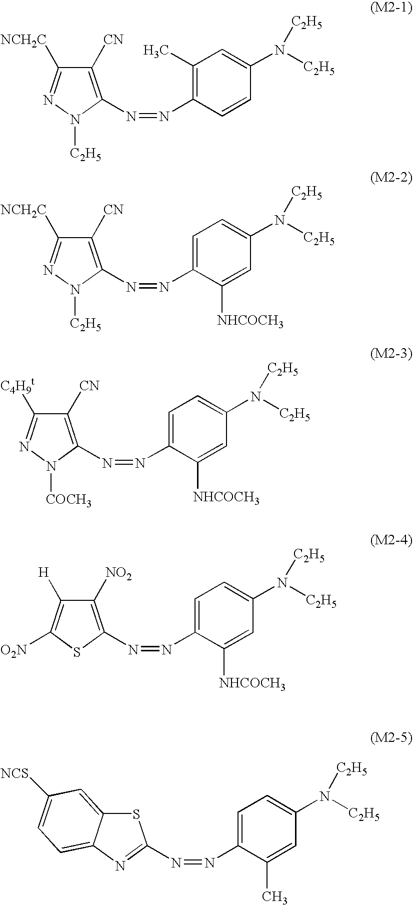

These dyes may be easily synthesized by or in accordance with the method described in JP-A-62-55194.

Next, the compound represented by formula (M3) or (M4) is explained in detail.

The compound represented by formula (M3) or (M4) is preferably a compound to be a magenta dye.

In formula (M3), R⁷¹ and R⁷³ each independently represent a hydrogen atom or a substituent; R⁷² and R⁷⁴ each independently represent a substituent; n11 represents an integer of 0 to 4; n12 represents an integer of 0 to 2; when n11 represents an integer of 2 to 4, R⁷⁴s may be the same or different from each other; and when n12 represents 2, R⁷²s may be the same or different from each other.

Examples of the substituents represented by R⁷¹ to R⁷⁴ include a halogen atom, an alkyl group (including a cycloalkyl group regardless of ring number), an alkenyl group (including a cycloalkenyl group regardless of ring number), an alkynyl group, an aryl group, a heterocyclic group, a cyano group, an alkoxy group, an aryloxy group, an acyloxy group, a carbamoyloxy group, an alkoxycarbonyloxy group, an aryloxycarbonyloxy group, an amino group (including an alkylamino group and an anilino group), an acylamino group, an aminocarbonylamino group, an alkoxycarbonylamino group, an aryloxycarbonylamino group, a sulfamoylamino group, an alkyl- or aryl-sulfonylamino group, an alkylthio group, an sulfamoyl group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, and an imido group. Each of the above-mentioned substituents may further be substituted.

R⁷¹ and R⁷³ each are preferably a hydrogen atom, a substituted or unsubstituted alkyl group, a substituted or unsubstituted alkenyl group, a substituted or unsubstituted aryl group, or a substituted or unsubstituted heterocyclic group; more preferably a hydrogen atom or a substituted or unsubstituted alkyl group, further preferably a hydrogen atom or a substituted or unsubstituted alkyl group having 1 to 6 carbon atoms, and still furthermore preferably a hydrogen atom.

R⁷² and R⁷⁴ each independently represent a halogen atom, an alkyl group, an alkenyl group, an alkynyl group, an aryl group, a heterocyclic group, a cyano group, an alkoxy group, an aryloxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, an alkyl- or aryl-sulfonylamino group, an alkylthio group, an sulfamoyl group, an alkyl- or aryl-sulfinyl group, an alkyl- or aryl-sulfonyl group, an acyl group, an aryloxycarbonyl group, an alkoxycarbonyl group or a carbamoyl group; more preferably an alkoxy group, an aryloxy group, an acyloxy group, a carbamoyloxy group, an alkoxycarbonyloxy group, or an aryloxycarbonyloxy group; further preferably an alkoxy group or an aryloxy group. Each of the above-mentioned substituents may further be substituted.

In formula (M4), R⁸¹ represents a hydrogen atom or a substituent, R⁸² and R⁸⁴ each independently represent a substituent, n13 represents an integer of 0 to 4, and n14 represents an integer of 0 to 2. When n13 represents an integer of 2 to 4, R⁸⁴s may be the same or different from each other. When n14 represents 2, R⁸²s may be the same or different from each other. Examples of the substituents each represented by R⁸¹, R⁸² and R⁸⁴ include those given as examples of the substituent each represented by R⁷¹ to R⁷⁴ set forth above.

Examples of the substituent represented by R⁸¹ include those given as examples of the substituents as described about R⁷¹ and R⁷³, and preferable examples thereof are also same. R⁸¹ is more preferably a hydrogen atom or a substituted or unsubstituted alkyl group having 1 to 6 carbon atoms, and further preferably a hydrogen atom.

Examples of the substituent represented by R⁸² and R⁸⁴ include those given as examples of the substituent as described about R⁷² and R⁷⁴. R⁸² and R⁸⁴ each independently are more preferably an alkoxy group, an aryloxy group, an acyloxy group, a carbamoyloxy group, an alkoxycarbonyloxy group and an aryloxycarbonyloxy group; and further preferably an alkoxy group and an aryloxy group. Each of these groups may be further substituted.

The following is an explanation about a preferable combination of various substituents (atoms) that a dye represented by formula (M3) or (M4) may have: A preferred compound is a compound in which at least one of the substituents is the above-described preferable substituent. A more preferred compound is a compound in which more substituents are the above-described preferable substituents. The most preferred compound is a compound in which all substituents are the above-described preferable substituents.

In the compound represented by formula (M3), it is preferable that R⁷¹ is a hydrogen atom, R⁷² is an aryloxy group, R⁷³ is a hydrogen atom, n11 is an integer of 0, and n12 is an integer of 0 to 2. It is more preferable that R⁷¹ is a hydrogen atom, R⁷² is an aryloxy group, R⁷³ is a hydrogen atom, n11 is integer of 0, and n12 is an integer of 2.

In the compound represented by formula (M4), it is preferable that R⁸¹ is a hydrogen atom, R⁸² is an aryloxy group, n13 is an integer of 1 to 2, and n14 is an integer of 0. It is more preferable that R⁸¹ is a hydrogen atom, R⁸² is an aryloxy group, n13 is an integer of 1, and n14 is an integer of 0. It is further preferable that R⁸¹ is a hydrogen atom, R⁸² is an aryloxy group, n13 is an integer of 1, n14 is an integer of 0, and said R⁸² is positioned at ortho-site to the amino group.

Specific examples of the dye represented by formula (M3) or (M4) are shown below. However, the present invention should not be construed as being limited to these compounds.

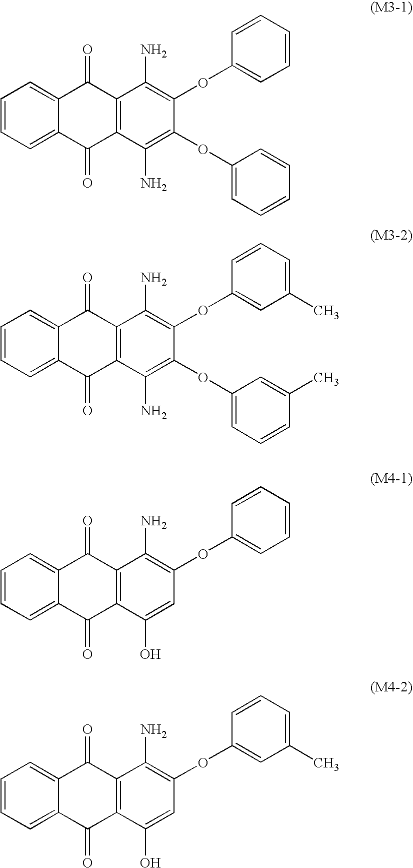

Next, the dye represented by formula (M) is explained.

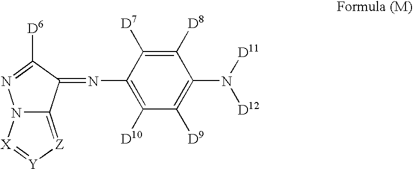

In formula (M), D⁶, D⁷, D⁸, D⁹, and D¹⁰ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D¹¹ and D¹² each independently represent a hydrogen atom, an alkyl group, or an aryl group; D¹¹ and D¹² may be bonded together to form a ring; D⁸ and D¹¹ and/or D⁹ and D¹² may be bonded together to form a ring; X, Y, and Z each independently represent ═C(D¹³)- or a nitrogen atom, in which D¹³ represents a hydrogen atom, an alkyl group, an aryl group, an alkoxy group, an aryloxy group, or an amino group; when X and Y each represents —C(D¹³)- or Y and Z each represents ═C(D¹³)-, two D¹³s may be bonded together to form a saturated or unsaturated carbon ring; and each of the above-mentioned groups may further be substituted.

The compound represented by formula (M) is preferably a compound to be a magenta dye.

D⁶ to D¹⁰ each independently represent a hydrogen atom, a halogen atom (e.g., a chlorine atom, a bromine atom, a fluorine atom), an alkyl group (preferably an alkyl group having 1 to 12 carbon atoms, e.g., methyl, ethyl, isopropyl, n-propyl and t-butyl), an alkoxy group (preferably an alkoxy group having 1 to 12 carbon atoms, e.g., methoxy, butoxy, octyloxy, dodecyloxy), an aryl group (preferably an aryl group having 6 to 10 carbon atoms, e.g., phenyl, m-nitrophenyl, p-nitrophenyl, p-tolyl, naphthyl), an aryloxy group (preferably an aryloxy group having 6 to 10 carbon atoms, e.g., phenyloxy, m-nitrophenyloxy, p-nitrophenyloxy, p-tolyloxy, naphthyloxy), a cyano group, an acylamino group (preferably an acylamino group having 1 to 12 carbon atoms, e.g., formylamino, acetylamino, butylcarbonylamino, octylcarbonylamino), a sulfonylamino group (preferably a sulfonylamino group having 1 to 12 carbon atoms, e.g., methane sulfonamido, butane sulfonamido, octane sulfonamido, benzene sulfonamido, toluene sulfonamido), a ureido group (preferably a ureido group having 1 to 12 carbon atoms, e.g., N-methylureido, N,N-dimethylureido, N-phenylureido, N-methyl-N-phenylureido, N-octylureido), an alkoxycarbonylamino group (preferably an alkoxycarbonylamino group having 2 to 12 carbon atoms, e.g., methoxycarbonylamino, ethoxycarbonylamino, isopropoxycarbonylamino, n-octyloxycarbonylamino), an alkylthio group (preferably an alkylthio group having 1 to 12 carbon atoms, e.g., methylthio, ethylthio, butylthio, octylthio, isobutylthio, t-octylthio), an arylthio group (preferably an arylthio group having 6 to 10 carbon atoms, e.g., phenylthio, naphthylthio), an alkoxycarbonyl group (preferably an alkoxycarbonyl group having 2 to 12 carbon atoms, e.g., methoxycarbonyl, ethoxycarbonyl, isopropoxycarbonyl, n-octyloxycarbonyl), a carbamoyl group (preferably a carbamoyl group having 1 to 12 carbon atoms, e.g., N-methyl carbamoyl, N,N-dimethyl carbamoyl, N-phenylcarbamoyl, N-butyl-N-phenylcarbamoyl), a sulfamoyl group (preferably a sulfamoyl group having 1 to 12 carbon atoms, e.g., N-methyl sulfamoyl, N-phenylsulfamoyl, N-ethyl-N-phenyl sulfamoyl), a sulfonyl group (preferably a sulfonyl group having 1 to 12 carbon atoms, e.g., methylsulfonyl, butylsulfonyl, benzenesulfonyl, toluenesulfonyl), an acyl group (preferably an acyl group having 1 to 12 carbon atoms, e.g., formyl, acetyl, lauroyl), or an amino group (preferably an amino group having 0 to 12 carbon atoms, e.g., amino, methylamino, phenylamino, N-methyl-N-phenylamino, octylamino).

D¹¹ and D¹² each independently represent a hydrogen atom, an alkyl group (preferably an alkyl group having 1 to 12 carbon atoms, e.g., methyl, ethyl, isopropyl, n-propyl and t-butyl), an alkoxy group (preferably an alkoxy group having 1 to 12 carbon atoms, e.g., methoxy, butoxy, octyloxy, dodecyloxy), or an aryl group (preferably an aryl group having 6 to 10 carbon atoms, e.g., phenyl, m-nitrophenyl, p-nitrophenyl, p-tolyl, naphthyl). D¹¹ and D¹² may be bonded together to form a ring.

D⁸ and D¹¹ and/or D⁹ and D¹² may be bonded together to form a ring.

Further, each of these groups may further be substituted, and examples of such the substituent are the aforementioned groups.

X, Y, and Z each represents ═C(D¹³)- or a nitrogen atom. D¹³ represents a hydrogen atom, an alkyl group (preferably an alkyl group having 1 to 12 carbon atoms, e.g., methyl, ethyl, isopropyl, n-propyl and t-butyl), an aryl group (preferably an aryl group having 6 to 10 carbon atoms, e.g., phenyl, m-nitrophenyl, p-nitrophenyl, p-tolyl, naphthyl), an alkoxy group (preferably an alkoxy group having 1 to 12 carbon atoms, e.g., methoxy, butoxy, octyloxy, dodecyloxy), an aryloxy group (preferably an aryloxy group having 6 to 10 carbon atoms, e.g., phenyloxy, m-nitrophenyloxy, p-nitrophenyloxy, p-tolyloxy, naphthyloxy), or an amino group (preferably an amino group having 0 to 12 carbon atoms, e.g., amino, methylamino, phenylamino, N-methyl-N-phenylamino, octylamino). In the case that both X and Y represents ═C(D¹³)-, or both Y and Z represents ═C(D¹³)-, two D¹³s may be bonded together to form a saturated or unsaturated carbon ring. The above-described groups may be further substituted. Examples of the substituent include a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, a heterocyclic group, a sulfo group, a carboxyl group, a hydroxyl group and an amino group.

D⁶ is preferably an alkyl group (preferably an alkyl group having 1 to 12 carbon atoms, e.g., methyl, ethyl, isopropyl, n-propyl, t-butyl) or an aryl group (preferably an aryl group having 6 to 10 carbon atoms, e.g., phenyl, m-nitrophenyl, p-nitrophenyl, p-tolyl, naphthyl, m-chlorophenyl, p-chlorophenyl), and more preferably an aryl group (preferably an aryl group having 6 to 10 carbon atoms, e.g., phenyl, m-nitrophenyl, p-nitrophenyl, p-tolyl, naphthyl, m-chlorophenyl, p-chlorophenyl).

D⁷ to D¹⁰ each independently are preferably a hydrogen atom or an alkyl group (preferably an alkyl group having 1 to 12 carbon atoms, e.g., methyl, ethyl, isopropyl, n-propyl and t-butyl), more preferably a hydrogen atom or an alkyl group having 1 to 3 carbon atoms. These groups may be further substituted.

D¹¹ is preferably an alkyl group having 3 to 6 carbon atoms, which is unsubstituted or substituted with any of an alkyl group, an alkoxy group, a nitro group and a cyano group; and more preferably an unsubstituted alkyl group having 3 to 6 carbon atoms, or an alkyl group having 3 to 6 carbon atoms substituted with a cyano group.

D¹² preferably has a structure represented by formula (II) or (III).

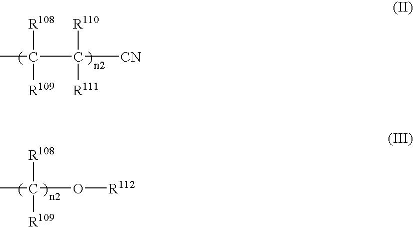

In formulas (II) and (III), R¹⁰⁸, R¹⁰⁹, R¹¹⁰, and R¹¹¹ each independently represent a hydrogen atom, an alkyl group, an aryl group, a heterocyclic group, a halogen atom, an alkoxy group, an aryloxy group, an amino group, an acyl group, an acyloxy group, an acylamino group, an alkylthio group, an arylthio group, a sulfonylamino group, a sulfonyl group, a sulfinyl group, a carbamoyl group, a sulfamoyl group, alkoxycarbonyl group, or an aryloxycarbonyl group. Among these, preferred groups are a hydrogen atom and an alkyl group (preferably an alkyl group having 1 to 12 carbon atoms, e.g., methyl, ethyl, isopropyl, n-propyl, t-butyl), and more preferred groups are a hydrogen atom, a methyl group and an ethyl group. R¹¹² represents a hydrogen atom, an alkyl group, an aryl group, a heterocyclic group, a halogen atom, an alkoxy group, an aryloxy group, an amino group, an acyl group, an acyloxy group, an acylamino group, an alkylthio group, an arylthio group, a sulfonylamino group, a sulfonyl group, a sulfinyl group, a carbamoyl group, a sulfamoyl group, alkoxycarbonyl group, or an aryloxycarbonyl group. A preferred group is an aryl group (preferably an aryl group having 6 to 10 carbon atoms, e.g., phenyl, m-nitrophenyl, p-nitrophenyl, p-tolyl, p-methoxyphenyl, naphthyl, m-chlorophenyl, p-chlorophenyl). n2 represents from 1 to 5, preferably from 1 to 3.

In the case where n2 is 2 or more, a plurality of R¹⁰⁸, R¹⁰⁹, R¹¹⁰, and R¹¹¹ may be the same or different from each other, respectively.

Of the combination of X, Y, and Z, it is more preferred that X and Z are each a nitrogen atom, and Y is ═C(D¹³)-. Further, each of the above-described groups may have a substituent.

Among the compounds represented by formula (M), compounds represented by formula (MB) are preferable.

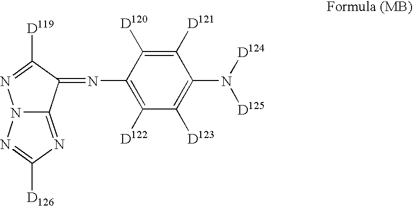

In formula (MB), D¹⁹, D¹²⁰, D¹²¹, D¹²² and D¹²³ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D¹²⁴ and D¹²⁵ each independently represent a hydrogen atom, an alkyl group or an aryl group; D¹²⁴ and D¹²⁵ may be bonded together to form a ring; D121 and D¹²⁴ and/or D¹²³ and D¹²⁵ may be bonded together to form a ring; and D¹²⁶ represents a hydrogen atom, an alkyl group, an aryl group, an alkoxy group, an aryloxy group or an amino group. Each of the above-mentioned groups may be further substituted.

Specific examples of the dye represented by formula (M) are shown below. However, the present invention should not be construed as being limited to these compounds.

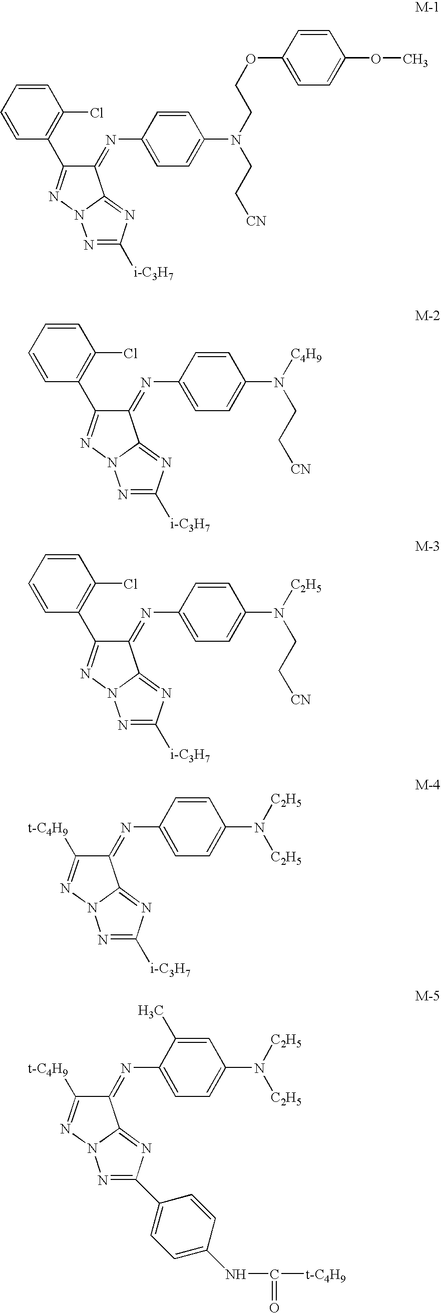

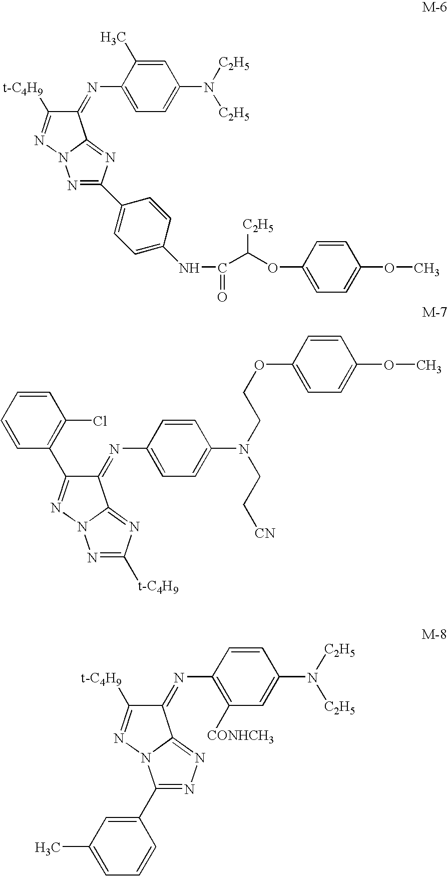

These compounds may be easily synthesized by or in accordance with the method described in JP-A-5-286268.

Each of these compounds represented by formula (Y), (YA) to (YE), (C1), (C), (M), or (M1) to (M4) is preferably contained in the heat transfer layer (dye layer) in an amount of 10 to 90% by mass, and more preferably 20 to 80% by mass.

A coating amount of the heat transfer layer (dye layer) in the heat-sensitive transfer sheet (ink sheet) is preferably in the range of 0.1 to 1.0 g/m² (in solid content equivalent), and more preferably in the range of 0.15 to 0.60 g/m². Hereinafter, the term “coating amount” used herein is expressed by a solid content equivalent value, unless it is indicated differently in particular.

A film thickness of the heat transfer layer is preferably in the range of 0.1 to 2.0 μm, and more preferably in the range of 0.1 to 1.0 μm.

As a support for the heat-sensitive transfer sheet, use may be made of the same as those for use in the heat-sensitive transfer image-receiving sheet, for example, polyethyleneterephthalate.

A thickness of the support is preferably in the range of 1 to 100 μm, more preferably in the range of 1 to 10 μm, further more preferably in the range of 2 to 10 μm, and especially preferably in the range of 3 to 10 μm.

With respect to the heat-sensitive transfer sheet, there is a detailed explanation in, for example, JP-A-11-105437. The description in paragraph Nos. 0017 to 0078 of JP-A-11-105437 is incorporated by reference into the specification of the present application.

(3) Heat Transferable Protective Layer

A preferable embodiment of the present invention, particularly in the first embodiment thereof, is that a heat transferable protective layer is disposed on the above-described heat-sensitive transfer sheet. The following is an explanation of the heat transferable protective layer.

(Fundamental Composition)

The heat transferable protective layer (hereinafter also referred to as “a heat-sensitive transfer cover film”) is a heat-sensitive transfer cover film having a substrate and a transparent resin layer disposed thereon so that the transparent resin layer can be detached, and further a heat-sensitive adhesive layer disposed on the transparent resin layer. The heat-sensitive adhesive layer is preferably composed of a resin having a glass transition temperature of from 40° C. to 75° C. A release layer may be disposed between the substrate film and the transparent resin layer so as to reduce adhesion properties between the transparent resin layer and the substrate, thereby to make it easier to transfer the transparent resin layer. Further, a back layer may be disposed on the back side of the above-described substrate film to prevent a thermal head of a printer from sticking. As the substrate, the same materials as described above with respect to the heat-sensitive transfer sheet can be preferably used.

(Transparent Resin Layer)

The transparent resin layer disposed on the substrate may be composed of various kinds of resins that are excellent in abrasion resistance, chemical resistance, transparency, hardness and the like. Examples of the resin include polyester resins, polystyrene resins, acrylic resins, polyurethane resins, acrylurethane resins, silicone-modified resins of each of these resins, and a mixture of each of these resins. These resins are excellent in transparency, but tend to form a relatively stiff coating. Consequently, a so-called “film-off” at the time of transfer is not enough. Therefore, to these transparent resin layers, fine particles or wax having a high transparency, such as silica, alumina, calcium carbonate, and plastic pigments may be added in such an amount that transparency of the resin is not substantially degraded.

As a method of forming a transparent resin layer on a substrate, or on a previously formed release layer disposed on the substrate, there are various methods such as gravure coat, gravure reverse coat, roll coat, and a method of coating and drying an ink containing the above-described resin. A thickness of the transparent resin layer is preferably from 0.1 μm to about 20 μm.

At the time of forming the above-described transparent resin layer, various additives may be contained in said transparent resin layer. The additives are exemplified by a sliding agent, a ultraviolet absorbing agent, an antioxidant and/or a fluorescent whitening agent. Addition of these additives enables to improve properties such as scratch resistance, gloss, light resistance, weather resistance and whiteness of various kinds of images to be laminated with the transparent resin layer.

(Release Layer)

The release layer that may be formed on the substrate prior to formation of the above-described transparent resin layer, is preferably formed of release agents such as waxes, silicone waxes, silicone resins, fluorine resins, and acryl resins. The release layer may be formed in the same manner as the method of forming the above-described transparent resin layer. As a thickness of the release layer, a thickness in a range of from 0.05 μm to about 5 μm is generally sufficient. Further, in the case where it is preferred to dispose a matte protective layer after transfer, the surface can be made matte by incorporating various particles in a release layer or by using a substrate film having a matte processed surface on the same side as the release layer.

(Heat-Sensitive Adhesive Layer)

In order to improve transfer properties of the transparent resin layer and so on, a heat-sensitive adhesive layer is also disposed on the surface of said transparent resin layer. An ultraviolet absorbing agent is preferably contained in the heat-sensitive adhesive layer. The heat-sensitive adhesive layer is formed by coating and drying a solution of a thermoplastic resin that has Tg of preferably from 40° C. to 75° C., more preferably from 60° C. to 70° C. and that is excellent in adhesiveness when heated, such as acrylic resins, polyvinylchloride resins, polyvinyl acetate resins, vinyl chloride-vinyl acetate copolymer resins and polyester resins. The heat-sensitive adhesive layer is preferably formed so as to become a thickness of from 0.1 μm to about 100 m.

If the Tg value of the heat-sensitive adhesive layer is too low, adhesion properties between a transparent resin layer and an image laminated with the transparent resin layer sometimes becomes insufficient. Besides, in the case where the formed image is used at a relatively high temperature, fine cracks can sometimes generate in the transparent resin layer owing to softening of the adhesive layer, resulting in degradation of chemical resistance, particularly resistance to plasticizer. In contrast, if the Tg value of the heat-sensitive adhesive layer is too high, heating by a thermal head can sometimes be insufficient to give satisfactory transfer of the transparent protective layer; and “foil-off” properties (i.e. easiness of removing) of the transparent resin layer can sometimes degrade, resulting in difficulty of transfer with a good resolution.

Further, of the above-described heat-sensitive adhesives, especially preferred are polyvinylchloride resins, polyvinyl acetate resins, and vinyl chloride-vinyl acetate copolymer resins, each of which has a polymerization degree of from 50 to 300, more preferably from 50 to 250. If the polymerization degree is too low, there are sometimes caused the same disadvantages as the case where the Tg value is too low. In contrast, if the polymerization degree is too high, there are sometimes caused the same disadvantages as the case where the Tg value is too high.

The above description is of a composition of the heat-sensitive transfer cover film preferably used in the present invention, particularly in the first embodiment thereof. As a matter of cause, the transparent resin layer of the heat-sensitive transfer cover film may be disposed solely on a substrate, or may be disposed in a state where the transparent resin layer and the dye layers containing respective diffusion transfer dyes according to the present invention are sequentially arranged in the longitudinal direction on the same support. In the latter case, the heat-sensitive transfer cover film becomes a part of the heat-sensitive transfer sheet according to the present invention.

<Ultraviolet Absorber>

In the present invention, particularly in the first embodiment thereof, a more preferable embodiment of the heat-sensitive transfer cover film is that the heat-sensitive transfer cover film has an absorption in a near ultraviolet region of the wavelength ranging from 330 nm to 370 nm. This can be accomplished by introducing an ultraviolet absorbing agent in a heat-sensitive transfer cover film.

The following explanation is of the ultraviolet absorbing agents preferably used in the present invention, particularly in the first embodiment of the present invention.

As the ultraviolet absorber, compounds having various ultraviolet absorber skeletons, which are widely used in the field of information recording, may be used. Specific examples of the ultraviolet absorber may include compounds having a 2-hydroxybenzotriazole type ultraviolet absorber skeleton, 2-hydroxybenzotriazine type ultraviolet absorber skeleton, or 2-hydroxybenzophenon type ultraviolet absorber skeleton. Compounds having a benzotriazole-type or triazine-type skeleton are preferable from the viewpoint of ultraviolet absorbing ability (absorption coefficient) and stability, and compounds having a benzotriazole-type or benzophenone-type skeleton are preferable from the viewpoint of obtaining a higher-molecular weight and using in a form of a latex. Specifically, ultraviolet absorbers described in, for example, JP-A-2004-361936 may be used.

The ultraviolet absorber preferably absorbs light at wavelengths in the ultraviolet region, and the absorption edge of the absorption of the ultraviolet absorber is preferably out of the visible region. Specifically, after addition of the ultraviolet absorbing agent to a receptor layer so as to form a heat-sensitive transfer image-receiving sheet, it is preferred that the resultant heat-sensitive transfer image-receiving sheet has the maximum absorption in the wavelength region of from 330 nm to 370 nm and has an absorption density Abs of 0.8 or more at the maximum absorption wavelength, more preferably has an absorption density Abs of 0.5 or more at 380 nm. Also, the heat-sensitive transfer image-receiving sheet has an absorption density of, preferably, Abs 0.1 or less at 400 nm. If the absorption density at a wavelength range exceeding 400 nm is high, it is not preferable because an image is made yellowish.

In the present invention, preferably in the first embodiment of the present invention, the ultraviolet absorber may be made to have a higher molecular weight. In this case, the ultraviolet absorber has a mass average molecular weight of preferably 10,000 or more, and more preferably 100,000 or more. As a means of obtaining a higher-molecular weight ultraviolet absorber, it is preferable to graft an ultraviolet absorber on a polymer. The polymer as the principal chain preferably has a polymer skeleton less capable of being dyed than the receptor polymer to be used together. Also, when the polymer is used to form a film, the film preferably has sufficient film strength. The graft ratio of the ultraviolet absorber to the polymer principal chain is preferably 5 to 20% by mass and more preferably 8 to 15% by mass.

Also, the polymer containing a unit having ultraviolet absorbing ability (ultraviolet absorber unit) may be made to be used in a form of a latex. When the polymer is made to be used in a form of a latex, an aqueous dispersion-system coating solution may be used in application and coating to form the receptor layer, and this enables reduction of production cost. As a method of making the latex polymer (or making the polymer latex-wise), a method described in, for example, Japanese Patent No. 3450339 may be used. As the ultraviolet absorber to be used in a form of a latex, the following commercially available ultraviolet absorbers may be used which include ULS-700, ULS-1700, ULS-1383MA, ULS-1635 MH, XL-7016, ULS-933LP, and ULS-935LH, manufactured by Ipposha Oil Industries Co., Ltd.; and New Coat UVA-1025W, New Coat UVA-204W, and New Coat UVA-4512M, manufactured by Shin-Nakamura Chemical Co., Ltd. (all of these names are trade names).

In the case of using the polymer containing a unit having ultraviolet absorbing ability in a form of a latex, it may be mixed with a latex of the receptor polymer capable of being dyed, and the resulting mixture is coated. By doing so, a receptor layer, in which the ultraviolet absorber is homogeneously dispersed, can be formed.

The addition amount of the polymer containing a unit having ultraviolet absorbing ability or its latex is preferably 5 to 50 parts by mass, and more preferably 10 to 30 parts by mass, to 100 parts by mass of the receptor polymer capable of being dyed or its latex to be used to form the receptor layer.

The ultraviolet absorber may be either an organic compound or an inorganic compound.

In the case of the organic ultraviolet absorber, those represented by the following Formulae (11) to (18) are preferable.

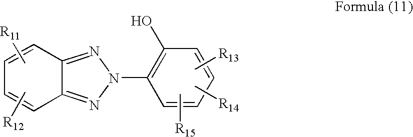

In formula (11), R₁₁, R₁₂, R₁₃, R₁₄, and R₁₅ each independently represent a hydrogen atom, a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group.

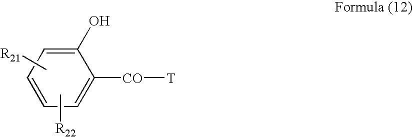

In formula (12), R₂₁ and R₂₂ each independently represent a hydrogen atom, a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group. T represents an aryl group, a heterocyclic group, or an aryloxy group. T preferably represents an aryl group.

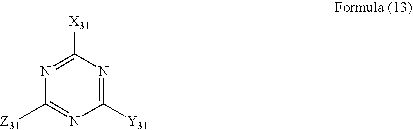

In the formula (13), X₃₁, Y₃₁ and Z₃₁ each independently represent a substituted or unsubstituted alkyl group, aryl group, alkoxy group, aryloxy group, alkylthio group, arylthio group or heterocyclic group. At least one of X₃₁, Y₃₁ and Z₃₁ represents a group represented by the following Formula (a1).

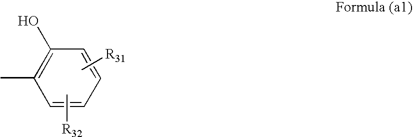

In formula (a1), R₃₁ and R₃₂ each independently represent a hydrogen atom, a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group. Also, the neighboring R₃₁ and R₃₂ may be combined to form a ring.

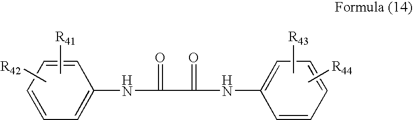

In formula (14), R₄₁, R₄₂, R₄₃, and R₄₄ each independently represent a hydrogen atom, a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group.

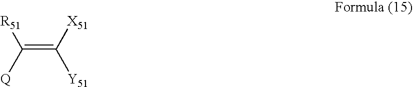

In the formula (15), Q represents an aryl group or a five- or six-membered heterocyclic group, R₅, represents a hydrogen atom or an alkyl group, X₅ and Y₅₁ each independently represent a cyano group, —COOR₅₂, —CONR₅₂R₅₃, —COR₅₂, —SO₂OR₅₂ or —SO₂NR₅₂R₅₃, wherein R₅₂ and R₅₃ each independently represent a hydrogen atom, an alkyl group or an aryl group. One among R₅₂ and R₅₃ preferably represents a hydrogen atom. Also, X₅₁ and Y₅₁ may be combined to form a five- or six-membered ring. When X₅, and Y₅₁ are respectively a carboxyl group, they may respectively have a salt form.

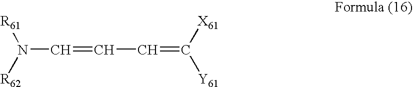

In the formula (16), R₆₁ and R₆₂ each independently represent a hydrogen atom, an alkyl group or an aryl group, or nonmetal atomic groups which are combined with each other to form a five- or six-membered ring. Also, any one of R₆₁ and R₆₂ may be combined with a methine group adjacent to the nitrogen atom to form a five- or six-membered ring. X₆₁ and Y₆₁ may be the same or different and have the same meanings as R₅₁ and X₅₁ in formula (15).

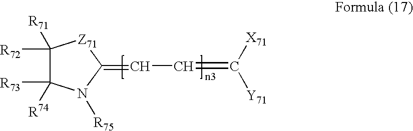

In the formula (17), R₇₁, R₇₂, R₇₃, and R₇₄ may be the same or different, and each independently represent a hydrogen atom, an alkyl group or an aryl group, provided that R₇₁ and R₇₄ may be combined with each other to form a double bond, wherein when R₇₁ and R₇₄ are combined with each other to form a double bond, R₇₂ and R₇₃ may be combined with each other to form a benzene ring or a naphthalene ring. R₇₅ represents an alkyl group or an aryl group, Z₇₁ represents an oxygen atom, a sulfur atom, a methylene group, an ethylene group, >N—R₇₆ or >C(R₇₇)(R₇₈), where R₇₆ represents an alkyl group or an aryl group, and R₇₇ and R₇₈ may be the same or different and respectively represent a hydrogen atom or an alkyl group. X₇₁ and Y₇₁ may be the same or different, and have the same meanings as X₅₁ and Y₅₁ in the formula (15). n3 denotes 0 or 1.

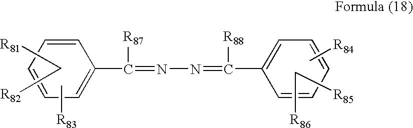

In formula (18), R₈₁, R₈₂, R₈₃, R₈₄, R₈₅, and R₈₆ each independently represent a hydrogen atom, a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, or a silyl group; R₈₇ and R₈₈ may be the same or different and each represent a hydrogen atom, an alkyl group, or an aryl group, and R₈₇ and R₈₈ may bond together to form a 5- or 6-membered ring.

In the formulae (11) to (18) and (a1), each substituent in, for example, groups having an alkyl part, aryl part or heterocyclic part may be substituted with the following substituents. In the explanations of each group described in the formulae (11) to (18) and (a1), specific examples include exemplified groups of the corresponding groups among the groups shown below.

Such groups will be explained and exemplified hereinbelow.

The below-described explanation of substituents applies to the term “substituent” in the phrases such as “substituent”, “optionally substituted substituent”, “may further have a substituent”, appeared in the explanation of the ultraviolet absorber (absorbing agent) for use in the present invention, especially in the first embodiment of the present invention.

Specific examples include: a halogen atom (e.g. a chlorine atom, a bromine atom, or an iodine atom); an alkyl group [which represents a substituted or unsubstituted linear, branched, or cyclic alkyl group, and which includes an alkyl group (preferably an alkyl group having 1 to 30 carbon atoms, e.g. a methyl group, an ethyl group, an n-propyl group, an isopropyl group, a t-butyl group, an n-octyl group, an eicosyl group, a 2-chloroethyl group, a 2-cyanoethyl group, or a 2-ethylhexyl group), a cycloalkyl group (preferably a substituted or unsubstituted cycloalkyl group having 3 to 30 carbon atoms, e.g. a cyclohexyl group, a cyclopentyl group, or a 4-n-dodecylcyclohexyl group), a bicycloalkyl group (preferably a substituted or unsubstituted bicycloalkyl group having 5 to 30 carbon atoms, i.e. a monovalent group obtained by removing one hydrogen atom from a bicycloalkane having 5 to 30 carbon atoms, e.g. a bicyclo[1,2,2]heptan-2-yl group or a bicyclo[2,2,2]octan-3-yl group), and a tricyclo or higher structure having three or more ring structures; and an alkyl group in substituents described below (e.g. an alkyl group in an alkylthio group) represents such an alkyl group of the above concept]; an alkenyl group [which represents a substituted or unsubstituted linear, branched, or cyclic alkenyl group, and which includes an alkenyl group (preferably a substituted or unsubstituted alkenyl group having 2 to 30 carbon atoms, e.g. a vinyl group, an allyl group, a prenyl group, a geranyl group, or an oleyl group), a cycloalkenyl group (preferably a substituted or unsubstituted cycloalkenyl group having 3 to 30 carbon atoms, i.e. a monovalent group obtained by removing one hydrogen atom from a cycloalkene having 3 to 30 carbon atoms, e.g. a 2-cyclopenten-1-yl group or a 2-cyclohexen-1-yl group), and a bicycloalkenyl group (which represents a substituted or unsubstituted bicycloalkenyl group, preferably a substituted or unsubstituted bicycloalkenyl group having 5 to 30 carbon atoms, i.e. a monovalent group obtained by removing one hydrogen atom from a bicycloalkene having one double bond, e.g. a bicyclo[2,2,1]hept-2-en-1-yl group or a bicyclo[2,2,2]oct-2-en-4-yl group)]; an alkynyl group (preferably a substituted or unsubstituted alkynyl group having 2 to 30 carbon atoms, e.g. an ethynyl group, a propargyl group, or a trimethylsilylethynyl group); an aryl group (preferably a substituted or unsubstituted aryl group having 6 to 30 carbon atoms, e.g. a phenyl group, a p-tolyl group, a naphthyl group, an m-chlorophenyl group, or an o-hexadecanoylaminophenyl group); a heterocyclic group (preferably a monovalent group obtained by removing one hydrogen atom from a substituted or unsubstituted 5- or 6-membered aromatic or nonaromatic heterocyclic compound; more preferably a 5- or 6-membered aromatic heterocyclic group having 3 to 30 carbon atoms, e.g. a 2-furyl group, a 2-thienyl group, a 2-pyrimidinyl group, a 2-benzothiazolyl group); a cyano group; a hydroxyl group; a nitro group; a carboxyl group; an alkoxy group (preferably a substituted or unsubstituted alkoxy group having 1 to 30 carbon atoms, e.g. a methoxy group, an ethoxy group, an isopropoxy group, a t-butoxy group, an n-octyloxy group, or a 2-methoxyethoxy group); an aryloxy group (preferably a substituted or unsubstituted aryloxy group having 6 to 30 carbon atoms, e.g. a phenoxy group, a 2-methylphenoxy group, a 4-t-butylphenoxy group, a 3-nitrophenoxy group, or a 2-tetradecanoylaminophenoxy group); a silyloxy group (preferably a silyloxy group having 3 to 20 carbon atoms, e.g. a trimethylsilyloxy group or a t-butyldimethylsilyloxy group); a heterocyclic oxy group (preferably a substituted or unsubstituted heterocyclic oxy group having 2 to 30 carbon atoms, e.g. a 1-phenyltetrazol-5-oxy group or a 2-tetrahydropyranyloxy group); an acyloxy group (preferably a formyloxy group, a substituted or unsubstituted alkylcarbonyloxy group having 2 to 30 carbon atoms, or a substituted or unsubstituted arylcarbonyloxy group having 7 to 30 carbon atoms, e.g. a formyloxy group, an acetyloxy group, a pivaloyloxy group, a stearoyloxy group, a benzoyloxy group, or a p-methoxyphenylcarbonyloxy group); a carbamoyloxy group (preferably a substituted or unsubstituted carbamoyloxy group having 1 to 30 carbon atoms, e.g. an N,N-dimethylcarbamoyloxy group, an N,N-diethylcarbamoyloxy group, a morpholinocarbonyloxy group, an N,N-di-n-octylaminocarbonyloxy group, or an N-n-octylcarbamoyloxy group); an alkoxycarbonyloxy group (preferably a substituted or unsubstituted alkoxycarbonyloxy group having 2 to 30 carbon atoms, e.g. a methoxycarbonyloxy group, an ethoxycarbonyloxy group, a t-butoxycarbonyloxy group, or an n-octylcarbonyloxy group); an aryloxycarbonyloxy group (preferably a substituted or unsubstituted aryloxycarbonyloxy group having 7 to 30 carbon atoms, e.g. a phenoxycarbonyloxy group, a p-methoxyphenoxycarbonyloxy group, or a p-n-hexadecyloxyphenoxycarbonyloxy group); an amino group (preferably an amino group, a substituted or unsubstituted alkylamino group having 1 to 30 carbon atoms, or a substituted or unsubstituted arylamino group having 6 to 30 carbon atoms, e.g. an amino group, a methylamino group, a dimethylamino group, an anilino group, an N-methyl-anilino group, or a diphenylamino group); an acylamino group (preferably a formylamino group, a substituted or unsubstituted alkylcarbonylamino group having 1 to 30 carbon atoms, or a substituted or unsubstituted arylcarbonylamino group having 6 to 30 carbon atoms, e.g. a formylamino group, an acetylamino group, a pivaloylamino group, a lauroylamino group, a benzoylamino group, or a 3,4,5-tri-n-octyloxyphenylcarbonylamino group); an aminocarbonylamino group (preferably a substituted or unsubstituted aminocarbonylamino group having 1 to 30 carbon atoms, e.g. a carbamoylamino group, an N,N-dimethylaminocarbonylamino group, an N,N-diethylaminocarbonylamino group, or a morpholinocarbonylamino group); an alkoxycarbonylamino group (preferably a substituted or unsubstituted alkoxycarbonylamino group having 2 to 30 carbon atoms, e.g. a methoxycarbonylamino group, an ethoxycarbonylamino group, a t-butoxycarbonylamino group, an n-octadecyloxycarbonylamino group, or an N-methyl-methoxycarbonylamino group); an aryloxycarbonylamino group (preferably a substituted or unsubstituted aryloxycarbonylamino group having 7 to 30 carbon atoms, e.g. a phenoxycarbonylamino group, a p-chlorophenoxycarbonylamino group, or an m-n-octyloxyphenoxycarbonylamino group); a sulfamoylamino group (preferably a substituted or unsubstituted sulfamoylamino group having 0 to 30 carbon atoms, e.g. a sulfamoylamino group, an N,N-dimethylaminosulfonylamino group, or an N-n-octylaminosulfonylamino group); an alkyl- or aryl-sulfonylamino group (preferably a substituted or unsubstituted alkylsulfonylamino group having 1 to 30 carbon atoms, or a substituted or unsubstituted arylsulfonylamino group having 6 to 30 carbon atoms, e.g. a methylsulfonylamino group, a butylsulfonylamino group, a phenylsulfonylamino group, a 2,3,5-trichlorophenylsulfonylamino group, or a p-methylphenylsulfonylamino group); a mercapto group; an alkylthio group (preferably a substituted or unsubstituted alkylthio group having 1 to 30 carbon atoms, e.g. a methylthio group, an ethylthio group, or an n-hexadecylthio group); an arylthio group (preferably a substituted or unsubstituted arylthio group having 6 to 30 carbon atoms, e.g. a phenylthio group, a p-chlorophenylthio group, or an m-methoxyphenylthio group); a heterocyclic thio group (preferably a substituted or unsubstituted heterocyclic thio group having 2 to 30 carbon atoms, e.g. a 2-benzothiazolylthio group or a 1-phenyltetrazol-5-ylthio group); a sulfamoyl group (preferably a substituted or unsubstituted sulfamoyl group having 0 to 30 carbon atoms, e.g. an N-ethylsulfamoyl group, an N-(3-dodecyloxypropyl)sulfamoyl group, an N,N-dimethylsulfamoyl group, an N-acetylsulfamoyl group, an N-benzoylsulfamoyl group, or an N-(N′-phenylcarbamoyl)sulfamoyl group); a sulfo group; an alkyl- or aryl-sulfinyl group (preferably a substituted or unsubstituted alkylsulfinyl group having 1 to 30 carbon atoms, or a substituted or unsubstituted arylsulfinyl group having 6 to 30 carbon atoms, e.g. a methylsulfinyl group, an ethylsulfinyl group, a phenylsulfinyl group, or a p-methylphenylsulfinyl group); an alkyl- or aryl-sulfonyl group (preferably a substituted or unsubstituted alkylsulfonyl group having 1 to 30 carbon atoms, or a substituted or unsubstituted arylsulfonyl group having 6 to 30 carbon atoms, e.g. a methylsulfonyl group, an ethylsulfonyl group, a phenylsulfonyl group, or a p-methylphenylsulfonyl group); an acyl group (preferably a formyl group, a substituted or unsubstituted alkylcarbonyl group having 2 to 30 carbon atoms, a substituted or unsubstituted arylcarbonyl group having 7 to 30 carbon atoms, or a substituted or unsubstituted heterocyclic carbonyl group having 4 to 30 carbon atoms, which is bonded to said carbonyl group through a carbon atom, e.g. an acetyl group, a pivaloyl group, a 2-chloroacetyl group, a stearoyl group, a benzoyl group, a p-n-octyloxyphenylcarbonyl group, a 2-pyridylcarbonyl group, or a 2-furylcarbonyl group); an aryloxycarbonyl group (preferably a substituted or unsubstituted aryloxycarbonyl group having 7 to 30 carbon atoms, e.g. a phenoxycarbonyl group, an o-chlorophenoxycarbonyl group, an m-nitrophenoxycarbonyl group, or a p-t-butylphenoxycarbonyl group); an alkoxycarbonyl group (preferably a substituted or unsubstituted alkoxycarbonyl group having 2 to 30 carbon atoms, e.g. a methoxycarbonyl group, an ethoxycarbonyl group, a t-butoxycarbonyl group, or an n-octadecyloxycarbonyl group); a carbamoyl group (preferably a substituted or unsubstituted carbamoyl group having 1 to 30 carbon atoms, e.g. a carbamoyl group, an N-methylcarbamoyl group, an N,N-dimethylcarbamoyl group, an N,N-di-n-octylcarbamoyl group, or an N-(methylsulfonyl)carbamoyl group); an aryl- or heterocyclic-azo group (preferably a substituted or unsubstituted aryl azo group having 6 to 30 carbon atoms, or a substituted or unsubstituted heterocyclic azo group having 3 to 30 carbon atoms, e.g. a phenylazo group, a p-chlorophenylazo group, or a 5-ethylthio-1,3,4-thiadiazol-2-ylazo group); an imido group (preferably an N-succinimido group or an N-phthalimido group); a phosphino group (preferably a substituted or unsubstituted phosphino group having 2 to 30 carbon atoms, e.g. a dimethylphosphino group, a diphenylphosphino group, or a methylphenoxyphosphino group); a phosphinyl group (preferably a substituted or unsubstituted phosphinyl group having 2 to 30 carbon atoms, e.g. a phosphinyl group, a dioctyloxyphosphinyl group, or a diethoxyphosphinyl group); a phosphinyloxy group (preferably a substituted or unsubstituted phosphinyloxy group having 2 to 30 carbon atoms, e.g. a diphenoxyphosphinyloxy group or a dioctyloxyphosphinyloxy group); a phosphinylamino group (preferably a substituted or unsubstituted phosphinylamino group having 2 to 30 carbon atoms, e.g. a dimethoxyphosphinylamino group or a dimethylaminophosphinylamino group); a silyl group (preferably a substituted or unsubstituted silyl group having 3 to 30 carbon atoms, e.g. a trimethylsilyl group, a t-butyldimethylsilyl group, or a phenyldimethylsilyl group).

Among the substituents, with respect to one having a hydrogen atom, the hydrogen atom may be removed and be substituted by any of the above-mentioned substituents. Examples thereof include: an alkylcarbonylaminosulfonyl group, an arylcarbonylaminosulfonyl group, an alkylsulfonylaminocarbonyl group, and an arylsulfonylaminocarbonyl group. Specific examples thereof include a methylsulfonylaminocarbonyl group, a p-methylphenylsulfonylaminocarbonyl group, an acetylaminosulfonyl group, and a benzoylaminosulfonyl group.

When the ultraviolet absorber represented by any one of the formulas (11) to (18) is water-soluble, it is preferred to have an ionic hydrophilic group. The ionic hydrophilic group includes a sulfo group, a carboxyl group, a phosphono group, and a quaternary ammonium group. As the ionic hydrophilic group, a carboxyl group, a phosphono group, and a sulfo group are preferred, and a carboxyl group and a sulfo group are particularly preferred. The carboxyl group, phosphono group, and sulfo group may be in the state of a salt, and the examples of the counter ions for forming the salts include an ammonium ion, an alkali metal ion (e.g., a lithium ion, a sodium ion, and a potassium ion), and an organic cation (a tetramethylammonium ion, a tetramethylguanidium ion, and a tetramethylphosphonium ion).

Among ultraviolet absorbers represented by any one of the Formulae (11) to (18), those represented by any one of the Formulae (11) to (14) are preferable in the point that they themselves have high light fastness, and those represented by any one of the Formulae (11) or (13) are further preferable in view of absorbing characteristics. Among these absorbers, those represented by the Formulae (11) or (13) are particularly preferable. In the case where the ultraviolet absorber is used in a basic condition, on the other hand, compounds represented by any one of the Formulae (14) to (18) are preferable from the viewpoint of preventing coloring caused by dissociation.

The compounds represented by any one of the formulae (11) to (18) can be synthesized by or according to any of the methods described, for example, in JP-B-48-30492, JP-B-55-36984, JP-B-55-125875, JP-B-36-10466, JP-B-48-5496, JP-A-46-3335, JP-A-58-214152, JP-A-58-221844, JP-A-47-10537, JP-A-59-19945, JP-A-63-53544, JP-A-51-56620, JP-A-53-128333, JP-A-58-181040, JP-A-6-211813, JP-A-7-258228, JP-A-8-239368, JP-A-8-53427, JP-A-10-115898, JP-A-10-147577, JP-A-10-182621, JP-T-8-501291 (“JP-T” means searched and published International patent publication), U.S. Pat. No. 3,754,919, U.S. Pat. No. 4,220,711, U.S. Pat. No. 2,719,086, U.S. Pat. No. 3,698,707, U.S. Pat. No. 3,707,375, U.S. Pat. No. 5,298,380, U.S. Pat. No. 5,500,332, U.S. Pat. No. 5,585,228, U.S. Pat. No. 5,814,438, British Patent No. 1,198,337, European Patents No. 323408A, No. 520938A, No. 521823A, No. 531258A, No. 530135A, and No. 520938A.

Also, the structures, material properties and action mechanisms of typical ultraviolet absorbers are described in Andreas Valet, “Light Stabilizers for Paint”, issued by Vincentz.

(4) Heat-Transferable Protective Layer Sheet

Next, there is explained a heat transferable protective layer sheet used in the heat-sensitive transfer sheet for use in the present invention, particularly in the third embodiment of the present invention.

(Substrate Sheet)

As a substrate sheet for the protective layer transfer sheet used in the present invention, particularly in the third embodiment thereof, use can be made of substrate sheets that have been used from the past for the heat transfer sheet. Specific examples of preferable substrate sheets include thin papers such as a capacitor paper, a glassine paper, and a paraffin paper; and stretched or non-stretched films or sheets of various kind plastic materials such as high heat-resistant polyester (e.g. polyethylene terephtharate, polybutylene terephtharate, and polyethylenenaphtharate), polypropylene, polycarbonate, cellulose acetate, polyethylene derivatives, polyvinylchloride, polyvinylidene chloride, polystyrene, polyamide, polyimide, polymethylpentene, and ionomer, and polyphenylene sulfide, polyetherketone, and polyethersulfone. In addition, these materials may be used after processing their surface with an easy adhesion processing. A laminate of these materials may also be used. The thickness of the substrate may be properly changed according to the materials used for the support so that strength and heat resistance would be suitable. Ordinarily, preferred are substrates having a thickness of from 1 μm to about 100 μm.

(Protective Layer)

The protective layer used in the present invention, particularly in the third embodiment thereof, has a laminated structure consisting of at least 2 layers, namely at least a layer containing an acrylic resin as a primary component and a layer containing a polyester resin as a primary component disposed in this order on a substrate sheet. As the acrylic resin used in the present invention, use can be made of polymers derived from at least one monomer selected from conventionally known acrylate monomers and methacrylate monomers. Other monomers than these acrylate-series monomers, such as styrene and acrylonitrile may be co-polymerized with said acryl-series monomers. A preferred monomer is methyl methacrylate. It is preferred that methyl methacrylate is contained in terms of preparation mass ratio of 50 mass % or more in the polymer.

Examples of the above-described conventionally known acryl-series monomers include methyl acrylate, methyl methacrylate, ethyl acrylate, ethyl methacrylate, propyl acrylate, propyl methacrylate, butyl acrylate, butyl methacrylate, isobutyl acrylate, isobutyl methacrylate, tertiary butyl acrylate, tertiary butyl methacrylate, isodecyl acrylate, isodecyl methacrylate, lauryl acrylate, lauryl methacrylate, lauryl tridecylacrylate, lauryl tridecylmethacrylate, tridecylacrylate, tridecylmethacrylate, cetylstearylacrylate, cetylstearylmethacrylate, 2-ethylhexyl acrylate, 2-ethylhexyl methacrylate, octyl acrylate, octyl methacrylate, cyclohexyl acrylate, cyclohexyl methacrylate, benzyl acrylate, benzyl methacrylate, phenoxyethyl acrylate, phenoxyethyl methacrylate, isobornyl acrylate, isobornyl methacrylate, dicyclopentenyl acrylate, dicyclopentenyl methacrylate, methacrylic acid, 2-hydroxyethyl acrylate, 2-hydroxyethyl methacrylate, 2-hydroxypropyl acrylate, 2-hydroxypropyl methacrylate, dimethylaminoethyl acrylate, dimethylaminoethyl methacrylate, diethylaminoethyl acrylate, diethylaminoethyl methacrylate, tertiary butyl aminoethyl acrylate, tertiary butylaminoethyl methacrylate, glycidyl acrylate, glycidyl methacrylate, and tetrahydrofurfuryl methacrylate.

Additional examples of the acryl-series monomers include ethylene diacrylate, ethylene dimethacrylate, diethyleneglycol diacrylate, diethylene glycol dimethacrylate, triethyleneglycol diacrylate, triethylene glycol dimethacrylate, tetraethyleneglycol diacrylate, tetraethylene glycol dimethacrylate, decaethyleneglycol diacrylate, decaethylene glycol dimethacrylate, pentadecaethyleneglycol diacrylate, pentadecaethylene glycol dimethacrylate, pentacontahectaethyleneglycol diacrylate, pentacontahectaethylene glycol dimethacrylate, butylene diacrylate, butylene dimethacrylate, allyl acrylate, allyl methacrylate, trimethylolpropane triacrylate, trimethylolpropane trimethacrylate, 1,6-hexanediol diacrylate, 1,6-hexanediol dimethacrylate, tripropyleneglycol diacrylate, tripropylene glycol dinethacrylate, pentaerythritol tetraacrylate, pentaerythritol tetramethacrylate, dipentaerythritol hexaacrylate, dipentaerythritol hexamethacrylate, neopentylglycol pentaacrylate, neopentylglycol pentamethacrylate, phosphagen hexaacrylate, and phosphagen hexamethacrylate. The acrylic resin used in the present invention is preferred to have a molecular weight of from 20,000 to 100,000. If the molecular weight is too small, oligomers are produced at the time of synthesis, so that a stable performance cannot be obtained. On the other hand, if the molecular weight is too large, a so-called “foil-off” deteriorates at the time of transfer of the protective layer.

As the polyester resin used in the present invention, particularly in the third embodiment thereof, there can be used conventionally known saturated polyester resins. Examples of an acid component of the polyester resin used in the present invention, particularly in the third embodiment, include aromatic dicarboxylic acids such as terephtharic acid, isophtharic acid, orthophtharic acid, 2,6-naphthalene dicarboxylic acid, teterahydrophtharic acid, hexahydrophtharic acid, hexahydroisophtharic acid, and hexahydroterephthiaric acid; aliphatic dicarboxylic acids such as succinic acid, adipic acid, azelaic acid, sebacic acid, dodecanedionic acid, and dimmer acid; and alicyclic dicarboxylic acids such as cyclohexane dicarboxylic acid, tricyclodecane dicarboxylic acid, and decalin dicarboxylic acid. Methyl-esterified derivatives of these compounds may be also used. Further, acid anhydrides of these compounds may be also used.

Further, if necessary, the above-mentioned compounds may be also used together with other compounds such as p-(hydroxyethoxy)benzoic acid, hydroxypivalic acid, γ-butyryllactone, ε-caprolactone, fumaric acid, maleic acid, maleic acid anhydrate, itaconic acid, and citraconic acid. Further, if necessary, the above-mentioned compounds may be also used together with tri- or more multi-functional polycarboxylic acids such as tri and tetra carboxylic acids (e.g., trimellitic acid, pyromellitic acid), in so far as the proportion of the tri- or more multi-functional polycarboxylic acids is 10 mol % or less of the entire carboxylic acid components. Particularly preferred is the composition that contains at least one acid component which is an aromatic carboxylic acid a part of which is substituted with a sulfonic acid or a salt thereof, in one molecular chain. It is preferable to conduct polymerization with setting the upper limit of a substitution amount of the sulfonic acid (or salt thereof) within a range that ensures solubility to organic solvents, since this would make it possible to use the polyester resin with mixing with other organic-solvent-soluble additives or resins. As a preferable aromatic dicarboxylic acid substituted with the sulfonic acid (or salt thereof), there are exemplified sulfoterephtharic acid, 5-sulfoisophtharic acid, 4-sulfophtharic acid, 4-sulfonaphthalene-2,7-dicarboxylic acid, 5-(4-sulfophenoxy)isophtharic acid, ammonium salts of these acids, and metal salts of these acids wherein examples of the metal include lithium, potassium, magnesium, calcium, copper, and iron. Of these acids, sodium salt of 5-sulfoisophtharic acid is especially preferred.

Examples of a polyol component that is another component of the polyester resin used in the present invention, particularly in the third embodiment thereof, include ethylene glycol, 1,2-propylene glycol, 1,3-propane diol, 1,4-butane diol, neopentyl glycol, 1,5-pentane diol, 1,6-hexane diol, 3-methyl-1,5-pentane diol, 1,9-nonane diol, 2-ethyl-2-butylpropane diol, hydroxypivalic acid neopentylglycol ester, dimethylolheptane, and 2,2,4-trimethyl-1,3-pentane diol. If necessary, there can be also used diethylene glycol, triethylene glycol, dipropylene glycol, polyethylene glycol, polypropylene glycol, polytetramethylene glycol, ethylene oxide adducts of neopentyl glycol, and propylene oxide adducts of neopentyl glycol.

As aromatic-group-containing glycols, there are paraxylene glycol, metaxylene glycol, orthoxylene glycol, 1,4-phenylene glycol, ethylene oxide adduct of 1,4-phenylene glycol, bisphenol A, and glycols obtained by adding from 1 to several moles of ethylene oxide or propylene oxide to the two phenolic hydroxyl groups of bisphenols, such as ethylene oxide adducts or propylene oxide adducts of bisphenol A. Examples of alicyclic diol components include tricyclodecane diol, tricyclodecane dimethylol, tricyclodecane dimethanol (TCD-M), cyclohexane diol, 1,4-cyclohexane dimethanol, hydrogenated bisphenol A, ethylene oxide adducts or propylene oxide adducts of hydrogenated bisphenol A. As the above-described polyester resin, a preferable glass transition temperature ranges from 50° C. to 120° C., and a preferable molecular weight ranges from 2,000 to 40,000. A molecular weight ranging from 4,000 to 20,000 is more preferred, because so-called “foil-off” properties at the time of transfer of the protective layer are improved.

As to the protective layer transfer sheet used in the present invention, particularly in the third embodiment thereof, an ultraviolet absorbing agent may be contained in a layer composed of a polyester resin as a primary component among the two types of the protective layers, and/or an adhesion layer. As the ultraviolet absorbing agents, use can be made of conventionally known inorganic or organic ultraviolet absorbing agents. As the organic ultraviolet absorbing agents, use can be made of non-reactive ultraviolet absorbing agents such as salicylate-series, benzophenone-series, benzotriazole-series, triazine-series, substituted acrylonitrile-series, nickel chelate-series, and hindered amine-series ultraviolet absorbing agents; and copolymers or graft polymers of thermoplastic resins (e.g., acrylic resins) and activated products obtained by introducing to the above-described non-reactive ultraviolet absorbing agents; addition-polymerizable double bonds originated from a vinyl group, an acryroyl group, a methacryroyl group, or the like, or alternatively by introducing thereto other types of groups such as an alcoholic hydroxyl group, an amino group, a carboxyl group, an epoxy group, and an isocyanate group. Of these ultraviolet absorbing agents, especially preferred are benzophenone-series, benzotriazole-series, and triazine-series ones. It is preferred that these ultraviolet absorbing agents be used by combining different series ones so that an effective ultraviolet absorption wavelength region would be covered in accordance with characteristics of the dye used for image formation. Further, it is preferred that a plurality of the non-reactive ultraviolet absorbing agents having a different structure from each other be used as a mixture, so as to prevent the ultraviolet absorbing agents from deposition.

(Release Layer)

As to the protective layer transfer sheet used in the present invention, particularly in the third embodiment of the present invention, a release layer may be formed between the substrate sheet and the protective layer in the case where the protective layer is not easily released from the substrate sheet at the time of heat transfer. In other words, the substrate sheet may be release processed by applying a release layer thereon. The release layer may be formed by coating and drying a coating liquid containing at least one of waxes, silicone waxes, silicone resins, fluorine resins, acrylic resins, polyvinyl alcohol resins, cellulose derivatives resins, urethane-series resins, acetic acid-series vinyl resins, acryl vinyl ether-series resins, maleic acid anhydride resins, and copolymers of these resins, using a conventionally known coating method, such as gravure coat and gravure reverse coat. Of these resins, preferred are acryl resins obtained by polymerizing acrylic acid or methacrylic acid singly, or copolymerizing acrylic acid or methacrylic acid with other monomers. These acrylic resins are excellent in adhesion to the substrate sheet, and release properties from the protective layer.

The release layer can be properly selected from, for example, a type that transfers to the transferee (i.e. the object to be covered by the protective layer) at the time of heat transfer, or a type that remains on the same side as the substrate sheet at the time of heat transfer, or a type that is subjected to a cohesive failure at the time of heat transfer. It is preferred from excellence of surface gloss and transfer stability of the protective layer and the like that a release layer has no transferability so that the release layer remains on the same side as the substrate sheet at the time of heat transfer, and so that the interface between the release layer and a heat-transferable protective layer becomes a surface of the protective layer after heat transfer. The release layer may be formed according to conventionally known coating methods. A thickness of 0.5 μm to about 5 μm at a dry state would be sufficient. Further, in the case where it is desired to have a matte protective layer after transfer, the surface of the protective layer can be matted by incorporating various particles into the release layer, or by subjecting the surface of the release layer on the same side as the protective layer to a matte processing. If release properties between the substrate sheet and the protective layer are good, the protective layer can be separated directly from the substrate sheet by heat transfer, without assistance (disposition) of the release layer.

(Adhesion Layer)

In the present invention, particularly in the third embodiment of the present invention, it is preferred that an adhesion layer be disposed on the outermost surface of the protective layer, which is at least two-layer laminate, of the protective layer-transfer sheet, in order to improve adhesiveness of the protective layer to the transferee. For the adhesion layer, use can be made of conventionally known adhesives and heat-sensitive adhesives. It is more preferred to form an adhesion layer using a thermoplastic resin having a glass transition temperature of 50° C. to 80° C. Specifically, it is preferred to select resins having a suitable glass transition temperature from resins that exhibits excellent adhesiveness when heated, such as ultraviolet absorbing resins, acrylic resins, vinyl chloride-vinyl acetate copolymer resins, epoxy resins, polyester resins, polycarbonate resins, butyral resins, polyamide resins, and polyvinyl chloride resins.

As the ultraviolet absorbing resins, for example, use can be made of resins obtained by reacting to connect a reactive ultraviolet absorbing agent with a thermal plastic resin or ionizing radiation hardening resin. More specifically, examples include those obtained by introducing addition polymerizable double bonds or other reactive groups to conventionally known non-reactive organic ultraviolet absorbing agents, as exemplified by salicylate-series, benzophenone-series, benzotriazole-series, substituted acrylonitrile-series, nickel chelate-series, and hindered amine-series ultraviolet absorbing agents. The above-described addition polymerizable double bond can be introduced by addition polymerizable groups such as a vinyl group, an acryroyl group and a methacryroyl group. Examples of the above-described “other reactive group” include an alcoholic hydroxyl group, an amino group, a carboxyl group, an epoxy group, and an isocyanate group.

To the adhesion layer, the followings may be added: the above-described resins and additives including organic ultraviolet absorbing agents such as benzophenone-series compounds, benzotriazole-series compounds, oxalic anilide-series compounds, cyanoacrylate-series compounds, and salicylate-series compounds, and inorganic fine particles having ultraviolet absorbing capacity (for example, oxides of metal such as zinc, titanium, cerium, tin, and iron). Further, it is optional to add other additives such as coloring pigments, white pigments, extender pigments, fillers, antistatic agents, antioxidants, and fluorescent whitening agents in accordance with necessity. The adhesion layer is formed by coating and then drying a coating liquid containing the above-described resin for construction of the adhesion layer, and the above-described additives that are optionally added to the adhesion layer, so that a thickness of the adhesion layer preferably becomes a range of from 0.5 μm to about 10 μm at the dry state.

It is preferred that a heat transferable protective sheet in the present invention, particularly in the third embodiment of the present invention, has the absorption maximum within the wavelength of 330 nm to 370 nm and the absorption density at the maximum absorption wavelength is 0.8 or more.

Further, it is preferred that both values of the absorption wavelength and the absorption density as described above are with respect to the protective sheet.

(5) Image Formation

In the image-forming method (system) of the present invention, imaging is achieved by superposing a heat-sensitive (thermal) transfer sheet on a heat-sensitive (thermal) transfer image-receiving sheet so that a heat transfer layer of the heat-sensitive transfer sheet is in contact with a receptor layer of the heat-sensitive transfer image-receiving sheet and giving thermal energy in accordance with image signals given from a thermal head.

Specifically, image-forming can be achieved by the similar manner to that as described in, for example, JP-A-2005-88545. In the present invention, a printing time is preferably less than 15 seconds, and more preferably in the range of 5 to 12 seconds, from the viewpoint of shortening a time taken until a consumer gets a print.

The method or system of the present invention may be utilized for printers, copying machines and the like, which employs a heat-sensitive transfer recording system.

As a means for providing heat energy in the thermal transfer, any of the conventionally known providing means may be used. For example, application of a heat energy of about 5 to 100 mJ/mm² by controlling recording time in a recording device such as a thermal printer (e.g. trade name: Video Printer VY-100, manufactured by Hitachi, Ltd.), sufficiently attains the expected result.

Also, the heat-sensitive transfer image-receiving sheet for use in the present invention may be used in various applications enabling thermal transfer recording, such as heat-sensitive transfer image-receiving sheets in a form of thin sheets (cut sheets) or rolls; cards; and transmittable type manuscript-making sheets, by optionally selecting the type of support.

The present invention, especially the first embodiment of the present invention, provides an image-forming method using a thermal transfer system, which gives a good image excellent in image fastness, particularly light fastness.

The present invention, especially the second embodiment of the present invention, provides an image-forming method using a thermal transfer system, which gives an image excellent in fastness.

The present invention, especially the third embodiment of the present invention, provides an image-forming method using a thermal transfer system, which gives an image with a high density, a less reverse transfer of dye and an excellent image fastness.

According to the present invention, it is possible to provide an image-forming method using a thermal transfer system, which method gives an image with a high density and a high quality, and excellent image fastness.

The present invention will be described in more detail based on the following examples, but the invention is not intended to be limited thereto.

### EXAMPLES

In the following Examples, the terms “part” and “%” are values by mass, unless they are indicated differently in particular.

### Example 1

### Preparation of Heat Transfer Sheets

(Preparation of Heat-Sensitive Transfer Sheet-Coating Liquid and Protective Layer-Coating Liquid)

For preparation of heat-sensitive transfer sheets, the following thirteen kinds of coating liquids were prepared.

| Preparation of yellow-heat-transfer-layer-coating liquid Y1 | | |
|---|---|---|
| Yellow dye RY-1 shown below | 2.2 | parts by mass |
| Yellow dye RY-2 shown below | 2.3 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Preparation of yellow-heat-transfer-layer-coating liquid Y2 | | |
| Yellow dye Y-1 | 5.0 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Preparation of yellow-heat-transfer-layer-coating liquid Y3 | | |
| Yellow dye Y-6 | 5.0 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Preparation of magenta-heat-transfer-layer-coating liquid M1 | | |
| Magenta dye RM-1 shown below | 5.0 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Preparation of magenta-heat-transfer-layer-coating liquid M2 | | |
| Magenta dye RM-1 shown below | 2.0 | parts by mass |
| Magenta dye M1-4 | 3.0 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Preparation of magenta-heat-transfer-layer-coating liquid M3 | | |
| Magenta dye M1-4 | 3.6 | parts by mass |
| Magenta dye M3-1 | 1.2 | parts by mass |
| Magenta dye M4-1 | 1.2 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Preparation of magenta-heat-transfer-layer-coating liquid M4 | | |
| Magenta dye M1-4 | 3.0 | parts by mass |
| Magenta dye M2-3 | 2.0 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Preparation of cyan-heat-transfer-layer-coating liquid C1 | | |
| Cyan dye C-11 | 3.5 | parts by mass |
| Cyan dye RC-1 shown below | 1.5 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Preparation of cyan-heat-transfer-layer-coating liquid C2 | | |
| Cyan dye C-10 | 5.0 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Preparation of cyan-heat-transfer-layer-coating liquid C3 | | |
| Cyan dye C-10 | 2.0 | parts by mass |
| Cyan dye C-11 | 3.0 | parts by mass |
| Polyvinylbutyral resin (trade name: S-LEC BX-1, manufactured by | | |
| Sekisui Chemical Co., Ltd.) | 4.5 | parts by mass |
| Methyl ethyl ketone/toluene (1/1, at mass ratio) | 90 | parts by mass |
| Preparation of heat-transferable protective-layer-coating liquid P1 | | |
| Acryl silicone graft resin (trade name: XSA-100, manufactured by | 70 | parts by mass |
| Toagosei Co., Ltd.) | | |
| Methyl ethyl ketone/toluene (1/1, at mass ratio) | 40 | parts by mass |
| Preparation of heat-transferable protective-layer-coating liquid P2 | | |
| Acryl silicone graft resin (trade name: XSA-100, manufactured by | 60 | parts by mass |
| Toagosei Co., Ltd.) | | |
| Ultraviolet absorber IV-1 shown below | 10 | parts by mass |
| Methyl ethyl ketone/toluene (1/1, at mass ratio) | 40 | parts by mass |
| Preparation of adhesion layer-coating liquid A1 for heat transferable protective layer | | |
| Vinyl chloride/vinyl acetate copolymer (VYLF (trade name, a | 30 | parts by mass |
| product of UCC), Tg = 68° C., polymerization degree: 220) | | |
| Micro silica | 0.4 | parts by mass |
| Methyl ethyl ketone/toluene (1/1, at mass ratio) | 70 | parts by mass |

(RY-1)

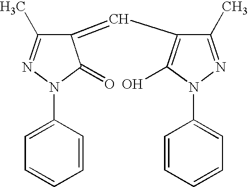

(RY-2)

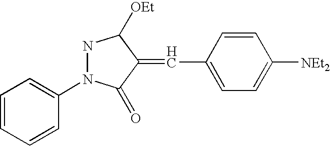

(RM-1)

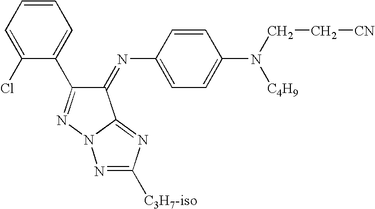

(RC-1)

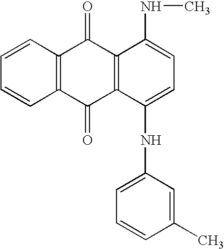

(UV-1)

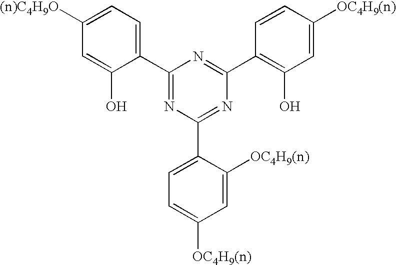

(Preparation of Sheets by Coating of Coating Liquids Described Above)

As a support, was used a 6.0 μm thick polyester film (Lumirror (trade name, a product of Tray)), the back surface of which was previously processed to give a heat resistant lubricant properties to said back surface using a thermosetting acrylic resin (thickness: 1 μm). On the surface of the above-said film opposite to the back surface, were coated the above-described coating liquids in combinations described in Table 1 below so that a yellow heat-transfer layer, a magenta heat-transfer layer, a cyan heat-transfer layer, and a protective layer were disposed successively in the longitudinal direction of the film. Thus, heat-sensitive transfer sheets A to S were prepared. In the case of forming a protective layer, the protective layer-coating liquid P1 or P2 was coated and dried, and then the adhesion layer-coating liquid A1 for protective layer was coated on the protective layer.

A coating amount of each of five layers applied in this preparation was controlled so that the solid content coating amount would become the value set forth below.

Yellow heat-transfer layer 0.6 g/m²

Magenta heat-transfer layer 0.8 g/m²

Cyan heat-transfer layer 0.9 g/m²

Protective layer 1.0 g/m²

Protective-layer adhesive layer 0.7 g/m²

TABLE 1

| | Yellow | Magenta | Cyan | |
|---|---|---|---|---|
| Sample | transfer | transfer | transfer | Protective |
| No. | layer | layer | layer | layer |
| A | Y1 | M1 | C1 | None |
| B | Y1 | M1 | C1 | P1 |
| C | Y1 | M1 | C1 | P2 |
| D | Y2 | M1 | C1 | None |
| E | Y1 | M1 | C2 | None |
| F | Y1 | M1 | C2 | P1 |
| G | Y2 | M1 | C2 | None |
| H | Y2 | M1 | C2 | P1 |
| I | Y2 | M1 | C2 | P2 |
| J | Y2 | M2 | C2 | None |
| K | Y2 | M2 | C2 | P1 |
| L | Y2 | M3 | C2 | None |
| M | Y2 | M3 | C2 | P1 |
| N | Y2 | M4 | C2 | None |
| O | Y2 | M4 | C2 | P1 |
| P | Y3 | M4 | C2 | P1 |
| Q | Y3 | M4 | C3 | None |
| R | Y3 | M4 | C3 | P1 |
| S | Y3 | M4 | C3 | P2 |

With respect to the thus-obtained heat-sensitive transfer sheets, ultraviolet absorption spectra of the samples having a protective layer were measured. As a result, with respect to the samples prepared using the protective layer-coating liquid P1, no maximum absorption was found in the wavelength region of from 330 nm to 370 nm, and average absorption density was 0.2 or less. In contrast, with respect to the samples prepared using the protective layer-coating liquid P2, the maximum absorption was observed at 348 nm, and absorption density at the maximum absorption wavelength was 1.0.

(Preparation of Heat-Transfer Image-Receiving Sheets)

Preparation of an Image-Receiving Sheet S1

A synthetic paper (trade name: Yupo FPG 200, manufactured by Yupo Corporation, thickness: 200 μm) was used as the support; and, on one surface of the support, a white intermediate layer and a receptor layer, having the following compositions, were coated in this order by a bar coater. The coating was carried out such that the amount of the white intermediate layer and the amount of the receptor layer after each layer was dried would be 1.0 g/m² and 4.0 g/m², respectively, and these layers were respectively dried at 110° C. for 30 seconds.

White intermediate layer

| | | |
|---|---|---|
| Polyester resin (Trade name: Vylon 200, | 10 | parts by mass |
| manufactured by Toyobo Co., Ltd.) | | |
| Fluorescent whitening agent (Trade name: | 1 | part by mass |
| Uvitex OB, manufactured by Ciba-Geigy) | | |
| Titanium oxide | 30 | parts by mass |
| Methyl ethyl ketone/toluene (1/1, at | 90 | parts by mass |
| mass ratio) | | |

Receptor layer

| | | |
|---|---|---|
| Vinyl chloride/vinyl acetate resin | 100 | parts by mass |
| (Trade name: Solbin A, manufactured | | |
| by Nisshin Chemicals Co., Ltd.) | | |
| Amino-modified silicone (Trade name: | 5 | parts by mass |
| X22-3050C, manufactured by Shin-Etsu | | |
| Chemical Co., Ltd.) | | |
| Epoxy-modified silicone (Trade name: | 5 | parts by mass |
| X22-300E, manufactured by Shin-Etsu | | |
| Chemical Co., Ltd.) | | |
| Methyl ethyl ketone/toluene (1/1, at | 400 | parts by mass |
| mass ratio) | | |

Preparation of Image-Receiving Sheet S2

A paper support, on both sides of which polyethylene was laminated, was subjected to corona discharge treatment on the surface thereof, and then a gelatin undercoat layer containing sodium dodecylbenzenesulfonate was disposed on the treated surface. The heat insulation layer and the receptor layer each having the following composition were multilayer-coated on the gelatin undercoat layer, in the state that the heat insulation layer and the receptor layer were laminated in this order from the side of the support, by a method illustrated in FIG. 9 in U.S. Pat. No. 2,761,791. Immediately after the coating, the layers were dried at 50° C. for 16 hours. The coating was performed so that coating amounts of the heat insulation layer and the receptor layer after drying would be 15 g/m² and 4.0 g/m², respectively.

Receptor layer

| | | |
|---|---|---|
| Vinyl chloride-series latex (trade | 48 | parts by mass |
| name: Vinybran 900, manufactured | | |
| by Nisshin Chemicals Co., Ltd.) | | |
| Gelatin | 3 | parts by mass |
| Wax (trade name: EMUSTAR-042X, | 1 | part by mass |
| manufactured by Nippon Seiki Co., Ltd.) | | |

Heat insulation layer

| | | |
|---|---|---|
| Hollow latex polymer (trade name: | 563 | parts by mass |
| MH5055, manufactured by Nippon | | |
| Zeon Co., Ltd.) | | |
| Gelatin | 120 | parts by mass |

Preparation of Image-Receiving Sheet S3

A paper support, on both sides of which polyethylene was laminated, was subjected to corona discharge treatment on the surface thereof, and then a gelatin undercoat layer containing sodium dodecylbenzenesulfonate was disposed on the treated surface. On the gelatin undercoat layer, were multilayer-coated a heat insulation layer having the same composition as that in the image-receiving sheet S2 and an interlayer consisting of gelatin alone so that these layers would be superposed in this order from the support side, according to the method described in FIG. 9 of U.S. Pat. No. 2,761,791. Immediately after coating, these layers were dried at 50° C. for 16 hours. These layers were coated so that a dry coating amount of each of the heat insulation layer and the interlayer would become 15 g/m² and 0.2 g/m², respectively. On the interlayer of the thus-obtained sample, was coated a receptor layer having the same composition as that in the image-receiving sheet S1 using a bar coater. The receptor layer was coated so that a dry coating amount would become 4.0 g/m². Immediately after coating, the sample was dried at 110° C. for 30 seconds.

(Image Formation)

The aforementioned heat transfer sheets A to S and heat transfer image-receiving sheets S1 to S3 were processed such that each of these sheets could be mounted on a sublimate-type printer (trade name: DPB1500, manufactured by Nidec Copal Corporation.), and image outputs were made in a high speed printing mode.

[Evaluation Test]

With respect to the thus-obtained image samples, light fastness was evaluated by sunlight irradiation. The sunlight irradiation was carried out indoor of a house having a sufficiently wide glazed window open to the south, in which samples were stuck on a sloping table with an angle of 45 degree from the floor. The indoor temperature and humidity were controlled to the conditions of 25° C.±2° C. and 55% RH±5%. Evaluation was carried out by reflection densitometric measurement using Xrite 310 manufactured by Xrite Inc. With respect to a monochromatic image of each of yellow (Y), magenta (M), and cyan (C) with an initial density of 1.0 and a gray image with a V density (visual density) of 1.0, each density of said each monochromatic image and each density of yellow, magenta and cyan in the said gray image were measured after passage of 60 days respectively. Based on the thus-measured densities, each image residual ratio was calculated to evaluate light fastness. Concerning the gray image, not only high residual ratio for density is required, but also it is required from the viewpoint of color balance that three color (yellow, magenta, and cyan) residual ratios are close to each other. Therefore, a ratio of the lowest residual ratio of a dye of the gray to the highest residual ratio of another dye of the gray was defined as a residual rate which was used for an indicator of the color balance evaluation. The thus-obtained results were shown in Table 2.

TABLE 2

| | Heat- | | Color image | | | Color image residual ratio | | | |
|---|---|---|---|---|---|---|---|---|---|
| | sensitive | Image- | residual ratio | | | (Gray) | | | |
| Sample | transfer | receiving | (Monochromatic) | | | | | | Residual |
| No. | sheet | sheet | Y | M | C | Y | M | C | rate |
| 101 | A | S1 | 52 | 45 | 50 | 44 | 42 | 20 | 0.45 |
| 102 | B | S1 | 56 | 53 | 55 | 50 | 43 | 22 | 0.44 |
| 103 | C | S1 | 62 | 54 | 58 | 54 | 48 | 27 | 0.50 |
| 104 | D | S1 | 61 | 44 | 50 | 58 | 40 | 20 | 0.34 |
| 105 | E | S1 | 53 | 45 | 61 | 43 | 39 | 29 | 0.67 |
| 106 | F | S1 | 56 | 53 | 66 | 52 | 45 | 33 | 0.63 |
| 107 | G | S1 | 62 | 45 | 62 | 59 | 54 | 52 | 0.88 |
| 108 | H | S1 | 67 | 53 | 67 | 66 | 56 | 54 | 0.82 |
| 109 | I | S1 | 69 | 56 | 69 | 69 | 62 | 58 | 0.84 |
| 110 | J | S1 | 62 | 59 | 62 | 59 | 56 | 49 | 0.83 |
| 111 | K | S1 | 68 | 64 | 67 | 66 | 62 | 58 | 0.88 |
| 112 | L | S1 | 62 | 58 | 62 | 61 | 58 | 53 | 0.87 |
| 113 | M | S1 | 67 | 64 | 68 | 66 | 62 | 66 | 0.94 |
| 114 | N | S1 | 62 | 56 | 62 | 62 | 54 | 54 | 0.82 |
| 115 | O | S1 | 67 | 64 | 68 | 66 | 62 | 66 | 0.94 |
| 116 | P | S1 | 69 | 63 | 68 | 68 | 63 | 67 | 0.93 |
| 117 | Q | S1 | 64 | 57 | 60 | 62 | 57 | 56 | 0.90 |
| 118 | R | S1 | 70 | 64 | 65 | 69 | 64 | 66 | 0.93 |
| 119 | S | S1 | 70 | 68 | 66 | 70 | 72 | 68 | 0.97 |
| 120 | A | S2 | 65 | 56 | 62 | 55 | 52 | 18 | 0.33 |
| 121 | B | S2 | 70 | 66 | 69 | 62 | 54 | 21 | 0.34 |
| 122 | C | S2 | 78 | 68 | 72 | 68 | 60 | 25 | 0.37 |
| 123 | D | S2 | 76 | 55 | 62 | 73 | 50 | 24 | 0.33 |
| 124 | E | S2 | 66 | 56 | 76 | 54 | 49 | 31 | 0.57 |
| 125 | F | S2 | 70 | 66 | 82 | 65 | 56 | 33 | 0.51 |
| 126 | G | S2 | 77 | 56 | 78 | 74 | 68 | 55 | 0.74 |
| 127 | H | S2 | 84 | 66 | 84 | 82 | 70 | 63 | 0.77 |
| 128 | I | S2 | 86 | 70 | 86 | 86 | 77 | 70 | 0.81 |
| 129 | J | S2 | 77 | 74 | 78 | 74 | 70 | 58 | 0.78 |
| 130 | K | S2 | 85 | 80 | 84 | 82 | 78 | 70 | 0.85 |
| 131 | L | S2 | 77 | 72 | 78 | 76 | 72 | 64 | 0.84 |
| 132 | M | S2 | 84 | 78 | 84 | 82 | 78 | 75 | 0.91 |
| 133 | N | S2 | 77 | 70 | 78 | 77 | 68 | 68 | 0.88 |
| 134 | O | S2 | 84 | 80 | 85 | 82 | 77 | 83 | 0.93 |
| 135 | P | S2 | 86 | 79 | 85 | 85 | 79 | 84 | 0.93 |
| 136 | Q | S2 | 80 | 71 | 75 | 78 | 71 | 68 | 0.87 |
| 137 | R | S2 | 87 | 80 | 81 | 86 | 80 | 82 | 0.93 |
| 138 | S | S2 | 88 | 85 | 83 | 88 | 90 | 85 | 0.94 |
| 139 | A | S3 | 63 | 55 | 62 | 55 | 51 | 18 | 0.33 |
| 140 | B | S3 | 70 | 64 | 68 | 61 | 54 | 20 | 0.33 |
| 141 | C | S3 | 78 | 66 | 71 | 66 | 60 | 24 | 0.36 |
| 142 | D | S3 | 76 | 54 | 60 | 71 | 50 | 23 | 0.32 |
| 143 | E | S3 | 64 | 55 | 76 | 54 | 48 | 31 | 0.57 |
| 144 | F | S3 | 69 | 66 | 82 | 64 | 56 | 32 | 0.50 |
| 145 | G | S3 | 75 | 56 | 78 | 74 | 68 | 54 | 0.73 |
| 146 | H | S3 | 84 | 65 | 83 | 82 | 69 | 63 | 0.77 |
| 147 | I | S3 | 85 | 70 | 85 | 85 | 77 | 68 | 0.80 |
| 148 | J | S3 | 77 | 74 | 78 | 74 | 70 | 58 | 0.78 |
| 149 | K | S3 | 84 | 80 | 83 | 82 | 78 | 70 | 0.85 |
| 150 | L | S3 | 77 | 72 | 76 | 76 | 71 | 63 | 0.83 |
| 151 | M | S3 | 83 | 76 | 84 | 80 | 78 | 73 | 0.91 |
| 152 | N | S3 | 77 | 70 | 78 | 77 | 68 | 68 | 0.88 |
| 153 | O | S3 | 84 | 79 | 84 | 82 | 77 | 82 | 0.94 |
| 154 | P | S3 | 84 | 79 | 85 | 85 | 79 | 84 | 0.94 |
| 155 | Q | S3 | 81 | 71 | 75 | 78 | 70 | 67 | 0.86 |
| 156 | R | S3 | 86 | 79 | 81 | 86 | 80 | 81 | 0.93 |
| 157 | S | S3 | 89 | 85 | 84 | 88 | 91 | 85 | 0.93 |

From the results shown in Table 2 set forth above, it is understood that samples 120 to 157 which used the image-receiving sheet S2 or S3 were excellent in light fastness, as compared with samples 101 to 119 which used the image-receiving sheet SI. In contrast, the samples which used the image-receiving sheet S1 were generally better with respect to the balance of dye residual ratios in the gray. However, samples 126 to 138, 145 to 157 which used the image-receiving sheet S2 or S3 together with the heat-sensitive transfer sheet (G to S) were also excellent in the balance of dye residual ratios. Therefore, these samples 126 to 138, 145 to 157 were excellent in both dye fastness and the balance of dye residual ratios. It is also understood that samples further provided with a protective layer were more excellent in the dye fastness, and had well balanced dye residual ratios (samples 127, 128, 130, 132, 134, 135, 137, 138, 146, 147, 149, 151, 153, 154, 156, 157).

### Example 2

### Preparation of Ink Sheets

(Preparation of Ink Sheet S1)

A polyester film 6.0 μm in thickness (trade name: Lumirror, manufactured by Toray Industries, Inc.) was used as the substrate film. A heat-resistant slip layer (thickness: 1 μm) was formed on the back side of the film, and the following yellow, magenta, and cyan compositions were respectively applied as a monochromatic layer (coating amount: 1 g/m² after drying) on the front side.

| Yellow ink | | |
|---|---|---|
| Yellow dye with the following structure (manufacture by Fuji Film | 4.5 | parts by mass |
| Corporation) | | |
| 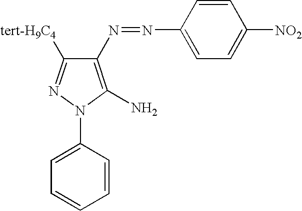 | | |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Magenta ink | | |
| Kayalon Polyester Red Violet FBL (manufactured by Nippon | 4.5 | parts by mass |
| Kayaku, trade name, with the chemical structure of the following | | |
| formula) | | |
| 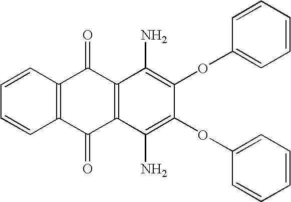 | | |
| Polyvinylbutyral resin (trade name: 5-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |
| Cyan ink | | |
| Exemplified compound (13)-1 | 4.5 | parts by mass |
| Polyvinylbutyral resin (trade name: S-LEC BX-1, manufactured by | 4.5 | parts by mass |
| Sekisui Chemical Co., Ltd.) | | |
| Methyl ethyl ketone/toluene (1/1, at mass ratio) | 90 | parts by mass |

(Preparation of Ink Sheet S2)

Ink sheet S2 was prepared in the same manner as ink sheet S1, except that the dye in the magenta ink of the ink sheet S1 was replaced by the exemplified compound M-1 of formula (M).

(Preparation of Ink Sheet S3)

Ink sheet S3 was prepared in the same manner as ink sheet SI, except that the dye in the yellow ink of the ink sheet S1 was replaced by the exemplified compound (1) of formula (YA).

(Preparation of Ink Sheet S4)

Ink sheet S4 was prepared in the same manner as ink sheet S1, except that the dye in the magenta ink of the ink sheet S1 was replaced by the exemplified compound M-1 of formula (M) and the dye in the yellow ink of the ink sheet S1 was replaced by the exemplified compound YB-(1) of formula (YB).

(Preparation of Ink Sheet S5)

Ink sheet S5 was prepared in the same manner as ink sheet S4, except that the dye in the magenta ink of the ink sheet S4 was replaced by the exemplified compound M-2 of formula (M).

(Preparation of Ink Sheet S6)

Ink sheet S6 was prepared in the same manner as ink sheet S4, except that the dye in the magenta ink of the ink sheet S4 was replaced by the exemplified compound M-8 of formula (M).

(Preparation of Ink Sheet S7)

Ink sheet S7 was prepared in the same manner as ink sheet S4, except that the dye in the magenta ink of the ink sheet S4 was replaced by the dye illustrated by the following chemical structure. 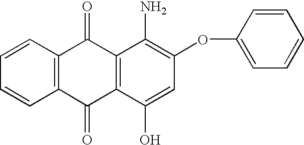
(Preparation of Ink Sheet S8)

Ink sheet S8 was prepared in the same manner as ink sheet S4, except that the dye in the yellow ink of the ink sheet S4 was replaced by the exemplified compound (I) of formula (YA).

(Preparation of Ink Sheet S9)

Ink sheet S9 was prepared in the same manner as ink sheet S4, except that the dye in the yellow ink of the ink sheet S4 was replaced by the exemplified compound YC-1 of formula (YC).

(Preparation of Ink Sheet S10)

Ink sheet S10 was prepared in the same manner as ink sheet S4, except that the dye in the yellow ink of the ink sheet S4 was replaced by the exemplified compound YD-1 of formula (YD).

(Preparation of Ink Sheet S11)

Ink sheet S1 was prepared in the same manner as ink sheet S4, except that the dye in the yellow ink of the ink sheet S4 was replaced by the exemplified compound YE-1 of formula (YE).

(Preparation of Ink Sheet S12)

Ink sheet S11 was prepared in the same manner as ink sheet S4, except that the dye in the cyan ink of the ink sheet S4 was replaced by the exemplified compound C-1 of formula (C).

[Preparation of Heat-Transfer Image Receiving Sheets]

Preparation of Image Receiving Sheet 101

Image receiving sheet 101 was prepared in the same manner as Image receiving sheet SI in Example 1.

Preparation of Image Receiving Sheet 102

Image receiving sheet 102 was prepared in the same manner as Image receiving sheet S2 in Example 1.

Preparation of Image Receiving Sheet 103

Image receiving sheet 103 was prepared in the same manner as Image receiving sheet S3 in Example 1.

(Image Formation)

Ink sheets S1 to S12 and image-receiving sheets 101 to 103 were used together in such various ways as shown in Tables 3 to 5 set forth below. These sheets were processed so that they could be loaded in a sublimation type printer DPB 2000 (trade name) manufactured by NIDEC COPAL Corporation. Output was performed with a high speed print mode.

(Evaluation Test)

An optical density (Dmax) at the black solid image area (uniformly blackened area) was measured using a reflection densitometer. In addition, the image sample was irradiated to a xenon light (96,000 lux) for 144 hours, and an image density (reflection density) of the image sample after the irradiation was also measured using the same reflection densitometer. A ratio of residual density was calculated with taking the image density before the irradiation being 100. The thus-obtained results are shown in the following Tables 3 to 5.

TABLE 3

| Ink sheet | Image-receiving sheet | Residual ratio of density (%) |
|---|---|---|
| S1 | 101 | 82 |
| S2 | 101 | 83 |
| S3 | 101 | 90 |
| S4 | 101 | 91 |
| S5 | 101 | 91 |
| S6 | 101 | 90 |
| S7 | 101 | 91 |
| S8 | 101 | 90 |
| S9 | 101 | 90 |
| S10 | 101 | 91 |
| S11 | 101 | 90 |
| S12 | 101 | 91 |

TABLE 4

| Ink sheet | Image-receiving sheet | Residual ratio of density (%) |
|---|---|---|
| S1 | 102 | 84 |
| S2 | 102 | 84 |
| S3 | 102 | 97 |
| S4 | 102 | 95 |
| S5 | 102 | 98 |
| S6 | 102 | 95 |
| S7 | 102 | 90 |
| S8 | 102 | 97 |
| S9 | 102 | 98 |
| S10 | 102 | 97 |
| S11 | 102 | 97 |
| S12 | 102 | 95 |

TABLE 5

| Ink sheet | Image-receiving sheet | Residual ratio of density (%) |
|---|---|---|
| S1 | 103 | 82 |
| S2 | 103 | 85 |
| S3 | 103 | 98 |
| S4 | 103 | 97 |
| S5 | 103 | 99 |
| S6 | 103 | 94 |
| S7 | 103 | 92 |
| S8 | 103 | 98 |
| S9 | 103 | 98 |
| S10 | 103 | 99 |
| S11 | 103 | 97 |
| S12 | 103 | 98 |

The results in the Tables 3 to 5 show that the samples, which used a combination of ink sheet and image-receiving sheet corresponding to comparative examples, were inferior in light resistance, whereas the samples according to the present invention were excellent in light resistance.

### Example 3

### Preparation of Ink Sheets

(Preparation of Ink Sheet D1)

A polyester film 6.0 μm in thickness (trade name: Lumirror, manufactured by Toray Industries, Inc.) was used as the substrate film. A heat-resistant slip layer (thickness: 1 μm) was formed on the back side of the film, and the following yellow, magenta, and cyan compositions were respectively applied as a monochromatic layer (coating amount: 1 g/m² after drying) on the front side.

Yellow ink

| | | |
|---|---|---|
| Dye compound (YC-1) | 4.5 | parts by mass |
| Polyvinylbutyral resin (Trade name: S-LEC | 4.5 | parts by mass |
| BX-1, manufactured by Sekisui | | |
| Chemical Co., Ltd.) | | |
| Methyl ethyl ketone/toluene (1/1, at mass ratio) | 90 | parts by mass |

Magenta ink

| | | |
|---|---|---|
| Dye compound (MS-1) | 4.5 | parts by mass |
| Polyvinylbutyral resin (Trade name: S-LEC | 4.5 | parts by mass |
| BX-1, manufactured by Sekisui | | |
| Chemical Co., Ltd.) | | |
| Methyl ethyl ketone/toluene (1/1, at mass ratio) | 90 | parts by mass |

Cyan ink

| | | |
|---|---|---|
| Dye compound (CS-1) | 4.5 | parts by mass |
| Polyvinylbutyral resin (Trade name: S-LEC | 4.5 | parts by mass |
| BX-1, manufactured by Sekisui | | |
| Chemical Co., Ltd.) | | |
| Methyl ethyl ketone/toluene (1/1, at mass ratio) | 90 | parts by mass |

(Preparation of Ink Sheet D2)

Ink sheet D2 was prepared in the same manner as ink sheet D1, except that dye compound MS-1 and CS-1 were replaced by M-2 and C-10 respectively.

(Preparation of Ink Sheet D3)

Ink sheet D3 was prepared in the same manner as ink sheet D1, except that dye compound MS-1 and CS-1 were replaced by M-8 and C-10 respectively.

(Preparation of Ink Sheet D4)

Ink sheet D4 was prepared in the same manner as ink sheet D2, except that dye compound YC-1 was replaced by YD-1.

(Preparation of Ink Sheet D5)

Ink sheet D5 was prepared in the same manner as ink sheet D2, except that dye compound YC-1 was replaced by YE-2.

(Preparation of Ink Sheet D6)

Ink sheet D6 was prepared in the same manner as ink sheet D2, except that dye compound YC-1 was replaced by the exemplified compound (7) of formula (YA).

(Preparation of Ink Sheet D7)

Ink sheet D7 was prepared in the same manner as ink sheet D2, except that dye compound YC-1 was replaced by YB-(1).

The chemical structures of the dye compounds MS-1 and CS-1 used for preparing the ink sheet D1 are shown below. 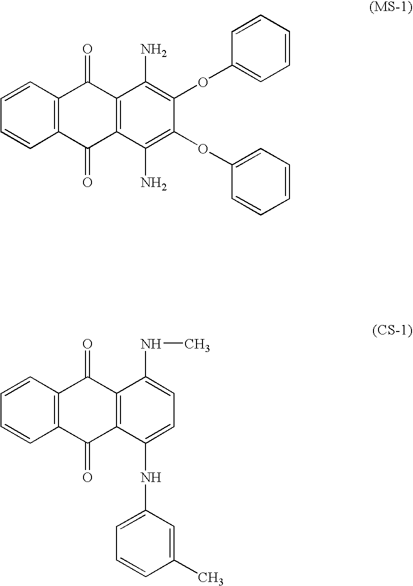
[Preparation of Protective Layer Sheet]
(Preparation of Protective Layer Sheet P1)

On the same polyester film as used for the preparation of ink sheets, were coated a protective layer and an adhesion layer each having the composition set forth below. Dry coating amounts of the protective layer and the adhesion layer were controlled to 1 g/m² and 0.7 g/m², respectively. After coating and drying of the protective layer, the adhesion layer was coated on the protective layer.

Protective layer

| | |
|---|---|
| Acrylic resin (DIANAL BR-80, trade name, a | 20 parts by mass |
| product of Mitsubishi Rayon) | |
| Methyl ethyl ketone/toluene (1/1, at mass ratio) | 80 parts by mass |

Adhesion layer

| | |
|---|---|
| Polyester resin (Trade name: Vylon 220, | 30 parts by mass |
| manufactured by Toyobo Co., Ltd.) | |
| Methyl ethyl ketone/toluene (1/1, at mass ratio) | 70 parts by mass |

Preparation of Protective Layer Sheet P2

Protective layer sheet P2 was prepared in the same manner as the protective layer sheet PI, except that TINUVIN 900 (a product of Ciba-Geigy, trade name) was added to the protective layer. The absorption maximum wavelength of the protective layer sheet P2 was 348 nm. The absorption density at the absorption maximum wavelength was 0.6.

Preparation of Protective Layer Sheet P3

Protective layer sheet P3 was prepared in the same manner as the protective layer sheet P2, except that the addition amount of TINUVIN 900 (a product of Ciba-Geigy, trade name) was increased so that the absorption density at 348 nm would become 0.8.

[Preparation of Heat-Sensitive Transfer Image-Receiving Sheets]

Image-receiving sheets 101 to 103 were prepared in the same manner as described above.

Preparation of Image-Receiving Sheet 104

Image-receiving sheet 104 was prepared in the same manner as the image-receiving sheet 102, except that gelatin of the heat insulation layer was replaced by a water-soluble polyester resin (VYLONAL MD 1200, trade name, a product of Toyobo).

(Image Formation)

Ink sheets D1 to D7, protective layer sheets P1 and P2 and the above-described image-receiving sheets 101 to 104 were used together in such various ways as shown in Table 6 set forth below to prepare heat transfer materials. These sheets were processed so that they could be loaded in a sublimation type printer DPB 1500 (trade name) manufactured by NIDEC COPAL Corporation. A black solid image and a yellow monochromic image were output using the thus-processed sheets.

(Maximum Transfer Density)

The visual density of each of the black images obtained in the above condition was measured by Photographic Densitometer (trade name, manufactured by X-Rite Incorporated).

(Evaluation Test of Light Fastness)

An optical density (Dmax) at the black solid image area was measured using a reflection densitometer. In addition, the image sample was irradiated to a xenon light (96,000 lux) for 144 hours, and an image density of the image sample after the irradiation was also measured using the same reflection densitometer. A ratio of residual density was calculated with taking the image density before the irradiation being 100.

(Reverse Transfer Test of Yellow Dye)

A yellow density in each of the yellow monochromatic output and in the black image was measured using a photographic densitometer (a product of X-rite Inc., a trade name). Reverse transfer of yellow dye was evaluated by a ratio of reduction of the yellow density in a black image compared with the maximum yellow density of the yellow monochromatic output.

TABLE 6

| | Ink sheet | Protective sheet | Image-receiving sheet |
|---|---|---|---|
| 1 | D1 | None | 101 |
| 2 | D2 | None | 101 |
| 3 | D3 | None | 101 |
| 4 | D4 | None | 101 |
| 5 | D5 | None | 101 |
| 6 | D6 | None | 101 |
| 7 | D7 | None | 101 |
| 8 | D1 | None | 102 |
| 9 | D2 | None | 102 |
| 10 | D3 | None | 102 |
| 11 | D4 | None | 102 |
| 12 | D5 | None | 102 |
| 13 | D6 | None | 102 |
| 14 | D7 | None | 102 |
| 15 | D1 | None | 103 |
| 16 | D2 | None | 103 |
| 17 | D3 | None | 103 |
| 18 | D4 | None | 103 |
| 19 | D5 | None | 103 |
| 20 | D6 | None | 103 |
| 21 | D7 | None | 103 |
| 22 | D1 | None | 104 |
| 23 | D2 | None | 104 |
| 24 | D3 | None | 104 |
| 25 | D4 | None | 104 |
| 26 | D5 | None | 104 |
| 27 | D6 | None | 104 |
| 28 | D7 | None | 104 |
| 29 | D1 | None | 102 |
| 30 | D1 | P1 | 102 |
| 31 | D1 | P2 | 102 |
| 32 | D2 | None | 102 |
| 33 | D2 | P1 | 102 |
| 34 | D2 | P2 | 102 |
| 35 | D3 | None | 102 |
| 36 | D3 | P1 | 102 |
| 37 | D3 | P2 | 102 |
| 38 | D4 | None | 102 |
| 39 | D4 | P1 | 102 |
| 40 | D4 | P2 | 102 |
| 41 | D5 | None | 102 |
| 42 | D5 | P1 | 102 |
| 43 | D5 | P2 | 102 |
| 44 | D6 | None | 102 |
| 45 | D6 | P1 | 102 |
| 46 | D6 | P2 | 102 |
| 47 | D7 | None | 102 |
| 48 | D7 | P1 | 102 |
| 49 | D7 | P2 | 102 |

The thus-obtained results are shown in the following Table 7.

TABLE 7

| | Maximum | Residual ratio of dye | Reverse transfer ratio of |
|---|---|---|---|
| | density | (%) | yellow dye (%) |
| 1 | 1.99 | 54 | 24 |
| 2 | 2.01 | 62 | 23 |
| 3 | 1.99 | 60 | 24 |
| 4 | 2.00 | 61 | 23 |
| 5 | 2.01 | 61 | 23 |
| 6 | 2.00 | 63 | 22 |
| 7 | 2.01 | 63 | 22 |
| 8 | 2.04 | 61 | 19 |
| 9 | 2.12 | 72 | 16 |
| 10 | 2.10 | 70 | 18 |
| 11 | 2.11 | 74 | 15 |
| 12 | 2.10 | 73 | 16 |
| 13 | 2.14 | 76 | 13 |
| 14 | 2.15 | 77 | 13 |
| 15 | 2.05 | 62 | 18 |
| 16 | 2.12 | 72 | 16 |
| 17 | 2.10 | 70 | 16 |
| 18 | 2.11 | 73 | 15 |
| 19 | 2.11 | 74 | 16 |
| 20 | 2.15 | 77 | 13 |
| 21 | 2.15 | 77 | 13 |
| 22 | 2.01 | 58 | 22 |
| 23 | 2.09 | 69 | 19 |
| 24 | 2.06 | 66 | 20 |
| 25 | 2.08 | 71 | 19 |
| 26 | 2.07 | 70 | 19 |
| 27 | 2.09 | 73 | 17 |
| 28 | 2.10 | 74 | 17 |
| 29 | 2.03 | 61 | 20 |
| 30 | 2.03 | 63 | 21 |
| 31 | 2.04 | 69 | 20 |
| 32 | 2.10 | 72 | 16 |
| 33 | 2.09 | 74 | 15 |
| 34 | 2.10 | 80 | 15 |
| 35 | 2.08 | 70 | 17 |
| 36 | 2.07 | 73 | 17 |
| 37 | 2.08 | 79 | 18 |
| 38 | 2.10 | 74 | 16 |
| 39 | 2.09 | 76 | 15 |
| 40 | 2.10 | 82 | 15 |
| 41 | 2.10 | 74 | 16 |
| 42 | 2.09 | 75 | 15 |
| 43 | 2.10 | 81 | 15 |
| 44 | 2.14 | 78 | 13 |
| 45 | 2.15 | 82 | 13 |
| 46 | 2.14 | 89 | 12 |
| 47 | 2.14 | 77 | 13 |
| 48 | 2.14 | 81 | 12 |
| 49 | 2.15 | 88 | 13 |

From the results shown in Table 7, it is understood that the heat transfer material samples having the composition according to the present invention each provided a high maximum density and were excellent in dye transfer properties, compared with the rest of the samples. Further, each sample according to the present invention was excellent in light fastness. It is also understood that, in the heat transfer material samples having the composition according to the present invention, a reverse transfer rate of the yellow dye was so small that a well color-balanced image were obtained.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. § 119 (a) on Patent Application No. 2006-269758 filed in Japan on Sep. 29, 2006, Patent Application No. 2006-269800 filed in Japan on Sep. 29, 2006, and Patent Application No. 2006-269804 filed in Japan on Sep. 29, 2006, each of which is entirely herein incorporated by reference.

What we claim is:

1. An image-forming method comprising:
employing
a heat-sensitive transfer image-receiving sheet having a support, at least one dye receptor layer on the support, and at least one heat insulation layer containing both hollow polymer particles and a hydrophilic polymer, the heat insulation layer being disposed between the receptor layer and the support, and
a heat-sensitive transfer sheet having at least one yellow heat transfer layer, at least one magenta heat transfer layer, and/or at least one cyan heat transfer layer on a support,
wherein a yellow dye incorporated in the yellow heat transfer layer contains at least one compound represented by formula (Y) set forth below, and a cyan dye incorporated in the cyan heat transfer layer is exclusively composed of at least one compound represented by formula (C) set forth below: 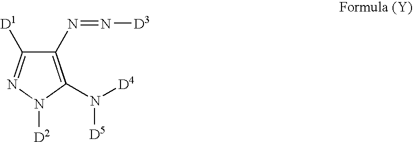
wherein, in formula (Y), D¹ represents a hydrogen atom, an alkyl group, an alkoxy group, an aryl group, an alkoxycarbonyl group, a cyano group, or a carbamoyl group; D² represents a hydrogen atom, an alkyl group, an aryl group, or a heteroaryl group; D³ represents an aryl group or a heteroaryl group; D⁴ and D⁵ each independently represent a hydrogen atom or an alkyl group; and each of the above-mentioned groups may further be substituted; 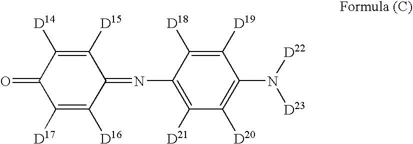
wherein, in formula (C), D¹⁴, D¹⁵, D¹⁶, D¹⁷, D¹⁸, D¹⁹, D²⁰, and D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D²² and D²³ each independently represent a hydrogen atom, an alkyl group, or an aryl group; D²² and D²³ may be bonded together to form a ring; D¹⁹ and D²² and/or D²⁰ and D²³ may be bonded together to form a ring; and each of the above-mentioned groups may further be substituted.

2. The image-forming method as described in claim 1, wherein at least one magenta dye contained in the magenta heat transfer layer disposed in the heat-sensitive transfer sheet is a compound represented by formula (M1), (M2), (M3), or (M4): 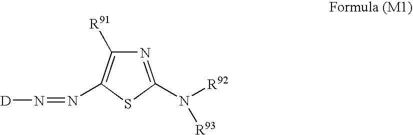
wherein, in formula (M1), R⁹¹ represents a hydrogen atom, a substituted or unsubstituted alkyl group, cycloalkyl group, aryl group, or heterocyclic group; R⁹² and R⁹³ each independently represent a hydrogen atom, a substituted or unsubstituted alkyl group, alkoxy group, cycloalkyl group, or aryl group; and D represents an optionally substituted aryl group or heterocyclic group;
A-N═N-E
wherein, in formula (M2), A represents an optionally substituted heterocyclic group whose heterocyclic ring is selected from a group consisting of imidazole, pyrazole, thiazole, benzothiazole, isothiazole, benzoisothiazole, and thiophene; and E represents an optionally substituted aminophenyl group, tetrahydroquinolinyl group, julolidyl group, or aminoquinolinyl group; 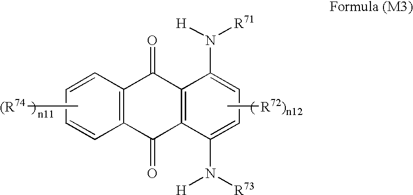
wherein, in formula (M3), R⁷¹ and R⁷³ each independently represent a hydrogen atom or a substituent; R⁷² and R⁷⁴ each independently represent a substituent; n11 represents an integer of 0 to 4; n12 represents an integer of 0 to 2; when n11 represents an integer of 2 to 4, R⁷⁴s may be the same or different from each other; and when n12 represents 2, R⁷²s may be the same or different from each other; 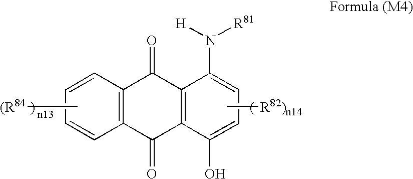
wherein, in formula (M4), R⁸¹ represents a hydrogen atom or a substituent; R⁸² and R⁸⁴ each independently represent a substituent; n13 represents an integer of 0 to 4; n14 represents an integer of 0 to 2; when n13 represents an integer of 2 to 4, R⁸⁴s may be the same or different from each other; and when n14 represents 2, R⁸²s may be the same or different from each other.

3. The image-forming method as described in claim 1, wherein the heat-sensitive transfer sheet has at least three kinds of heat transfer layers comprising yellow, magenta, and cyan, formed panel sequentially, on the surface of the same support.

4. The image-forming method as described in claim 1, wherein the heat-sensitive transfer sheet further has a heat transferable protective layer.

5. The image-forming method as described in claim 4, wherein the heat transferable protective layer has a maximum absorption within the wavelength region of from 330 nm to 370 nm and exhibits an absorption density of 0.8 or more at the maximum absorption wavelength.

6. The image-forming method as described in claim 1, wherein at least one of the hydrophilic polymer contained in the heat insulation layer of the heat-sensitive transfer image-receiving sheet is gelatin.

7. The image-forming method as described in claim 1, comprising the steps of:
superposing the heat-sensitive transfer sheet on the heat-sensitive transfer image-receiving sheet so that the receptor layer of the heat-sensitive transfer image-receiving sheet is in contact with the heat transfer layer of the heat-sensitive transfer sheet; and
giving thermal energy from a thermal head in accordance with image signals, thereby to form an image.

8. An image-forming method comprising:
employing
a heat-sensitive transfer image-receiving sheet having a support, at least one receptor layer on the support, and at least one heat insulation layer containing both hollow polymer particles and a hydrophilic polymer, the heat insulation layer being disposed between the receptor layer and the support, and
a heat-sensitive transfer sheet having three kinds of heat transfer layers of at least yellow, magenta, and cyan, on the support,
wherein a magenta dye incorporated in the magenta heat transfer layer contains at least one compound represented by formula (M) set forth below, a yellow dye incorporated in the yellow heat transfer layer contains at least one compound represented by formula (YA), (YB), (YC), (YD), or (YE) set forth below, and a cyan dye incorporated in the cyan heat transfer layer contains at least one compound represented by formula (C1) or (C) set forth below; 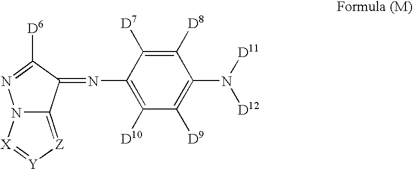
wherein in formula (M), D⁶, D⁷, D⁸, D⁹, and D¹⁰ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D¹¹ and D¹² each independently represent a hydrogen atom, an alkyl group, or an aryl group; D¹¹ and D¹² may be bonded together to form a ring; D⁸ and D¹¹ and/or D⁹ and D¹² may be bonded together to form a ring; X, Y, and Z each independently represent ═C(D¹³)- or a nitrogen atom, in which D¹³ represents a hydrogen atom, an alkyl group, an aryl group, an alkoxy group, an aryloxy group, or an amino group; when X and Y each represents ═C(D¹³)- or Y and Z each represents ═C(D¹³)-, two D¹³s may be bonded together to form a saturated or unsaturated carbon ring; and each of the above-mentioned groups may further be substituted; 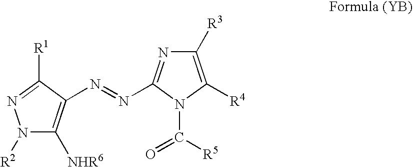
wherein, in formula (YB), R¹, R², R³, R⁴, and R⁶ each independently represent a hydrogen atom or a monovalent substituent; and R⁵ represents a monovalent substituent; 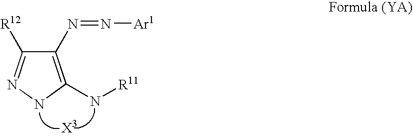
wherein, in formula (YA), R¹¹ represents a monovalent substituent; R¹² represents a hydrogen atom or a monovalent substituent; Ar¹ represents a group selected from the members of the heterocyclic group set (1) set forth below; and X³ represents atoms necessary to form a ring; 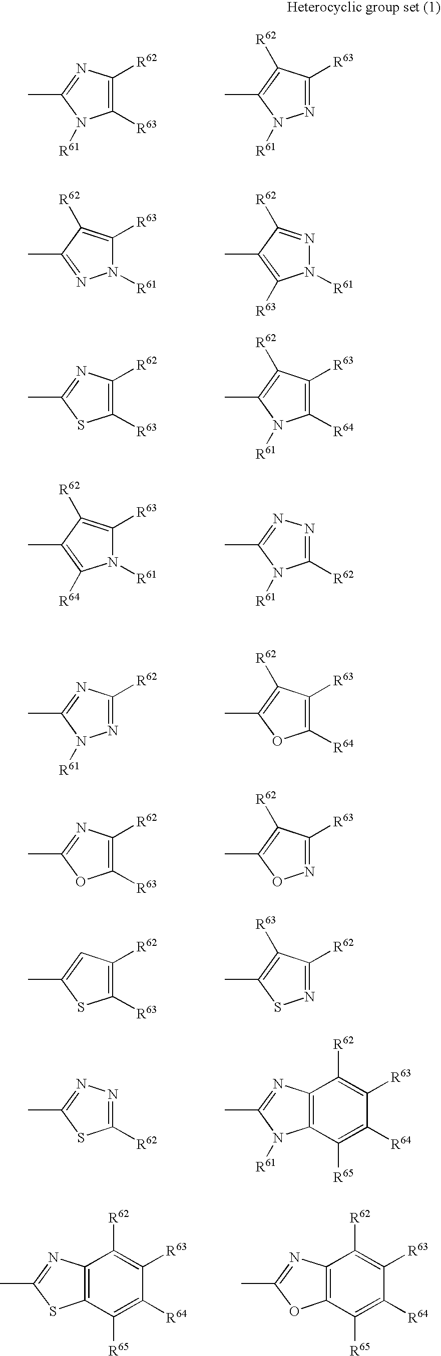 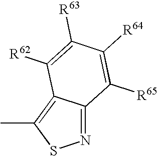
wherein, in the heterocyclic group set (1), R⁶¹, R⁶², R⁶³, R⁶⁴, and R⁶⁵ each independently represent a hydrogen atom or a substituent; 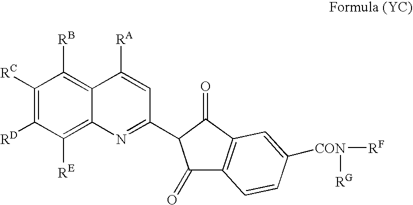
wherein, in formula (YC), R^{A}, R^{B}, R^{C}, R^{D}, and R^{E} each independently represent a hydrogen atom, a halogen atom, an alkyl group having 1 to 8 carbon atoms, a cycloalkyl group, an alkoxy group, an alkoxyalkoxy group, an alkoxycarbonyl group, a thioalkoxy group, an alkylsulfonyl group, an amino group, a substituted or unsubstituted phenoxy group, or a substituted or unsubstituted thiophenoxy group; R^{F} and R^{G} each independently represent a hydrogen atom, an alkyl group, an alkoxyalkyl group, a cycloalkyl group, an allyl group, an optionally substituted aryl group, an aralkyl group, a furfuryl group, a tetrahydrofuryl group, a tetrahydrofurfuryl group, or a hydroxylalkyl group; each of these groups may further be substituted; 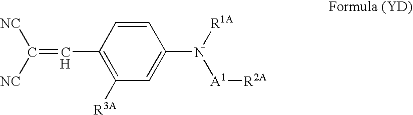
wherein, in formula (YD), R^{1A} represents an allyl group or an alkyl group; R^{2A} represents a substituted or unsubstituted alkyl group or aryl group; A¹ represents —CH₂—, —CH₂CH₂—, —CH₂CH₂O—, —CH₂CH₂OCH₂—, or —CH₂CH₂OCH₂CH₂—; R^{3A} represents an alkyl group; each of these groups may further be substituted; 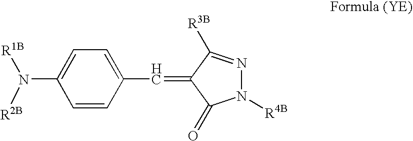
wherein, in formula (YE), R^{1B}, R^{2B}, R^{3B}, and R^{4B} each independently represent a hydrogen atom or a substituent; 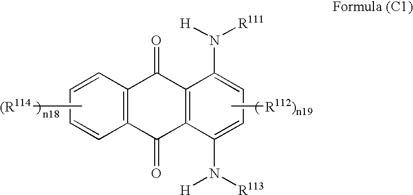
wherein, in formula (C1), R¹¹¹ and R¹¹³ each independently represent a hydrogen atom or a substituent; R¹¹² and R¹¹⁴ each independently represent a substituent; n18 represents an integer of 0 to 4; n19 represents an integer of 0 to 2; when n18 represents an integer of 2 to 4, R¹¹⁴s may be the same or different from each other; and when n19 represents 2, R¹¹²s may be the same or different from each other; each of these groups may further be substituted; 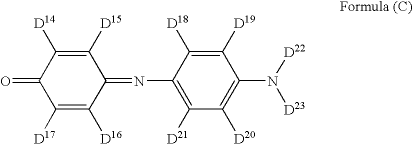
wherein, in formula (C), D⁴, D¹⁵, D¹⁶, D¹⁷, D¹⁸, D¹⁹, D²⁰, and D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D²² and D²³ each independently represent a hydrogen atom, an alkyl group, or an aryl group; D¹⁷ and D¹⁶ may be bonded together to form a ring; D²² and D²³ may be bonded together to form a ring; D¹⁹ and D²² and/or D²⁰ and D²³ may be bonded together to form a ring; and each of the above-mentioned groups may further be substituted.

9. The image-forming method as described in claim 8, wherein, in formula (M), X and Z each represent a nitrogen atom, and Y represents ═C(D¹³)-.

10. The image-forming method as described in claim 8, wherein the heat-sensitive transfer sheet has at least three kinds of heat transfer layers comprising yellow, magenta, and cyan, formed panel sequentially, on the surface of the same support.

11. The image-forming method as described in claim 8, wherein at least one of the hydrophilic polymer contained in the heat insulation layer of the heat-sensitive transfer image-receiving sheet is gelatin.

12. The image-forming method as described in claim 8, comprising the steps of:
superposing the heat-sensitive transfer sheet on the heat-sensitive transfer image-receiving sheet so that the receptor layer of the heat-sensitive transfer image-receiving sheet is in contact with the heat transfer layer of the heat-sensitive transfer sheet; and
giving thermal energy from a thermal head in accordance with image signals, thereby to form an image.

13. An image-forming method comprising:
employing
a heat-sensitive transfer image-receiving sheet having a support, at least one receptor layer on the support, and at least one heat insulation layer containing both hollow polymer particles and a hydrophilic polymer, the heat insulation layer being disposed between the receptor layer and the support, and
a heat-sensitive transfer sheet having three kinds of heat transfer layers of at least yellow, magenta, and cyan, on the support,
wherein a magenta dye incorporated in the magenta heat transfer layer contains at least one compound represented by formula (M) set forth below, and a cyan dye incorporated in the cyan heat transfer layer is exclusively composed of at least one compound represented by formula (C) set forth below: 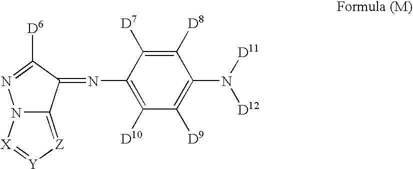
wherein, in formula (M), D⁶, D⁷, D⁸, D⁹, and D¹⁰ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D¹¹ and D¹² each independently represent a hydrogen atom, an alkyl group, or an aryl group; D¹¹ and D¹² may be bonded together to form a ring; D⁸ and D¹¹ and/or D⁹ and D¹² may be bonded together to form a ring; X, Y, and Z each independently represent ═C(D¹³)- or a nitrogen atom, in which D¹³ represents a hydrogen atom, an alkyl group, an aryl group, an alkoxy group, an aryloxy group, or an amino group; when X and Y each represents ═C(D¹³)- or Y and Z each represents ═C(D¹³)-, two D¹³s may be bonded together to form a saturated or unsaturated carbon ring; and each of the above-mentioned groups may further be substituted; 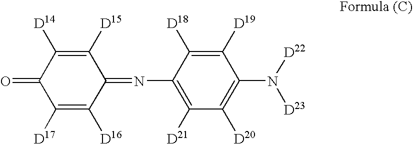
wherein, in formula (C), D¹⁴, D¹⁵, D¹⁶, D¹⁷, D¹⁸, D¹⁹, D²⁰, and D²¹ each independently represent a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group; D²² and D²³ each independently represent a hydrogen atom, an alkyl group, or an aryl group; D²² and D²³ may be bonded together to form a ring; D¹⁹ and D²² and/or D²⁰ and D²³ may be bonded together to form a ring; and each of the above-mentioned groups may further be substituted.

14. The image-forming method as described in claim 13, wherein at least one yellow dye contained in the yellow heat transfer layer disposed in the heat-sensitive transfer sheet is a compound represented by formula (YA), (YB), (YC), (YD), or (YE): 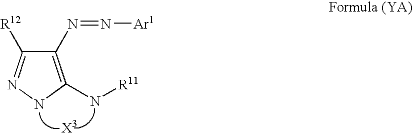
wherein, in formula (YA), R¹¹ represents a monovalent substituent; R¹² represents a hydrogen atom or a monovalent substituent; Ar¹ represents a group selected from the members of the heterocyclic group set (1) set forth below; and X³ represents atoms necessary to form a ring; 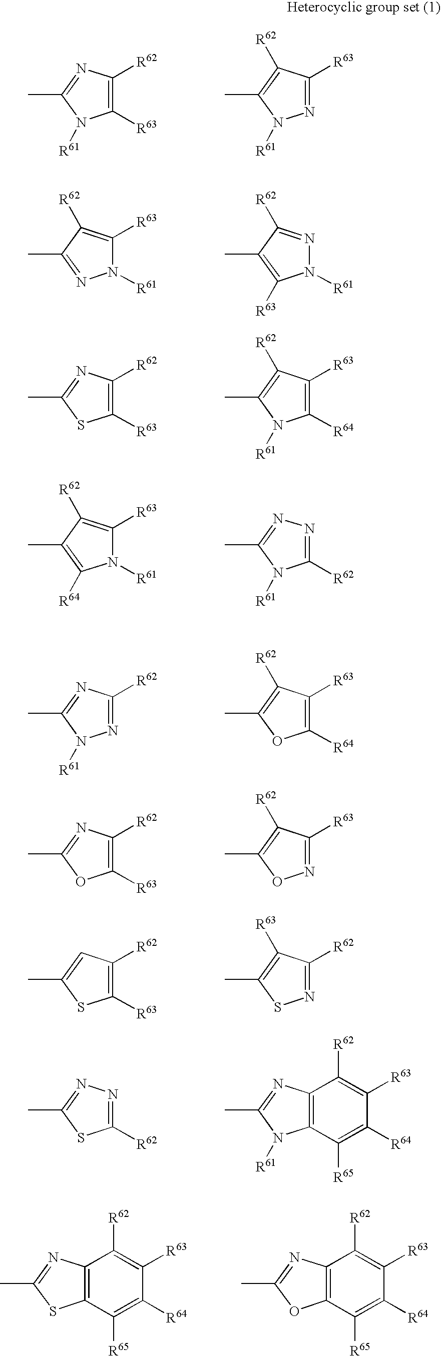 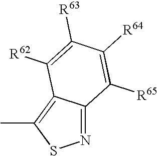
wherein in the heterocyclic group set (1), R⁶¹, R⁶², R⁶³, R⁶⁴ and R⁶⁵ each independently represent a hydrogen atom or a substituent; 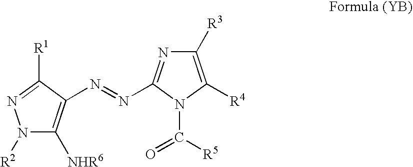
wherein, in formula (YB), R¹, R², R³, R⁴, and R⁶ each independently represent a hydrogen atom or a monovalent substituent; and R⁵ represents a monovalent substituent; 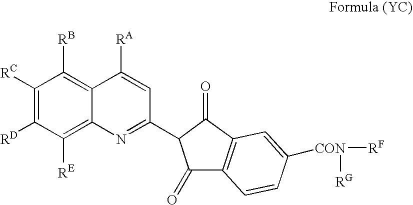
wherein, in formula (YC), R^{A}, R^{B}, R^{C}, R^{D}, and R^{E} each independently represent a hydrogen atom, a halogen atom, an alkyl group having 1 to 8 carbon atoms, a cycloalkyl group, an alkoxy group, an alkoxyalkoxy group, an alkoxycarbonyl group, a thioalkoxy group, an alkylsulfonyl group, an amino group, a substituted or unsubstituted phenoxy group, or a substituted or unsubstituted thiophenoxy group; R^{F} and R^{G} each independently represent a hydrogen atom, an alkyl group, an alkoxyalkyl group, a cycloalkyl group, an allyl group, an optionally substituted aryl group, an aralkyl group, a furfuryl group, a tetrahydrofuryl group, a tetrahydrofurfuryl group, or a hydroxylalkyl group; each of these groups may further be substituted; 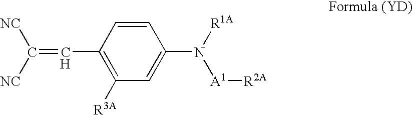
wherein, in formula (YD), R^{1A} represents an allyl group or an alkyl group; R^{2A} represents a substituted or unsubstituted alkyl group or aryl group; A¹ represents —CH₂—, —CH₂CH₂—, —CH₂CH₂O—, —CH₂CH₂OCH₂—, or —CH₂CH₂OCH₂CH₂—; R^{3A} represents an alkyl group; each of these groups may further be substituted; 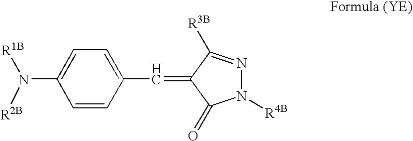
wherein, in formula (YE), R^{1B} and R^{2B} each independently represent a hydrogen atom, an optionally substituted alkyl group, an allyl group, an optionally substituted aryl group, or an optionally substituted cycloalkyl group; R^{3B} represents a hydrogen atom, an optionally substituted alkyl group, a NR^{5C}R^{6C} group, an optionally substituted alkoxy group, an optionally substituted alkoxycarbonyl group, an optionally substituted aryl group, or a C(O)NR^{5D}R^{6D} group; R^{4B}, R^{5C}, R^{5D}, R^{6C}, and R^{6D} each independently represent a hydrogen atom, an optionally substituted alkyl group, or an optionally substituted aryl group.

15. The image-forming method as described in claim 13, wherein at least one of a yellow dye contained in the yellow heat transfer layer disposed in the heat-sensitive transfer sheet is a compound represented by the above-described formula (YA) or (YB).

16. The image-forming method as described in claim 13, wherein with respect to the above-described formula (M), X and Z are a nitrogen atom and Y is a ═C(D¹³)-, wherein D¹³ represents a hydrogen atom, an alkyl group, an aryl group, an alkoxy group, an aryloxy group, or an amino group.

17. The image-forming method as described in claim 13, wherein the heat-sensitive transfer sheet has at least three kinds of heat transfer layers comprising yellow, magenta, and cyan, formed panel sequentially, on the surface of the same support.

18. The image-forming method as described in claim 13, wherein the heat-sensitive transfer sheet further has a heat transferable protective layer.

19. The image-forming method as described in claim 18, wherein the heat transferable protective layer has a maximum absorption within the wavelength region of from 330 nm to 370 nm and exhibits an absorption density of 0.8 or more at the maximum absorption wavelength.

20. The image-forming method as described in claim 13, wherein at least one of the hydrophilic polymer contained in the heat insulation layer of the heat-sensitive transfer image-receiving sheet is gelatin.

21. The image-forming method as described in claim 13, comprising the steps of:
superposing the heat-sensitive transfer sheet on the heat-sensitive transfer image-receiving sheet so that the receptor layer of the heat-sensitive transfer image-receiving sheet is in contact with the heat transfer layer of the heat-sensitive transfer sheet; and
giving thermal energy from a thermal head in accordance with image signals, thereby to form an image.
